(19) United States
(12) Patent Application Publication
(10) Pub. No.: US 2026/0275960 A1
(43) Pub. Date: Sep. 17, 2026

(54) MECHANICAL ENERGY GENERATION SYSTEM FOR SUSTAINABLE CLEAN ENERGY

(71) Applicant: Marty Jefferson, Gorham, ME (US)

(72) Inventor: Marty Jefferson, Gorham, ME (US)

(21) Appl. No.: 19/562,728

(22) Filed: Mar. 10, 2026

Related U.S. Application Data
(60) Provisional application No. 63/770,128, filed on Mar. 11, 2025.
(60) Provisional application No. 63/779,674, filed on Mar. 28, 2025.
(60) Provisional application No. 63/813,671, filed on May 29, 2025.
(60) Provisional application No. 63/814,787, filed on May 30, 2025.
(60) Provisional application No. 63/817,491, filed on Jun. 4, 2025.
(60) Provisional application No. 63/818,464, filed on Jun. 5, 2025.
(60) Provisional application No. 63/818,962, filed on Jun. 6, 2025.

(51) Int. Cl. F03B 17/06

(52) U.S. Cl. CPC F03D 3/009; F03D 9/25; F03B 17/061; F03B 17/062; F03D 3/011; F05B 2210/16; F05B 2240/211; F05B 2240/218; F05B 2240/30; F05B 2260/403

(57) ABSTRACT

A rotational energy platform may include a rotating assembly comprising a central shaft, one or more vertical airfoils, and one or more horizontal wings. The vertical airfoils may be mounted on radial arms and may be oriented to generate a tangential force that produces torque about the central shaft as the rotating assembly rotates through a fluid. The horizontal wings may be mounted to the rotating assembly and may be configured to generate an axial force along the central shaft. The horizontal wings may be configured as axial-load compensating wings with a positive angle of attack to generate an upward lift force that counteracts a weight of the rotating assembly. Alternatively, the horizontal wings may be configured as downforce-generating wings with a negative angle of attack to generate a downward force. The platform may be configured for various applications, including energy generation, fluid pumping, and propulsion.

### RELATED APPLICATIONS

This application claims the benefit of U.S. Provisional Application Ser. No. 63/770,128, filed Mar. 11, 2025, entitled Mechanical Machine for Sustainable Clean Energy, the benefit of U.S. Provisional Application Ser. No. 63/779,674, filed Mar. 28, 2025, entitled High-Efficiency Energy Conservation System Using Rotational Lift-Generated Torque from Supercritical Wings, the benefit of U.S. Provisional Application Ser. No. 63/813,671, filed May 29, 2025, entitled KurdEdge, KurdLiftReduction, and KurdDownforce Energy Systems, the benefit of U.S. Provisional Application Ser. No. 63/814,787, filed May 30, 2025, entitled KurdSkyNet—Sky-Based Transportation and Infrastructure Platform, the benefit of U.S. Provisional Application Ser. No. 63/817,491, filed Jun. 4, 2025, entitled Torque-Based Vertical Wing System for Fluid and Air Circulation—Including KurdPump and Kurd Air Flow, the benefit of U.S. Provisional Application Ser. No. 63/818,464, filed Jun. 5, 2025, entitled KurdLiftTorque System—Lift-Based Torque Generation Using Horizontal Airfoils, and the benefit of U.S. Provisional Application Ser. No. 63/818,962, filed Jun. 6, 2025, titled KurdLiftTower—Modular High-Rise Building System with Integrated Torque, Lift, and Emergency Safety Architecture, the entire disclosures of each of which are herein incorporated by reference.

### FIELD OF THE INVENTION

The disclosure relates to rotational energy platforms, and more particularly, to using a rotational platform to convert fluid flow through a fluid into mechanical work or electrical power.

### BACKGROUND OF THE INVENTION

Conventional rotating systems for energy conversion, fluid movement, propulsion, and mechanical power transmission may include turbines, pumps, fans, motors, and propellers. These systems may employ rotating blades or airfoils that interact with a working fluid such as air, water, or oil. In many implementations, conventional designs may be limited by performance tradeoffs, complexity of control hardware, parasitic losses, and startup requirements that restrict operation at lower fluid velocities or increase maintenance burden.

In conventional turbines, propellers, and impellers, a rotating blade set may simultaneously produce torque-generating tangential forces while also producing axial thrust and structural loads that impose bending moments and vibration. Because a single blade geometry may be expected to satisfy multiple force objectives across changing operating conditions, blade design may involve compromises that reduce efficiency in portions of the operating range. In some systems, variable-pitch mechanisms, active control, or additional structural reinforcement may be used to manage these competing requirements, which may increase cost, mechanical complexity, and potential failure modes.

Conventional rotating assemblies may also experience significant parasitic losses associated with bearings, seals, and drivetrain components. Rotating mass, aerodynamic or hydrodynamic thrust, and misalignment loads may impose radial and/or axial bearing loads, increasing friction and wear. These losses may reduce net power output and increase the minimum fluid velocity required to initiate rotation and sustain operation, particularly when combined with additional resisting torque from seals, generators, or gearboxes.

Pumps, fans, and multi-stream ventilation systems may face related limitations. Many conventional designs may be optimized for a single dominant flow path, and applications that require multiple flow streams or coupled functions may rely on separate machines, ducting, or motors, increasing system footprint, cost, and integration complexity.

Startup requirements may present additional constraints for large rotating assemblies. High system inertia and parasitic losses can require substantial starting torque, particularly at low rotational speed. In many conventional configurations, the startup motor is coupled directly to a central shaft and must be sized for worst-case starting conditions, increasing power demand, weight, and cost. These constraints may be problematic for installations requiring frequent start/stop cycles or where available electrical supply is constrained.

Accordingly, there remains a need for rotating systems that can operate efficiently across a wider range of fluid velocities while reducing reliance on complex control mechanisms and reducing parasitic losses in bearings and drivetrains. There is also a need for systems that enable lower-power startup arrangements, including drive architectures that apply input torque at a larger effective radius and/or through modular coupling mechanisms. Further, there is a need for a modular, adaptable architecture capable of supporting multiple applications-including power generation, pumping, ventilation, and propulsion-using a common set of components and scalable configurations.

### SUMMARY OF THE INVENTION

In various embodiments, a rotational energy platform may generate usable mechanical power by rotating within a working fluid. The platform may include a rotating assembly having a central shaft and a plurality of fluid-interacting members including one or more vertically oriented airfoils and one or more horizontally oriented wings. The vertically oriented airfoils may be configured to develop a tangential component of force from interaction with the working fluid, thereby producing torque about an axis of rotation. The horizontally oriented wings may be configured to generate lift and/or downforce having a component aligned with the axis of rotation, such that axial-direction forces and stabilization forces may be managed separately from torque generation.

In various embodiments, the horizontally oriented wings may be configured as load-compensating wings that generate lift to offset at least a portion of the rotating assembly load, thereby reducing net bearing loads (radial and/or axial), reducing parasitic losses, and enabling operation at lower fluid velocities. In other embodiments, the horizontally oriented wings may be configured to generate downforce for stabilization and/or to modify local fluid pressure and flow within a housing, conduit, or pumping region. The platform may further include a startup system configured to engage the rotating assembly at an outer radius or periphery, thereby reducing startup motor torque requirements relative to center-shaft drive arrangements.

The rotational energy platform may be implemented in a variety of configurations and application domains. In energy harvesting embodiments, the platform may convert wind or water flow into rotational mechanical power for driving an electrical generator. In pumping embodiments, the platform may produce rotational output to drive one or more pumping stages for moving a fluid. In propulsion embodiments, the platform may be arranged to generate thrust and/or lift forces for aerial or marine systems. In further embodiments, the platform may be configured as a sealed or partially sealed hydraulic or pneumatic rotating system and/or as a modular airflow-management system for building ventilation and climate-control applications, while employing shared components and scalable geometry across configurations.

In various embodiments, a rotational energy platform may include a rotating assembly having a central shaft, a plurality of vertical airfoils, and at least one set of horizontal wings. The plurality of vertical airfoils may be mounted on one or more radial arms extending from the central shaft. The plurality of vertical airfoils may be oriented to generate a tangential force that produces torque about the central shaft as the rotating assembly rotates through a fluid. The at least one set of horizontal wings may be mounted to the rotating assembly and may generate an axial force along the central shaft.

At least one of the at least one set of horizontal wings may include axial-load compensating wings configured with a positive angle of attack to generate an upward lift force that counteracts a weight of the rotating assembly. The axial-load compensating wings may offset at least 90 percent of the weight of the rotating assembly. The at least one set of horizontal wings may include downforce-generating wings configured with a negative angle of attack to generate a downward force. The rotational energy platform may include a startup system configured to engage the rotating assembly to initiate rotation, where the startup system includes two interlocking plates with directional locking segments that engage to transfer torque in a first direction and disengage when torque is applied in a second direction opposite to the first direction. The directional locking segments may include a guide wall extending from a surface of a first plate, an engagement ledge extending from the guide wall parallel to the surface of the first plate, and a rotational stop positioned at an end of the directional locking segment. The rotational energy platform may include a power transfer assembly configured to manage connections between the central shaft, a startup motor, and a generator. The rotating assembly may be positioned within a housing having a plurality of openings configured to allow fluid flow through the housing while preventing contact with the rotating assembly. The at least one set of horizontal wings may include an upper set of horizontal wings positioned above the one or more vertical airfoils and a lower set of horizontal wings positioned below the one or more vertical airfoils, and a vertical gap between the upper set of horizontal wings and the lower set of horizontal wings may define an isolation plenum. The one or more vertical airfoils may have an angle of attack in a range of approximately 5 to 15 degrees.

In various embodiments, a method for converting fluid energy may include rotating an assembly through a fluid, where the assembly includes a central shaft, one or more vertical airfoils mounted on one or more radial arms extending from the central shaft, and one or more horizontal wings. The method may include generating a tangential force with the one or more vertical airfoils to produce torque about the central shaft, and generating an axial force with the one or more horizontal wings to manage an axial load on the central shaft.

Generating the axial force may include generating an upward lift force that counteracts a weight of the assembly. In some embodiments, generating the axial force may include generating a downward force to stabilize the assembly. The method may include applying torque to the central shaft of the assembly with a startup motor to initiate rotation, disengaging the startup motor after the assembly reaches an operational speed, and extracting power from the torque about the central shaft with a generator after the startup motor is disengaged. The fluid may include water, and the method may further include pumping the water through a housing containing the assembly.

In various embodiments, a system for aerial lift may include an aerial vehicle body and a rotating assembly having a central shaft extending vertically, a plurality of vertical airfoils mounted on radial arms extending from the central shaft, and at least one set of horizontal wings configured with a positive angle of attack. The at least one set of horizontal wings may generate upward lift as the rotating assembly rotates. The system may include a propulsion system configured to provide horizontal thrust.

The at least one set of horizontal wings may include a first set of horizontal wings positioned below a body of an aerial vehicle and a second set of horizontal wings positioned above the body of the aerial vehicle. The central shaft may extend through the body of the aerial vehicle to connect to the first set of horizontal wings and the second set of horizontal wings.

### BRIEF DESCRIPTION OF THE DRAWINGS

The invention description below refers to the accompanying drawings, of which:

FIG. 1 is a schematic diagram illustrating forces generated by vertically mounted airfoils rotating around a central axis, in accordance with some embodiments.

FIG. 2 is a perspective view of a vertical airfoil illustrating a mounting cavity, in accordance with some embodiments.

FIG. 3 is a perspective view of a vertical airfoil illustrating multiple mounting cavities, in accordance with some embodiments.

FIG. 4 is a schematic view of a Rotational Lift Energy Platform illustrating a startup motor and a power generation system, in accordance with some embodiments.

FIG. 5 is a perspective view of a rotating assembly illustrating vertical wings and upper axial-load compensating wings, in accordance with some embodiments.

FIG. 6 is a top view of the rotating assembly of FIG. 5, illustrating an arrangement of vertical wings and upper axial-load compensating wings, in accordance with some embodiments.

FIG. 7 is a side view of axial-load compensating wings illustrating a positive angle of attack and a corresponding upward force vector, in accordance with some embodiments.

FIG. 8 is a perspective view of a set of axial-load compensating wings for a large-radius system, in accordance with some embodiments.

FIG. 9 is a perspective view of a set of axial-load compensating wings for a small-radius system, in accordance with some embodiments.

FIG. 10 is a side view of downforce-generating wings illustrating a negative angle of attack and a corresponding downward force vector, in accordance with some embodiments.

FIG. 11 is a perspective view of a set of downforce-generating wings, in accordance with some embodiments.

FIG. 12 is a cross-sectional view of a downforce-generating wing, taken along line 12-12 of FIG. 11, illustrating an airfoil profile, in accordance with some embodiments.

FIG. 13 is a perspective view of an assembled Edge-Drive Startup System, in accordance with some embodiments.

FIG. 14 is a perspective view of a peripheral-wall plate for an Edge-Drive Startup System illustrating a plurality of directional locking segments, in accordance with some embodiments.

FIG. 15 is a perspective view of a corresponding plate for an Edge-Drive Startup System illustrating directional locking segments with an inset guide wall, in accordance with some embodiments.

FIG. 16 is a perspective view of a peripheral-wall plate for a small-radius system, in accordance with some embodiments.

FIG. 17 is a perspective view of an inset-wall plate for a small-radius system, in accordance with some embodiments.

FIG. 18 is a perspective view of a rotating assembly illustrating an integrated Edge-Drive Startup System, in accordance with some embodiments.

FIG. 19 is a perspective view of a rotating assembly for a water pump system, illustrating upper and lower sets of horizontal wings, in accordance with some embodiments.

FIG. 20 is a perspective view of a water-pump system illustrating the rotating assembly of FIG. 19 within a pump housing.

FIG. 21 is a perspective view of the water-pump system of FIG. 20 illustrating a support base and a wishbone-shaped outlet.

FIG. 22 is a perspective view of an underwater energy harvesting system, illustrating a submerged rotating assembly and a top-side power transfer assembly, in accordance with some embodiments.

FIG. 23 is a detailed perspective view of the system of FIG. 22, illustrating a rotating assembly within a protective shroud, in accordance with some embodiments.

FIG. 24 is a perspective view of a stratified air movement system, illustrating a housing with multiple inlets and outlets, in accordance with some embodiments.

FIG. 25 is a perspective view of the rotating assembly for the system of FIG. 24, illustrating upper and lower sets of horizontal wings separated by an isolation plenum, in accordance with some embodiments.

FIG. 26 is a perspective view of an open-air energy harvesting system, in accordance with some embodiments.

FIG. 27 is a perspective view of the rotating assembly for the system of FIG. 26, in accordance with some embodiments.

FIG. 28 is a perspective view of a sealed oil barrel torque system, illustrating a sealed housing and external power components, in accordance with some embodiments.

FIG. 29 is a perspective view of the rotating assembly for the system of FIG. 28, illustrating downforce-generating wings, in accordance with some embodiments.

FIG. 30 is a perspective view of a support base for the sealed oil barrel system, illustrating directional locking segments for mounting a housing, in accordance with some embodiments.

FIG. 31 is a perspective view of the sealed housing of FIG. 28, illustrating corresponding directional locking segments on its base, in accordance with some embodiments.

FIG. 32A is a front view of a power transfer assembly, illustrating a box frame, shafts, and internal and external gear sets, in accordance with some embodiments.

FIG. 32B is a perspective view of a power transfer assembly, illustrating a box frame, shafts, and internal and external gear sets, in accordance with some embodiments.

FIG. 33 is a bottom view of an aerial vehicle, illustrating a large rotating assembly with a protective shroud and a rear propeller, in accordance with some embodiments.

FIG. 34 is a rear view of the aerial vehicle of FIG. 33, illustrating the rotating assembly, fixed horizontal wings, and upper horizontal wings, in accordance with some embodiments.

FIG. 35 is a side view of an internal power system for the aerial vehicle of FIG. 33, illustrating a rotating assembly within a housing and a propeller drive system, in accordance with some embodiments.

FIG. 36 is a schematic side view of a propeller system for the aerial vehicle of FIG. 33, illustrating an angle of attack and thrust vector, in accordance with some embodiments.

FIG. 37 is a top perspective view of a floating aerial platform, illustrating multiple docked aerial vehicles and peripheral lift systems, in accordance with some embodiments.

FIG. 38 is a bottom perspective view of the floating aerial platform of FIG. 37, illustrating bottom-mounted lift systems and landing feet, in accordance with some embodiments.

FIG. 39 is a side view of a bottom-mounted lift system for the platform of FIG. 37, illustrating a rotating assembly within a housing and downward-extending lift wings, in accordance with some embodiments.

FIG. 40 is a side view of a side-mounted lift system for the platform of FIG. 37, illustrating a pivoting support frame for directional control, in accordance with some embodiments.

FIG. 41 is a detailed perspective view of the floating aerial platform of FIG. 37, illustrating a landing foot, a bottom-mounted lift system, and a side-mounted lift system, in accordance with some embodiments.

FIG. 42 is a perspective view of a multi-tower building structure, illustrating a central tower, surrounding towers, connecting bridges, and integrated side-mounted lift systems, in accordance with some embodiments.

FIG. 43 is a detailed perspective view of the building structure of FIG. 42, illustrating the placement of side-mounted lift systems and connecting bridges, in accordance with some embodiments.

FIG. 44 is a perspective view of an elevator system, illustrating a multi-floor structure with an elevator carriage, chain loop, and upper pulley, in accordance with some embodiments.

FIG. 45 is a perspective view of a power system for the elevator of FIG. 44, illustrating a rotating assembly within a housing, a lower pulley, and power transfer components, in accordance with some embodiments.

FIG. 46 is a perspective view of a pulley for the elevator of FIG. 44, illustrating directional locking segments for edge-lock connection to a drive shaft, in accordance with some embodiments.

### DETAILED DESCRIPTION

The description herein includes a Rotational Lift Energy Platform system and method of use. There are a great many possible implementations of the invention, too many to describe herein. Various possible implementations are described below. It cannot be emphasized too strongly, however, that these are descriptions of implementations of the invention, and not descriptions of the invention, which is not limited to the detailed implementations described in this section but is described in broader terms in the claims. Although this invention is disclosed in the context of certain preferred embodiments and examples, it should be understood by those skilled in the art that the present invention extends beyond the specifically disclosed embodiments and/or uses of the invention and obvious modifications and equivalents thereof. Further, the terms and phrases used herein are not intended to be limiting but rather to provide an understandable description of the invention.

In various instances, well-known structures and devices are shown in diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, any particular embodiment need not have all the aspects or advantages described herein. Thus, in various embodiments, any of the features described herein from different embodiments may be combined.

References to “one embodiment”, “an embodiment”, “another embodiment”, “one example”, “a further embodiment”, “some embodiments”, “various embodiments”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. The appearance of the phrase “in one embodiment” in various places in the specification are not necessarily all referring to the same embodiment, nor are separate or alternative embodiments mutually exclusive of other embodiments. Some embodiments, illustrating its features, will now be discussed in detail. The words “having,” “containing,” and “including,” and other forms thereof, are intended to be equivalent in meaning and be open ended in that an item or items following any one of these words is not meant to be an exhaustive listing of such item or items, or meant to be limited to only the listed item or items. Further, the terms “a” and “an” herein do not denote a limitation of quantity, but rather denote the presence of at least one of the referenced items. Moreover, various features are described which may be exhibited by some embodiments and not by others. Similarly, various features are described which may be included in some embodiments but not in other embodiments. All illustrations of the drawings are for the purpose of describing selected versions of the present invention and are not intended to limit the scope of the present invention.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure describes a Rotational Lift Energy Platform (RLEP), a system for converting interaction with a working fluid into rotational mechanical power for performing mechanical work and/or generating electrical power. The RLEP may operate in various fluid environments, including air and liquids such as water and oil. The RLEP system can generate rotational torque through the interaction of the vertical airfoils through a fluid medium. In various embodiments, the forces produced through the interaction of the vertical airfoils through a fluid medium may sustain rotation of the RLEP while sufficient fluid interaction energy is present.

The RLEP may include a rotating assembly comprising a central shaft, one or more vertically oriented airfoils mounted at a radius from the shaft, and one or more horizontally oriented wings. The vertically oriented airfoils may be arranged such that interaction with the working fluid produces a tangential component of aerodynamic or hydrodynamic force that generates torque about an axis of rotation. The horizontally oriented wings may be configured to generate lift and/or downforce having a force component along the shaft axis, and may thereby manage gravitational loading, thrust-related loading, stabilization forces, and/or application-specific pressure/flow effects. By separating torque generation from force management functions, the platform may reduce design tradeoffs and may improve operating efficiency over a wide range of fluid velocities in at least some embodiments.

The RLEP may be adapted for numerous applications, including but not limited to: energy harvesting systems (e.g., wind or water power generation), pumping systems for moving fluids, propulsion systems for generating thrust and/or lift forces, sealed hydraulic or pneumatic torque-generation systems, and airflow-management systems for building ventilation and climate control. The modular design of the RLEP may allow core components to be scaled and configured for operational requirements.

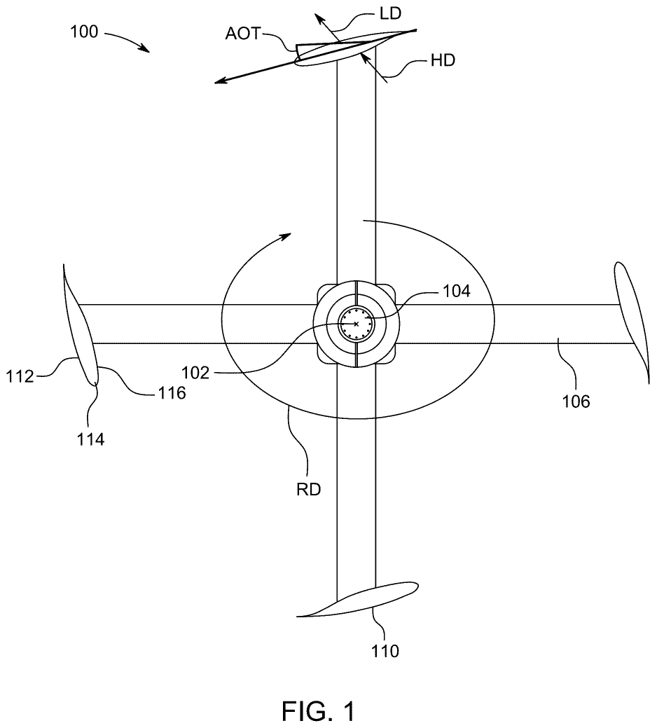

FIG. 1 is a schematic diagram illustrating forces generated by vertically oriented airfoils rotating around a central axis, in accordance with some embodiments. The figure shows an RLEP 100 comprising a central axis 102, a central shaft 104, radial arms 106, and vertical airfoils 110. Each vertical airfoil 110 may include an aerodynamic or hydrodynamic airfoil profile (which may be symmetric or cambered depending on the embodiment), a leading edge 114, and opposing surfaces that develop a pressure differential during rotation. In various embodiments, the outer surface 112 can generate a low-pressure zone, and the inner surface 116 can generate a high-pressure zone during rotation. The vertical airfoils 110 may be mounted at the ends of the radial arms 106 extending outward from the central shaft 104.

As the rotating assembly turns in rotational direction RD, each vertical airfoil 110 moves through the surrounding fluid and develops a pressure differential that produces a resultant force vector having tangential and radial components. The vertical airfoils 110 may be oriented at an angle of attack AOT selected to provide a desired tangential component of force to drive rotation about the central shaft 104. In some embodiments, AOT may be selected within a range such as approximately 5 to 20 degrees, although other angles may be used depending on fluid medium, airfoil profile, Reynolds number, and operating speed. Higher angles may increase drag and, in some operating regimes, may increase risk of flow separation and reduced efficiency.

The tangential component of the resultant force on the vertical airfoils 110 may generate torque about the central shaft 104, thereby converting interaction between the moving vertical airfoils and the working fluid into rotational mechanical energy. The number of vertical airfoils 110 may vary depending on application and scale, including configurations such as 3, 4, 6, or 8 vertical airfoils, among others.

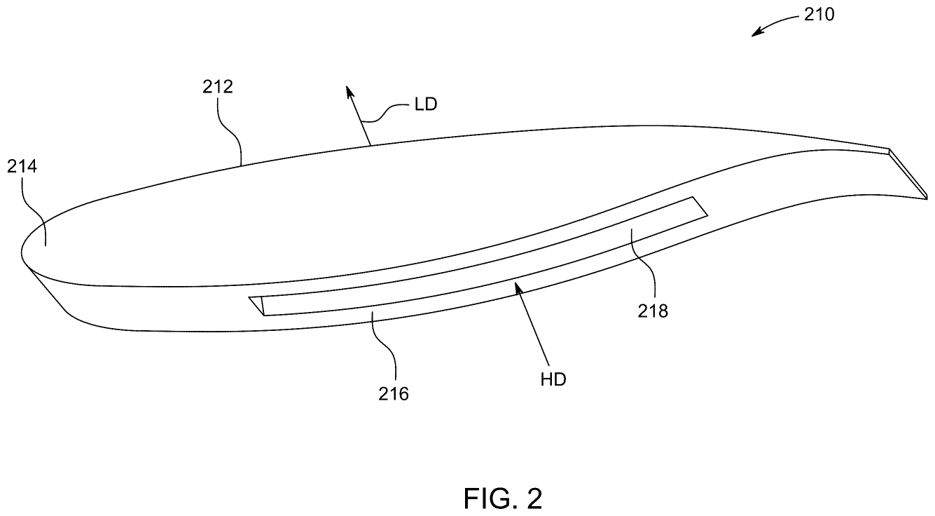

FIG. 2 is a perspective view of a vertical airfoil illustrating a mounting cavity, in accordance with some embodiments. The vertical airfoil 210 may include an outer surface 212, a nose 214, and an inner surface 216 that forms a high-pressure zone during rotation. The vertical airfoil 210 may include an airfoil profile suitable for the working fluid and operating speed, and a mounting cavity 218 configured to receive and secure an end portion of a radial arm.

The vertical airfoil 210 may generate a pressure differential during rotation and thereby experience a resultant force having tangential and radial components. In various embodiments, the aerodynamic profile of the vertical airfoil may allow the airfoil to generate the pressure differential, with a high pressure area forming on the inner surface 116. The inner surface 216 may be oriented at an angle such that the high-pressure area generated during rotation provides force in a direction that is at least partially tangent to the circular path of rotation. The tangential component may contribute to torque, while the radial component may impose structural loads that may be reacted by the radial arm and mounting features.

The mounting cavity 218 may provide a secure attachment point that allows the vertical airfoil 210 to withstand these aerodynamic forces during rotation while maintaining its orientation relative to the radial arm. The mounting cavity 218 may include internal reinforcement ribs or structural supports to distribute the aerodynamic loads across the airfoil structure and prevent deformation or failure at the attachment point. The vertical airfoil 210 may be constructed from lightweight, high-strength materials such as carbon fiber composites, fiberglass, or aluminum alloys.

The configuration shown in FIG. 2 may represent a single-mount vertical airfoil suitable for smaller-scale RLEP systems or for applications where the vertical airfoils are supported by a single set of radial arms. Alternative mounting configurations, such as dual-mount airfoils, are described in subsequent figures.

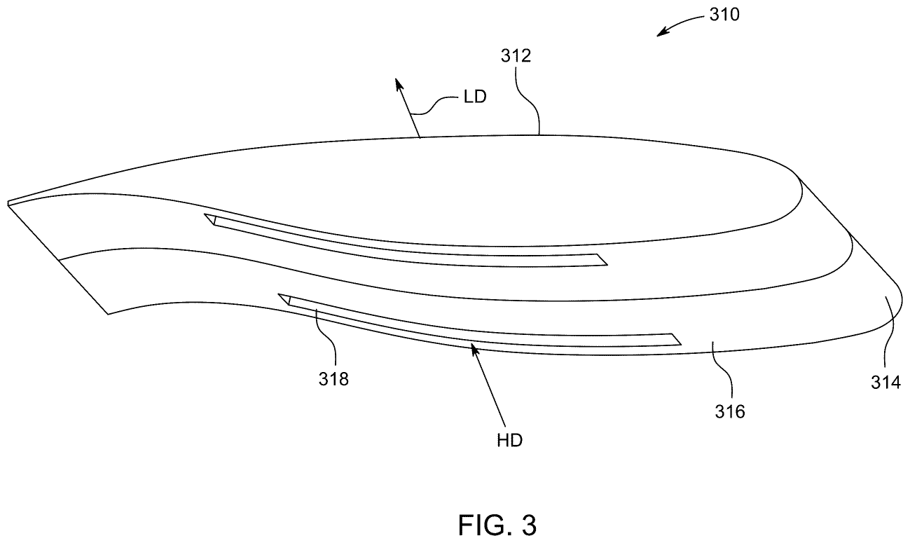

FIG. 3 is a perspective view of a vertical airfoil illustrating multiple mounting cavities, in accordance with some embodiments. The figure shows a vertical airfoil 310 that may be adapted for use in larger-scale RLEP systems. The vertical airfoil 310 may include an outer surface 312 with a lift-generating camber, a nose 314, and an inner surface 316 that forms a high-pressure zone during rotation. The vertical airfoil 310 may include two mounting cavities 318, configured to receive and secure radial arms at two different vertical positions along the airfoil.

The dual-mount configuration shown in FIG. 3 may provide enhanced structural support for larger vertical airfoils. By attaching the vertical airfoil 310 to both an upper set of radial arms and a lower set of radial arms, the system may distribute the aerodynamic loads more evenly and reduce bending moments and stress concentrations that could occur with a single attachment point. This configuration may be particularly advantageous for large-radius RLEP systems where the vertical airfoils 310 are subject to significant aerodynamic forces and where structural integrity is desired for safe and reliable operation.

The outer surface 312, nose 314, and inner surface 316 may function in the same manner as described for FIG. 2, generating lift and pressure differentials that produce tangential and radial forces during rotation. The vertical airfoil 310 may be constructed from the same lightweight, high-strength materials as described for FIG. 2, and the mounting cavities 318 may include internal reinforcement to withstand the distributed loads from the upper and lower radial arms.

The configuration shown in FIG. 3 may be scalable to accommodate various sizes of RLEP systems, with the spacing between the two mounting cavities 318 selected based on the height of the vertical airfoil 310 and the structural requirements of the application.

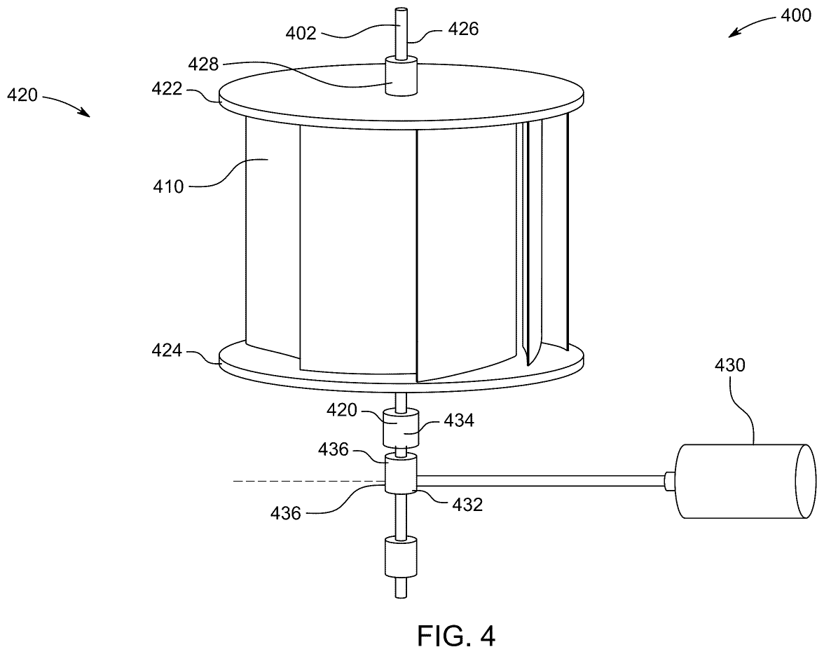

FIG. 4 is a schematic view illustrating a startup motor and a power generation system, in accordance with some embodiments. The figure shows an RLEP system 400 comprising a rotating assembly 420, a central shaft 402, a startup motor 426 and clutch 428, a generator 430 and clutch 432, a power transfer assembly 434, and one or more bearings 436 which may include one or more sets of magnetic bearings in some embodiments. In embodiments employing one or more sets of magnetic bearings, the magnetic bearings 436 may reduce friction and wear relative to contact bearings. In some embodiments, the system may further include backup or touchdown bearings and/or hybrid bearing arrangements for safety, startup, or fault conditions.

The rotating assembly 420 may include the vertical airfoils 410 positioned between the upper plate 422 and the lower plate 424. The upper plate 422 and the lower plate 424 may include pockets or recesses adapted to receive and secure the tops and bottoms of the vertical airfoils 410, holding them in a fixed orientation relative to the central shaft 402. This disc-based configuration may provide structural rigidity and may be particularly suitable for high-speed or high-torque applications where the vertical airfoils 410 must maintain precise alignment during operation.

The central shaft 402 may extend vertically through the rotating assembly 420 and may be supported by one or more sets of magnetic bearings 436 at the top and bottom. The magnetic bearings 436 may provide low-friction support for the central shaft 402, allowing the rotating assembly 420 to spin with minimal energy loss. The use of magnetic bearings 436 may eliminate the need for mechanical contact bearings, reducing wear and maintenance requirements.

The startup motor 426 may be positioned at the top of the system and may be used to bring the RLEP system 400 up to operational speed. The startup motor clutch 428 may selectively engage or disengage the startup motor 426 from the central shaft 402. When the rotating assembly 420 reaches operational speed, the startup motor clutch 428 may disengage the startup motor 426, allowing the system to operate independently.

The power transfer assembly 434 may be connected to the bottom of the central shaft 402 and may transfer rotational power to the generator 430. The generator clutch 432 may selectively engage or disengage the generator 430 from the power transfer assembly 434, allowing the system to control when power is extracted from the rotating assembly 420. The generator 430 may convert the mechanical rotational energy of the central shaft 402 into electrical energy.

The configuration shown in FIG. 4 may represent an alternate embodiment of the RLEP system that integrates power generation, startup control, and low-friction bearing support into a compact, vertically oriented assembly. This embodiment may be suitable for applications requiring high power output and precise control over startup and power generation operations.

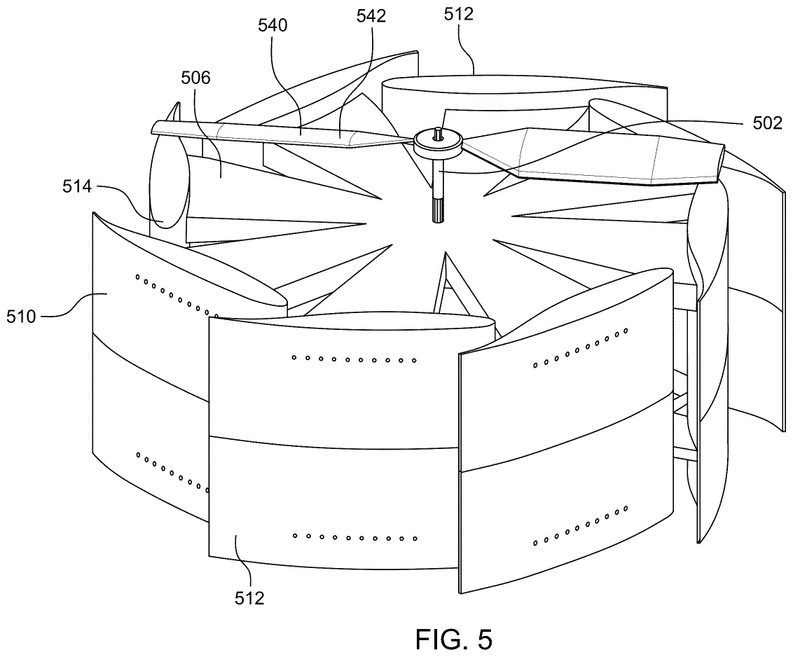

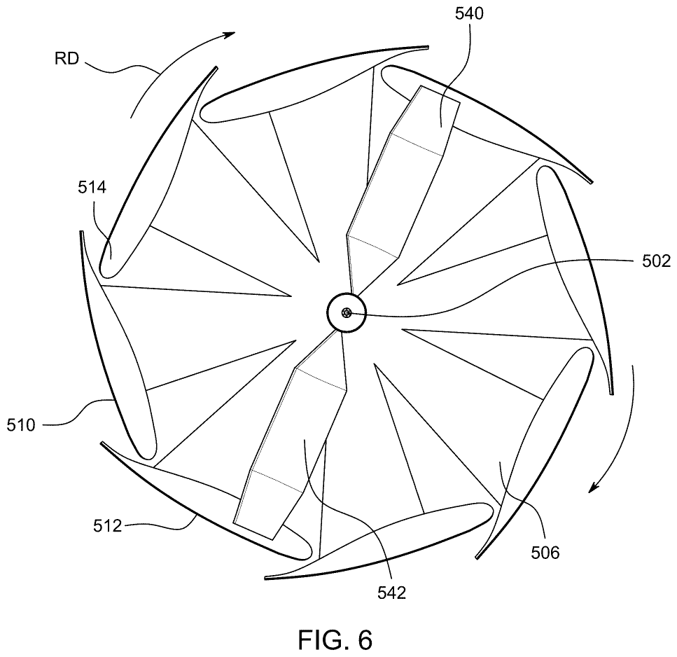

FIG. 5 is a perspective view of a rotating assembly illustrating vertical wings and upper axial-load compensating wings, and FIG. 6 is a top view of the rotating assembly of FIG. 5, illustrating an arrangement of vertical wings and upper axial-load compensating wings, in accordance with some embodiments. FIGS. 5-6 illustrate a rotating assembly having a central shaft 502, radial arms 506, vertical airfoils 510, and an upper set of horizontal wings 540 that can be force-management wings configured with a selected angle of attack.

As the rotating assembly rotates, the horizontal wings 540 may generate lift and/or downforce. In some embodiments, the horizontal wings 540 may be lift-generating wings 542 that generate lift to offset at least a portion of the rotating assembly load, thereby reducing net bearing loads (axial and/or radial depending on the bearing arrangement) and reducing parasitic losses.

The angle of attack of the horizontal wings 540 may be selected to achieve a desired force magnitude and direction. In various embodiments with lift-generating wings 542, the angle of attack may be within a range such as approximately 5 to 20 degrees, and may be tuned based on assembly weight, operating speed, fluid medium, and desired bearing-load reduction. The positive angle of attack of the axial-load compensating wings 542 may create a pressure differential, with a low-pressure zone on the top surface and a high-pressure zone on the bottom surface. As the rotating assembly rotates, the lift generating wings 542 may move through the surrounding fluid and generate a pressure differential that creates an upward force. The magnitude of the lift force may be adjusted by varying the angle of attack, the rotational speed of the assembly, or the size and number of the axial-load compensating wings 542. The number, size, and chord length of the axial-load compensating wings 542 may be selected based on the size of the system and the weight of the rotating assembly. In some implementations, the horizontal wings may offset a substantial portion of bearing load, which may improve low-velocity startup behavior and reduce frictional losses during operation.

The configuration of FIGS. 5-6 may illustrate functional separation in the RLEP system, in which vertically oriented airfoils may be optimized primarily for torque production while horizontal wings may be optimized primarily for forces along an axial direction, such as load management, stabilization, and/or application-specific flow/pressure effects.

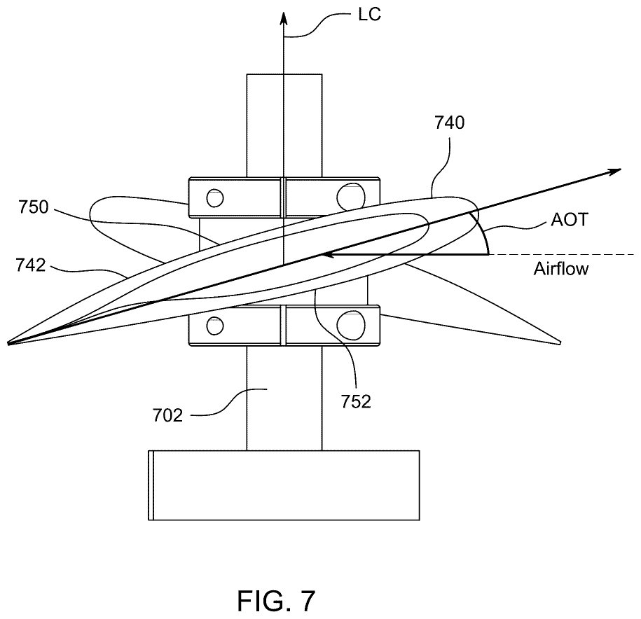

FIG. 7 is a side view of lift-generating horizontal wings configured to reduce axial bearing load, in accordance with some embodiments. The figure shows a central shaft 702, a rotating assembly including an upper wing set 740 that may be lift-generating wings 742 mounted to rotate about the central shaft 702. The lift wings 742 are configured at a positive angle of attack (AoA) relative to the local relative flow created by rotation. As shown, the lift wings 742 establish a lower-pressure region 750 on an upper surface and a higher-pressure region 752 on a lower surface, thereby generating an upward lift force vector LC.

The angle of attack (AoA) may be defined as the angle between a chord line of the lift wings 742 and the direction of the relative fluid flow at the wing section during rotation. In the embodiment shown, the AoA is approximately 15 degrees. In various embodiments, the AoA may be selected within a range of approximately 10 to 20 degrees, depending on the operating fluid, rotational speed, and the target axial-load reduction. At higher angles, for example above approximately 20 degrees in air under certain operating regimes, flow separation may increase and lift may degrade (stall-like behavior), reducing axial-load compensation.

During rotation about the central shaft 702, the lift wings 742 interact with the surrounding fluid and generate lift through a combination of pressure differential, circulation, and net momentum change of the flow. The positive AoA causes the rotating flowfield to be deflected and accelerated such that a pressure imbalance forms between upper and lower wing surfaces, producing the upward force vector LC.

In some embodiments, the AoA of the lift wings 742 may be fixed (e.g., rigid mounting, keyed hub, or tooth-lock alignment). In other embodiments, the AoA may be selectively adjustable during operation using a mechanical indexing interface, including but not limited to a tooth-lock mechanism, an optional clutch, and/or an optional braking/alignment feature to permit controlled engagement at a target AoA.

By maintaining a positive AoA during rotation, the system may continuously generate an upward force that offsets at least a portion of the gravitational weight of the rotating assembly. This reduces axial load on bearings supporting the central shaft 702, thereby reducing frictional losses, heat generation, and wear, and improving overall efficiency and durability.

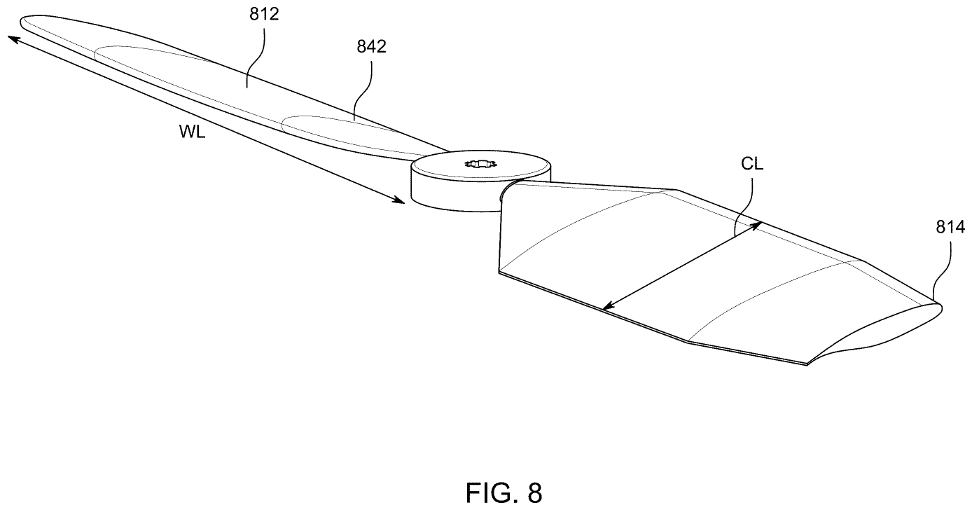

FIG. 8 is a perspective view of a set of lift wings for a large-radius system, in accordance with some embodiments. The figure shows lift wings 842 having an outer surface 812 and a leading edge or nose 814, and illustrates a wing length WL and chord length CL.

The wing length WL may be a radial dimension measured outward from the central shaft toward the wing tip. The chord length CL may be a leading-edge to trailing-edge dimension measured substantially in the local flow direction at the wing section. In large-radius RLEP embodiments, the wing length WL may be increased to generate higher total lift across a larger rotating radius while maintaining acceptable structural stiffness.

In large-radius embodiments, longer wings may provide increased lift capacity to offset larger rotating-assembly weights. In such embodiments, the wings may be constructed using lightweight high-strength materials and reinforcement features to maintain rigidity under aerodynamic loading and rotational stresses.

FIG. 8 illustrates one example of a large-radius lift-wing configuration; other embodiments may use different span, chord, thickness, and reinforcement based on operating fluid and RPM range.

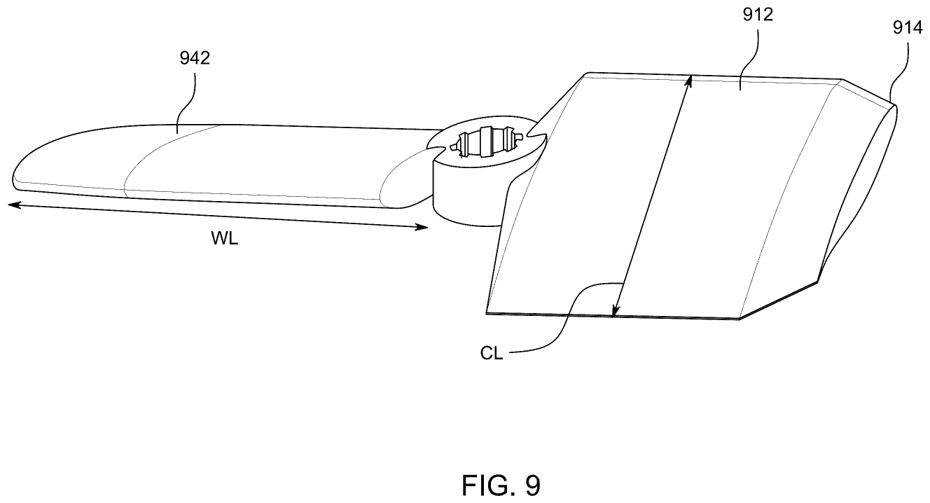

FIG. 9 is a perspective view of a set of lift wings for a small-radius system, in accordance with some embodiments. The figure shows lift wings 942 having an outer surface 912 and a leading edge or nose 914, and illustrates wing length WL and chord length CL.

In small-radius embodiments, the radial span may be shorter, and the wing length WL may be reduced accordingly. To maintain adequate lift for axial-load reduction, the chord length CL may be increased to provide greater surface area and lift capability in compact geometries.

The selection of WL and CL may be based on target axial-load reduction, rotating mass, rotational speed, and operating fluid. Horizontal wings may be fabricated from composites or metal alloys, and may use symmetric airfoil profiles consistent with the operating environment. FIG. 9 illustrates one example small-radius configuration;

other embodiments may vary WL/CL ratio to meet packaging, stiffness, and manufacturing constraints.

FIGS. 8 and 9 illustrate that wing scaling may be optimized using an aspect ratio parameter defined as WL/CL. Higher aspect ratio wings (longer WL relative to CL) may improve lift efficiency in larger-radius embodiments, but may require added stiffness and reinforcement to reduce bending and vibration under load. Lower aspect ratio wings (shorter WL and larger CL) may be structurally robust and compact, and may reduce certain tip-loss effects in constrained-radius embodiments.

In various embodiments for large radius systems, (e.g., radius≈10 m), WL may be approximately 3-5 m and CL may be approximately 0.5-1.0 m. In various embodiments for small radius systems, (e.g., radius≈2 m), WL may be approximately 0.5-1.0 m and CL may be approximately 0.3-0.6 m, with dimensions adjustable based on system mass, RPM, and fluid conditions. The final wing geometry may be selected as a tradeoff among aerodynamic efficiency, stiffness, mass, manufacturability, and integration with the rotating assembly.

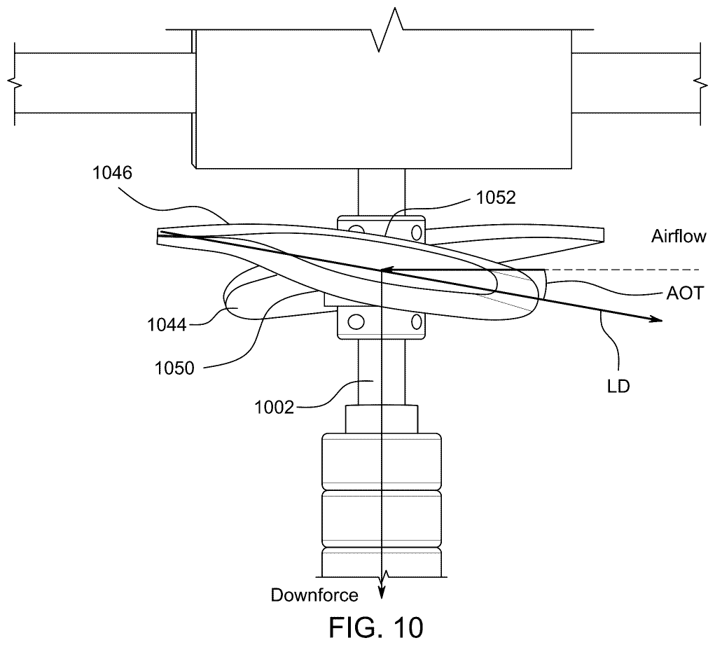

FIG. 10 is a side view of downforce-generating horizontal wings illustrating a negative angle of attack and a corresponding downward force vector, in accordance with some embodiments. The figure shows a central shaft 1002, and a rotating assembly including a lower wing set 1044 configured with downforce airfoils 1046 with a negative AoA relative to the local relative flow created by rotation. In this configuration, a pressure differential forms such that a lower-pressure region 1050 develops on a lower surface and a higher-pressure region 1052 develops on an upper surface, generating a downward force vector LD. In some embodiments, the downforce airfoils 1046 may be used for stabilization, braking, or non-liftoff safety control in ground-anchored or oil-based embodiments, and may be omitted in embodiments that use lift-only configurations (e.g., certain pumping embodiments).

The angle of attack AOT may be the angle between a chord line of the downforce-generating airfoils 1046 and a direction of a relative fluid flow at the airfoil section during rotation. In the embodiment shown in FIG. 10, the angle of attack AOT may be approximately −10 degrees. In some embodiments, the negative angle of attack may be in a range of approximately −5 to −15 degrees. In various embodiments, the negative angle of attack may be approximately −10 degrees. Negative angles beyond approximately −15 degrees under certain operating conditions may increase flow separation and reduce aerodynamic effectiveness. The negative angle of attack may orient a leading edge of the horizontal wings with downforce airfoils downward relative to the local relative flow, producing a downforce direction that can be opposite a lift-generating configuration.

As the downforce-generating airfoils 1046 rotate about the central shaft 1002, the horizontal downforce-generating airfoils 1046 interact with the surrounding fluid and generate downforce through a combination of pressure differential, circulation/flow turning, and net momentum change of the fluid. In operation, the negative angle of attack establishes a pressure imbalance across upper and lower airfoil surfaces, thereby producing the downward force indicated by the force vector LD. In various embodiments, the pressure differential may be expressed using Bernoulli relationships; however, the generated force may also be characterized as the result of the rotating horizontal airfoils imparting a net downward component of momentum to the surrounding fluid. In various embodiments, the generated torque forces may be characterized as aerodynamic pressure differentials and lift forces acting on the airfoils. In various embodiments, multiple aerodynamic effects may act on the airfoils and contribute to the generation of torque forces.

The downforce-generating airfoils 1046 may be used in embodiments where a downward force is advantageous, such as for stabilization, preload management, braking assistance, vibration reduction, and/or maintaining a desired net vertical load condition for a ground-anchored rotating assembly. In some embodiments, including for example sealed hydraulic or oil-based enclosed systems, downforce-generating airfoils may additionally promote internal circulation and pressure distribution within the enclosure. In embodiments directed to lift-only pumping configurations, downforce-generating horizontal airfoils may be omitted.

The configuration shown in FIG. 10 illustrates one example by which downforce-generating airfoils 1046 produce a downward force. By maintaining a negative angle of attack during rotation, the system may continuously generate downforce that may be used for stabilization, preload control, braking, internal circulation in applicable enclosed embodiments, and/or other operational purposes.

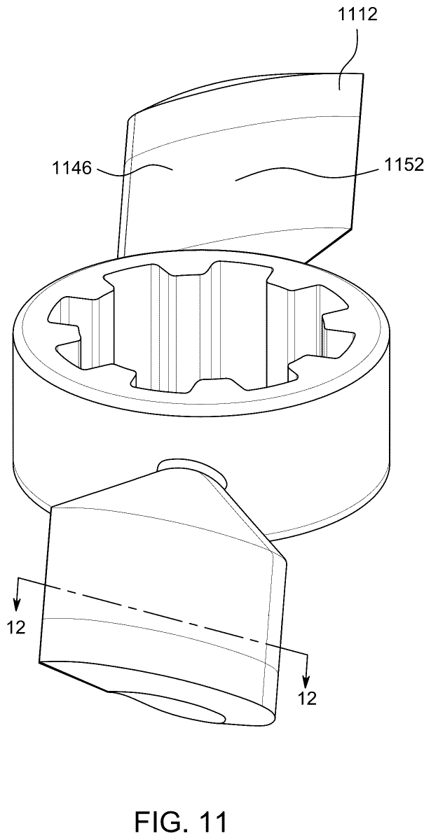

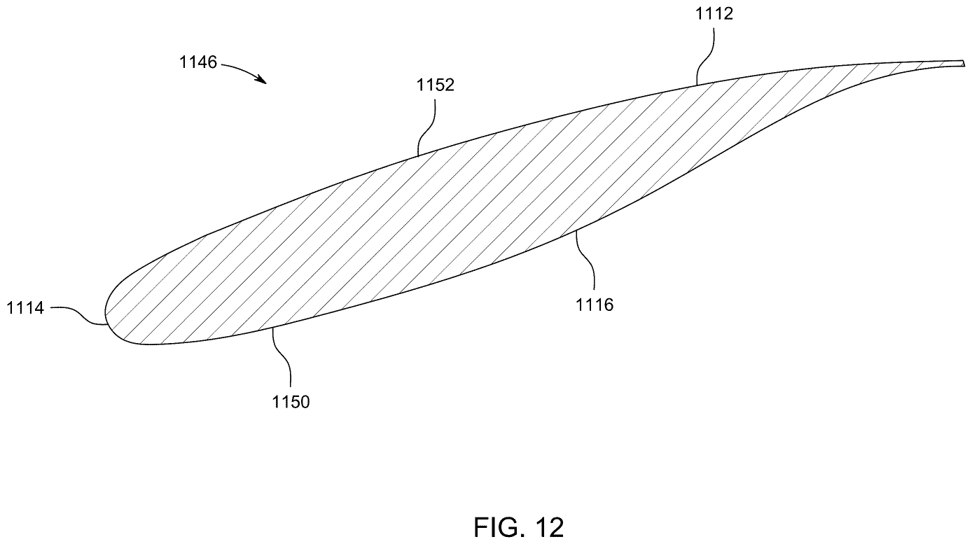

FIG. 11 is a perspective view of a set of horizontal wings with downforce-generating airfoils, in accordance with some embodiments. FIG. 12 is a cross-sectional view of the airfoil of a downforce-generating wing, taken along line 12-12 of FIG. 11, illustrating an airfoil profile, in accordance with some embodiments. FIG. 11 shows horizontal wings 1152 with downforce-generating airfoils 1146, including an upper surface 1112 and an associated high-pressure region 1152 during operation. FIG. 12 shows a cross section of the downforce-generating airfoil 1146 including the upper surface 1112, a leading edge (nose) 1114, an under surface 1116, and associated low-pressure and high-pressure regions 1150 and 1152 during operation.

The perspective view in FIG. 11 illustrates horizontal wings 1152 with downforce-generating airfoils 1146 configured as part of a rotating assembly, according to an exemplary embodiment. The cross-sectional view in FIG. 12 may illustrate an example airfoil geometry and a representative pressure distribution that may contribute to downforce generation.

The airfoil profile shown in FIG. 12 may be operated at a negative angle of attack, as described with reference to FIG. 10. The nose 1114 may be a leading edge positioned to first encounter the relative fluid flow during rotation. In some embodiments, the upper surface 1112 may be relatively flat, convex, or otherwise shaped, and the under surface 1116 may be convex, concave, or otherwise shaped, depending on the target operating regime. The disclosure is not limited to a specific airfoil geometry. In some embodiments, an asymmetric wing profile may be selected to increase downforce and/or improve stability in a given fluid and speed range. In other embodiments, a symmetric wing profile may be used such that downforce is generated primarily by the negative angle of attack. In various embodiments, wing geometry may be selected from standard profiles (including symmetric profiles) and/or custom profiles based on analysis and/or testing. In some embodiments, supercritical airfoil shapes may be used as a recommended option for certain operating regimes, without limiting the system to supercritical profiles.

During operation, the downforce-generating airfoil 1146 may establish an inverted pressure distribution relative to a lift-generating configuration, thereby producing a net downward force on the rotating assembly. The magnitude of downforce may depend on angle of attack, rotational speed, chord length, span/radial length, radius, fluid density, and other operating factors. In some embodiments, the angle of attack of the downforce-generating airfoils 1146 may be fixed by a rigid mount, keyed interface, or indexed coupling. In other embodiments, the angle of attack may be selectively adjustable using an indexing interface, which may include a tooth-lock structure and may optionally be used with a clutch and/or braking feature to support controlled alignment and engagement at a selected angle.

Because horizontal wings with downforce-generating airfoils impose loads in a direction opposite lift-generating airfoils, mounting interfaces and internal reinforcement structures may be selected to withstand operational loads, vibration, and fatigue. The airfoil geometry may be optimized for the fluid environment (air, water, oil, or other fluids) and an expected range of rotational speeds. In some embodiments, airfoil selection may consider cavitation margin for submerged operation, surface finish, stiffness, and structural thickness. The horizontal wings with downforce-generating airfoils 1146 may be manufactured from lightweight, high-strength materials including composites and/or metal alloys.

The configurations shown in FIGS. 11 and 12 illustrate example structural and aerodynamic implementations of downforce-generating airfoils. Such airfoil wings may be used, in various embodiments, for stabilization, braking, preload management, and/or internal circulation and pressure distribution within enclosed systems.

Various rotating airfoil systems are described herein. In various embodiments, an Edge-Drive Startup System may be used to initiate rotation of an RLEP rotating assembly and/or to couple rotation to a drivetrain, generator, pump, or other load. Conventional systems may use a motor coupled directly to a central shaft to overcome inertia and accelerate the rotating assembly, which can require relatively high startup torque due to the limited effective lever arm at the shaft. The edge-drive system applies rotational drive and/or resistance at an outer periphery of the rotating assembly, increasing leverage and mechanical advantage. By engaging at or near the outer edge rather than only at the central shaft, the system may achieve a target angular acceleration using a smaller motor and/or reduced startup torque. In some embodiments, the edge-drive system may reduce startup power requirements relative to center-shaft startup, with achievable reductions depending on assembly radius, inertia, gearing configuration, and frictional losses. The edge-drive system may be particularly advantageous for large-radius RLEP systems, where edge engagement provides increased leverage.

The Edge-Drive Startup System may include two interlocking plates or rings that cooperate to form a peripheral power-transfer ring at or near an outer radius of a rotating assembly. In some embodiments, a first plate may be coupled to the rotating assembly, and a second plate may be coupled to a startup motor and/or to an auxiliary shaft, gearbox, pulley, generator input, or other peripheral drive component. The plates may include complementary directional locking segments that, when rotated relative to each other in an engagement direction, mechanically interlock to transfer torque. In some embodiments, the directional locking segments may provide one-way clutch-like behavior (e.g., engage in a first direction and release in a second direction). In other embodiments, the system may be configured to remain engaged during operation, and disengagement may be performed selectively (e.g., by controlled reverse rotation, a separate release feature, or an optional clutch/brake/indexing interface). The directional locking mechanism may operate mechanically based on relative rotation and contact geometry, and in some embodiments may avoid hydraulic actuation and may not require electronic control for basic engagement. The edge-drive system may be used for startup and may also be used for coupling peripheral components such as pulleys, belts, drive shafts, and/or power takeoff elements, as described in later embodiments.

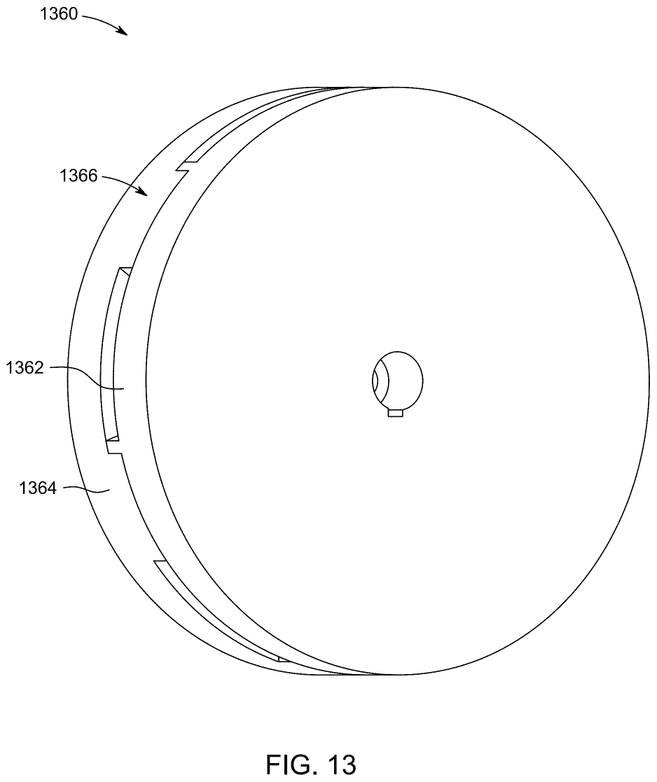

FIG. 13 is a perspective view of an assembled Edge-Drive Startup System, in accordance with some embodiments. The figure shows an Edge-Drive system 1360 comprising an inset-wall plate 1362, a peripheral-wall plate 1364, and a power-transfer ring 1366 formed by the plates in an interlocked configuration. In the assembled configuration, directional locking segments of each plate engage corresponding segments of the other plate.

The Edge-Drive system 1360 may be positioned at an outer periphery of a rotating assembly. In some embodiments, the peripheral-wall plate 1364 may be attached to the rotating assembly and may rotate with it, while the inset-wall plate 1362 may be connected to a startup motor or other drive mechanism. However, in various embodiments either plate may be coupled to either shaft or component, and the directional locking geometry may be arranged for a selected engagement direction. When the two plates are brought together and rotated relative to each other in the engagement direction, the directional locking segments may interlock, thereby forming the power-transfer ring 1366 at an outer edge region of the assembled system. The assembled power-transfer ring 1366 may have a diameter that corresponds to, or slightly exceeds, an outer diameter of the rotating assembly and/or an outer radius of horizontal wings mounted to the rotating assembly, depending on the embodiment.

When torque is applied by the startup motor in the engagement direction, the directional locking segments may mechanically lock and transfer torque from the inset-wall plate 1362 to the peripheral-wall plate 1364, and thereby to the rotating assembly. This may allow the startup motor to accelerate the rotating assembly toward an operational speed. In some embodiments, engagement may occur rapidly, for example requiring substantially less than one full rotation of relative motion, and the interlocked configuration may provide a secure connection capable of transferring high torque.

In some embodiments, the Edge-Drive system may be designed to remain engaged during operation to continuously transmit torque and/or to transmit power to an external load. In other embodiments, the plates may be configured to disengage when relative motion occurs in a release direction, allowing the plates to separate. Disengagement may be used, for example, during shutdown, maintenance, or embodiments where periodic engagement/disengagement is desired. In some embodiments, disengagement may be assisted or controlled using an optional clutch, brake, alignment feature, and/or indexing mechanism.

The assembled configuration shown in FIG. 13 illustrates one example integrated unit. Additional structural features and example directional locking segment geometries are described with reference to subsequent figures, and the disclosure is not limited to the segment shape or count shown.

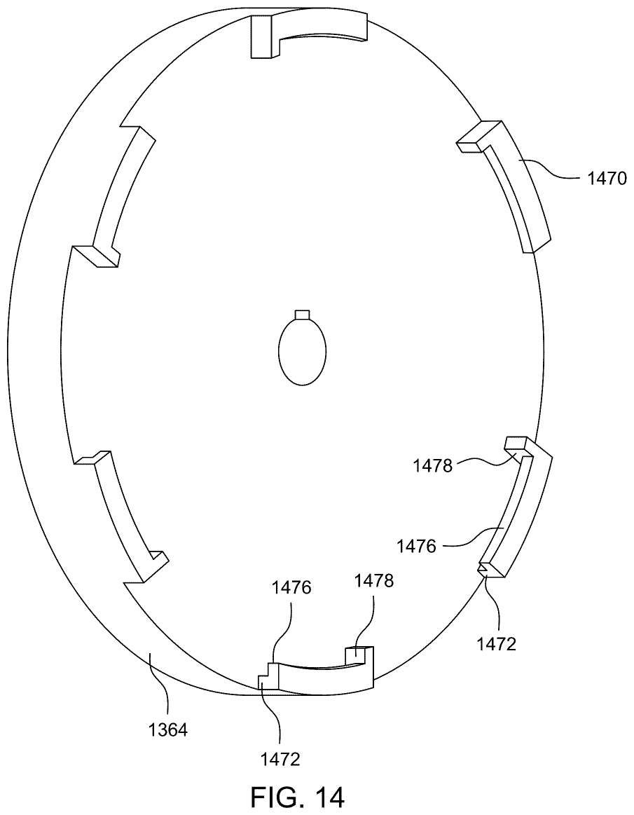

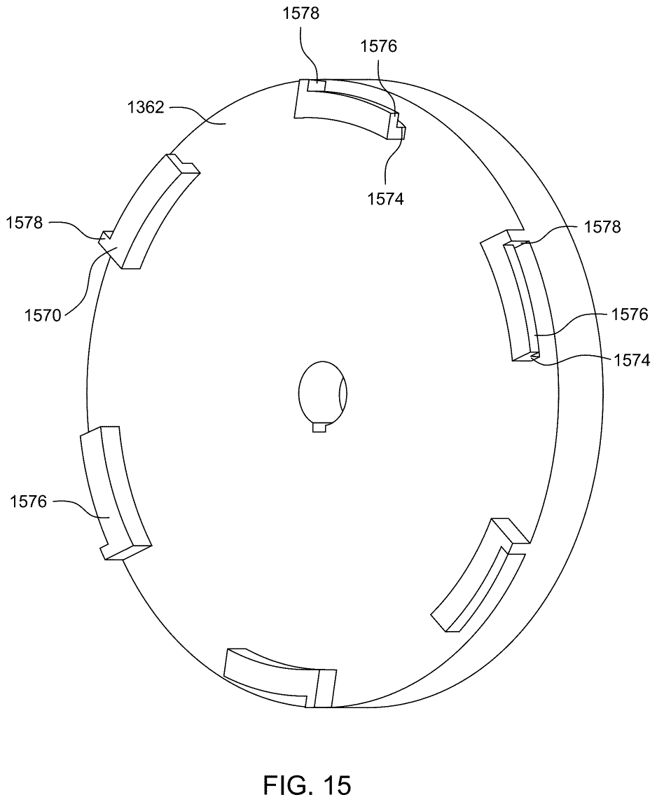

FIG. 14 is a perspective view of a peripheral-wall plate for an Edge-Drive Startup System, and FIG. 15 is a perspective view of a corresponding inset-wall plate for an Edge-Drive Startup System illustrating directional locking segments with an inset guide wall, in accordance with some embodiments. FIG. 14 shows the peripheral-wall plate 1364 with directional locking segments 1470, each including a peripheral guide wall 1472, an engagement ledge 1476, and a rotational stop 1478. FIG. 15 shows the inset-wall plate 1362 with directional locking segments 1570, each including an inset guide wall 1574, an engagement ledge 1576, and a rotational stop 1578.

The peripheral-wall plate 1364 and the inset-wall plate 1362 may be complementary components that interlock to form the power-transfer ring of the Edge-Drive system. Each plate may include a plurality of directional locking segments distributed around the periphery. In the example shown, each plate includes six directional locking segments; however, other quantities, segment sizes, and segment geometries may be used depending on scale, torque requirements, and manufacturing considerations. In general, increasing segment count and/or segment contact area may increase torque capacity and reduce localized stress.

Each directional locking segment 1470 on the peripheral-wall plate 1364 may include a peripheral guide wall 1472 extending upward from a plate surface at an outer edge region. The peripheral guide wall 1472 may define an outer boundary and lateral constraint. An engagement ledge 1476 may extend inward from the peripheral guide wall 1472, and may define a clearance space between the engagement ledge 1476 and a top surface of the plate. A rotational stop 1478 may be positioned at an end region of the segment to limit relative rotation and provide a torque-bearing contact surface during engagement.

Each directional locking segment 1570 on the inset-wall plate 1362 may include an inset guide wall 1574 extending upward from the plate surface at a radial position inward of the outer edge. An engagement ledge 1576 may extend outward from the inset guide wall 1574 toward the periphery, and may define a clearance space between the engagement ledge 1576 and a top surface of the plate. A rotational stop 1578 may be positioned at an end region of the segment to limit relative rotation and provide a torque-bearing contact surface during engagement.

When the plates are brought together and rotated relative to each other in the engagement direction, the engagement ledge 1476 of the peripheral-wall plate 1364 may slide under the engagement ledge 1576 of the inset-wall plate 1362, and correspondingly the engagement ledge 1576 may overlap with the engagement ledge 1476 such that the ledges mechanically capture each other to resist vertical separation. The peripheral guide wall 1472 and the inset guide wall 1574 may be positioned on either side of the engaged engagement ledges, preventing lateral separation. In some embodiments, engagement may occur after a relative rotation of approximately 25 to 30 degrees, although other engagement angles may be used. After engagement, the rotational stops 1478 and 1578 may contact corresponding surfaces of the opposing plate to limit further rotation in the engagement direction and to establish torque-transmitting contact. In some embodiments, tapered and/or angled surfaces on the engagement ledges may assist self-centering and alignment during engagement.

When torque is applied in the engagement direction, the rotational stops may bear against corresponding ledge and/or stop surfaces of the opposing plate, thereby transferring rotational force from one plate to the other and enabling the Edge-Drive system to transmit startup torque to the rotating assembly. In embodiments configured for release by reverse relative motion, applying torque or relative rotation in an opposite direction may allow the engagement ledges to separate, thereby releasing the plates. In other embodiments, release may be selective and may be assisted by a separate disengagement mechanism as described herein.

In some embodiments, each directional locking segment may extend less than approximately 30 degrees around a circumference of a plate. Between segments, open regions may be provided to permit overlap motion during engagement and to permit separation during disengagement in embodiments that use reverse-rotation release. Segment arc length, spacing, and wall heights may be selected based on desired engagement speed, torque capacity, manufacturability, and operating environment.

The plates may be constructed from high-strength materials such as steel, aluminum alloys, titanium alloys, and/or reinforced composites. Engagement ledges and rotational stops may be heat-treated, surface-hardened, coated, and/or otherwise reinforced to withstand repeated engagement cycles and high torque loads. The configurations shown in FIGS. 14 and 15 illustrate one example complementary plate geometry and one example mechanical principle by which directional locking segments engage and disengage. In some embodiments, the directional locking mechanism may provide one-way clutch-like behavior based on a direction of applied torque; however, the disclosure is not limited to one-way clutch operation, and other embodiments may remain engaged during operation and/or use a separate release mechanism.

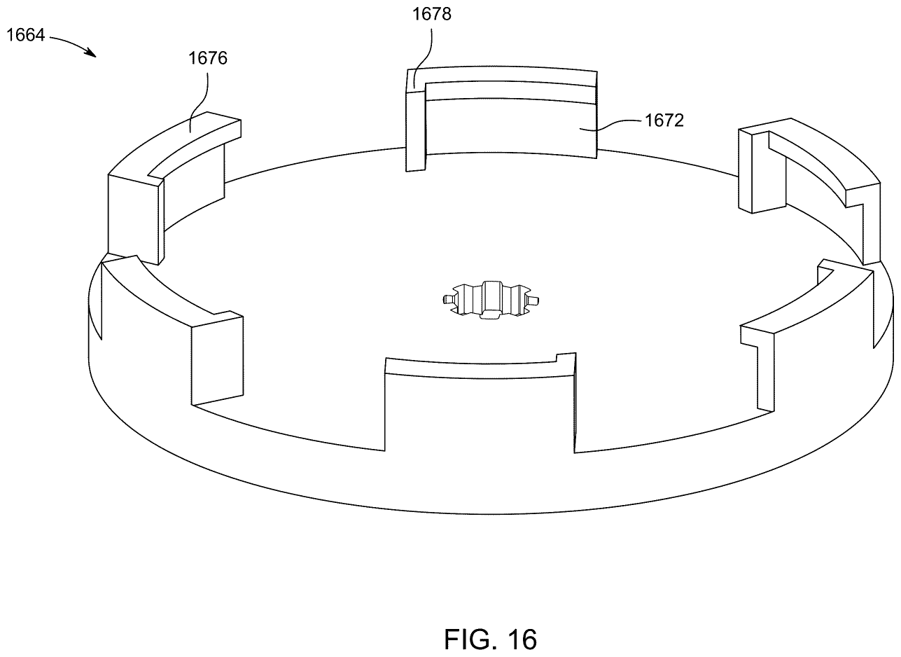

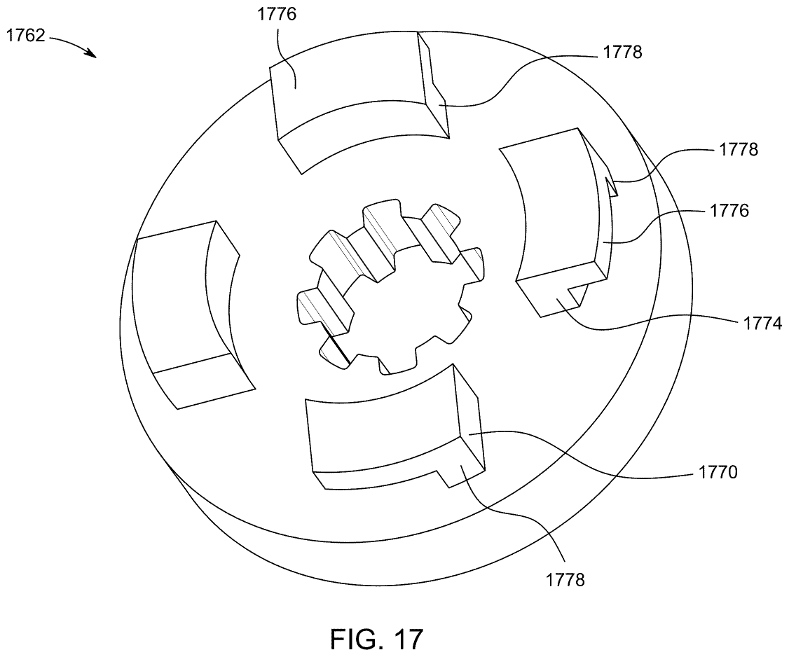

FIG. 16 is a perspective view of a peripheral-wall plate for a small-radius system, and FIG. 17 is a perspective view of an inset-wall plate for a small-radius system, in accordance with some embodiments. FIG. 16 shows a peripheral-wall plate 1664 with a peripheral guide wall 1672, an engagement ledge 1676, and a rotational stop 1678. FIG. 17 shows an inset-wall plate 1762 with directional locking segments 1770, an inset guide wall 1774, an engagement ledge 1776, and a rotational stop 1778.

The plates shown in FIGS. 16 and 17 may be scaled-down versions of the plates shown in FIGS. 14 and 15. These smaller plates may be suitable for use in small-radius RLEP systems and/or applications where lower torque transfer requirements allow a more compact edge-drive system implementation. In such embodiments, an overall plate diameter may be reduced and dimensions of directional locking segments may be correspondingly reduced.

Smaller edge-drive systems may be preferred for compact installations, lower startup torque requirements, weight-constrained designs, and/or portable or mobile RLEP units. In some embodiments, a smaller system may provide favorable torque-to-mass characteristics for assemblies having lower inertia. Smaller plates may also reduce manufacturing cost and may allow tighter tolerances and more precise engagement in certain implementations.

The structural design and operational principles of the smaller plates may be similar to those described with reference to FIGS. 14 and 15. The peripheral-wall plate 1664 may include directional locking segments with peripheral guide walls 1672 at an outer edge region, engagement ledges 1676 extending inward, and rotational stops 1678. The inset-wall plate 1762 may include directional locking segments 1770 with inset guide walls 1774, engagement ledges 1776 extending outward, and rotational stops 1778. The plates may interlock such that engagement ledges overlap to resist separation and rotational stops transfer torque through contact in an engagement direction.

The smaller size of the plates shown in FIGS. 16 and 17 may reduce material cost and weight while providing sufficient torque capacity for small-radius applications. In various embodiments, a number of directional locking segments may be the same as in larger plates or may be reduced when torque requirements are lower. The plates may be constructed from the same categories of materials as larger plates, and engagement features may be treated or hardened as needed.

The configurations shown in FIGS. 16 and 17 illustrate scalability of the edge-drive concept. By adjusting plate diameter and directional locking feature geometry, the system may be adapted across a range of RLEP sizes and torque requirements while maintaining the same fundamental mechanical principles.

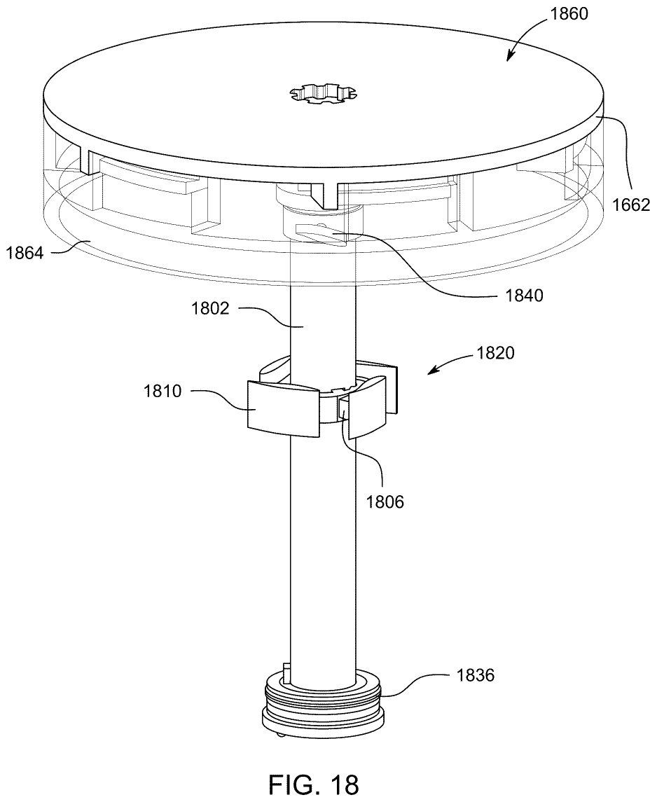

FIG. 18 is a perspective view of a rotating assembly illustrating an integrated Edge-Drive Startup System, in accordance with some embodiments. The figure shows a rotating assembly 1820 comprising a central shaft 1802, radial arms 1806, vertical airfoils 1810, an upper set of horizontal wings 1840, one or more sets of magnetic bearings 1836, an Edge-Drive system 1860, an inset-wall plate 1862, and a peripheral-wall plate 1864.

The rotating assembly 1820 shown in FIG. 18 illustrates one example integration of an edge-drive system within an RLEP rotating assembly. The central shaft 1802 may extend through the assembly. The radial arms 1806 may extend outward from the central shaft 1802, and the vertical airfoils 1810 may be mounted at radial positions to interact with the surrounding fluid and generate tangential force components that produce torque. The upper set of horizontal wings 1840 may be positioned above the vertical airfoils 1810 and may be configured as axial-load-compensation wings (e.g., lift-generating horizontal wings) to reduce axial bearing loading, as described with reference to previous figures.

The one or more sets of magnetic bearings 1836 may be positioned at a lower support region and/or an upper support region of the central shaft 1802 to provide reduced-friction support for the rotating assembly 1820. In some embodiments, magnetic bearings may reduce mechanical contact losses and reduce wear relative to rolling-element bearings at one or more support locations. The use of magnetic bearings in combination with edge-drive torque transfer may improve efficiency in certain implementations by reducing parasitic losses and improving startup behavior.

The Edge-Drive system 1860 may be positioned at an upper region of the rotating assembly 1820. The peripheral-wall plate 1864 may be attached to the rotating assembly 1820 and may rotate with it, and the inset-wall plate 1862 may be connected to a startup motor (not shown), or vice versa. When a startup motor applies torque in an engagement direction, directional locking segments may engage and transfer rotational force to the rotating assembly 1820 to accelerate the assembly toward an operational speed.

In the embodiment shown in FIG. 18, the vertical airfoils 1810 and radial arms 1806 may be relatively small while the Edge-Drive system 1860 may be relatively large. Such a configuration may be suitable for embodiments operating in higher-density fluids, including water or oil, where smaller vertical airfoils can generate substantial torque, while a robust edge-drive engagement structure is used to assist startup and/or power transfer. In such embodiments, a larger edge-drive radius may increase mechanical advantage, allowing a reduced-size startup motor for a given target angular acceleration.

The configuration shown in FIG. 18 illustrates one example complete rotating assembly with an integrated edge drive system. This design supports modular implementation, where component sizes and arrangements may be selected based on application requirements. Various sizes, angles, proportions, materials, and other features may be adjusted and combined across embodiments.

The components described in FIGS. 1 through 18 may be combined to form an RLEP system capable of converting fluid interaction with rotating airfoils into rotational energy, mechanical work, and/or electrical power. A representative RLEP system may include a rotating assembly comprising a central shaft, vertical airfoils mounted at radial positions, and one or more sets of horizontal wings. The vertical airfoils may generate tangential force components that produce torque during rotation through a fluid. The horizontal wings may be configured, in various embodiments, with lift-generating axial-load-compensation airfoils (with positive angle of attack) to reduce axial bearing load and/or with downforce-generating airfoils (with negative angle of attack) for stabilization or preload management in applicable embodiments. In lift-only pumping embodiments, downforce-generating airfoils may be omitted.

In some embodiments, the RLEP may benefit from separating and managing different force components using different airfoil sets. For example, vertical airfoils may be configured primarily for torque generation, while horizontal wings may be configured primarily for axial-load compensation and/or stabilization. By separating these functions, the system may reduce compromises associated with designs in which a single blade must manage multiple force objectives. In some embodiments, a fixed-pitch configuration of vertical airfoils combined with reduced-friction support and axial-load compensation may allow the rotating assembly to reach a rotational speed that corresponds to a balance among fluid velocity, aerodynamic loading, and connected load, without requiring complex active controls in certain implementations.

In various embodiments, RLEP systems may operate in different modes. In a turbine/harvest mode, an external fluid flow may drive rotation and a connected generator may produce electrical power. In a motor-driven mode, an external motor may drive rotation to move fluid, for example in fan or pump-type embodiments. In some embodiments, an external motor may accelerate the rotating assembly to a speed at which aerodynamic forces on the vertical airfoils contribute to sustaining rotation and delivering torque to a connected load.

An Edge-Drive Startup System may be integrated at an outer periphery of the rotating assembly to initiate rotation and/or to couple rotational power to another component. The edge-drive system may include two interlocking plates (or rings) with directional locking segments configured to engage for torque transfer from a startup motor to the rotating assembly. Depending on the embodiment, the edge-drive system may remain engaged during operation or may be selectively disengaged, for example for shutdown, maintenance, or mode switching. A power-transfer assembly may couple the rotating assembly to a generator for electrical generation and/or to other mechanical loads such as pumps, fans, propellers, gearboxes, and/or driveline components.

The modular design of the RLEP system may allow components to be scaled and configured for specific applications. Systems may range from compact units having a radius of less than approximately 1 meter to larger systems having a radius of approximately 20 meters or more for industrial-scale power generation, depending on embodiment. Applications may include wind and water turbines, pumps, aerial and marine vehicles, sealed hydraulic systems, and building climate-control and air-circulation systems. The following figures illustrate example embodiments of the RLEP system adapted for various applications.

In energy-harvesting embodiments, the RLEP system may operate as a turbine to convert kinetic energy associated with relative motion between the rotating assembly and a surrounding fluid into electrical power. In some embodiments, efficiency improvements relative to certain conventional turbine architectures may be achieved by separating torque generation and axial-load management into different airfoil sets and by reducing parasitic losses through simplified mechanical design and reduced bearing loading.

An operational sequence may begin with a startup phase during which a startup motor applies torque to the rotating assembly through an edge-drive system and/or a direct shaft connection, depending on embodiment. The startup motor may accelerate the rotating assembly from rest, causing vertical airfoils to move through the surrounding fluid. As rotational speed increases, the vertical airfoils may generate increasing aerodynamic and/or hydrodynamic forces. The angle of attack of the vertical airfoils may be configured such that a force component acts tangentially to a circular path of rotation, producing torque that contributes to continued rotation.

As the rotating assembly accelerates, it may reach a threshold speed at which tangential forces generated by the vertical airfoils become sufficient to sustain rotation and/or further accelerate the assembly with reduced or no continued input from the startup motor. Threshold speed may depend on fluid density, fluid velocity (if present as an external current), a number and size of vertical airfoils, angle of attack, rotational radius, assembly inertia, and connected load. By way of example, smaller-radius embodiments may reach a threshold speed within seconds to tens of seconds, while larger-radius embodiments may reach a threshold speed within tens of seconds to minutes, depending on configuration and operating conditions. In some embodiments, energy used for startup may be substantially recovered during subsequent energy-harvesting operation.

Once a desired operating speed and/or threshold condition is reached, the startup motor may be disengaged or otherwise decoupled. In embodiments using an edge-drive system, the edge-drive interface may remain engaged while the motor is turned off, or the interface may be selectively disengaged depending on configuration. In various embodiments, a clutch or other disconnect mechanism may be used to isolate the startup motor from the rotating assembly during normal operation.

After startup motor disengagement, the system may transition to a self-sustaining operating condition in which the rotating assembly continues rotating while extracting energy from the fluid via the vertical airfoils. In some embodiments, one or more sets of horizontal axial-load-compensation wings may generate an upward lift force component through their lift-generating airfoil shape that offsets at least a portion of the rotating assembly weight, thereby reducing axial load transmitted to bearings supporting the central shaft. When a substantial portion of the axial load is offset, bearing friction and wear may be reduced, allowing a greater portion of available fluid energy to be converted into useful rotation rather than being dissipated as mechanical loss.

Reduced bearing loading may enable startup and operation in lower external fluid velocities in certain embodiments, compared to some conventional turbine designs. By way of example, some embodiments may be configured to begin rotating and generate power at wind speeds below those typically required by certain conventional wind turbines, depending on geometry, load, and site conditions. Similarly, in water environments, some embodiments may operate in lower current velocities than certain conventional hydrokinetic turbines. In various embodiments, the system may operate within an open environment or within an enclosed or partially enclosed housing, depending on the application.

The rotating assembly may accelerate until reaching an equilibrium speed. At equilibrium, torque generated by the vertical airfoils may balance opposing torque associated with a generator load and residual losses within the system. At that point, a generator may extract power from rotation, converting mechanical rotational energy into electrical energy. Generated power may depend on rotational speed, torque available at the shaft and/or peripheral power-transfer interface, and efficiencies of the generator and power-transfer assembly.

Once operational, the system may continue generating power as fluid velocity varies. In some embodiments, fixed-pitch vertical airfoils and system load balancing may allow rotational speed to adjust based on available energy without requiring active pitch control, simplifying the mechanical design and improving reliability in certain implementations.

In some embodiments, separation of force objectives within the RLEP system may improve energy conversion characteristics relative to certain conventional designs. For example, vertical airfoils may be configured primarily for torque generation while horizontal wings may be configured primarily for axial-load management and/or stabilization. In some embodiments, such separation and reduced bearing loading may contribute to higher effective conversion efficiency under certain operating conditions. Reported efficiency values may depend on site conditions, fluid velocity distributions, generator selection, and system sizing.

In various embodiments, energy-harvesting modes may be implemented across different fluid environments. In air, the system may function as a wind-energy device. In water, the system may function as a hydrokinetic device for extracting energy from river currents, tidal flows, or ocean currents. Due to higher fluid density in water relative to air, smaller-radius embodiments may generate substantial torque at lower tip speeds in water environments, depending on configuration. Fixed-pitch vertical airfoils may allow adaptation to varying fluid velocities without active pitch mechanisms in certain embodiments.

Energy-harvesting embodiments may demonstrate versatility of the RLEP system. By using a startup motor to overcome initial inertia and then allowing aerodynamic and/or hydrodynamic forces on the vertical airfoils to sustain operation, the system may convert fluid interaction into electrical output across a range of scales and environments. Low-velocity operability, reduced mechanical complexity, and continuous generation capability may be advantageous in distributed power generation, remote locations, and applications where conventional turbine solutions are less economical, depending on embodiment.

In various embodiments, RLEP principles may be applied to pumping water. In water-pumping embodiments, the RLEP system may be configured to move fluid from one location to another and/or from a lower elevation to a higher elevation. The system may operate in multiple modes, including motor-driven pumping, externally driven pumping, and self-powered pumping, depending on embodiment.

In motor-driven water-pump configurations, external power may drive rotation to move water. A motor may be coupled to the rotating assembly through a power-transfer assembly (e.g., a shaft coupling and/or an edge drive peripheral coupling) to drive rotation at a controlled speed. In some embodiments, the rotating assembly may be positioned within a housing that guides water flow through a defined path. As the assembly rotates, vertical airfoils may interact with the water to produce torque and maintain rotation, and one or more sets of horizontal lift-generating wings may be driven by the rotating assembly to impart lift-based pumping action and/or pressure rise to move water through the system, depending on embodiment. The motor may provide energy to overcome hydraulic resistance and achieve a desired flow rate and discharge pressure.

In various self-powered water-pump configurations, a motor-assisted startup may be used to initiate self-powered pumping operation. In this mode, a motor may initially drive the rotating assembly to accelerate it to an operational speed. As rotational speed increases, the vertical airfoils may move through the water at sufficient velocity to generate hydrodynamic forces from pressure differentials and flow turning around the airfoils. Once the system reaches a threshold speed, tangential force components generated by the vertical airfoils moving through the water may become sufficient to sustain rotation without continued motor input, depending on configuration and operating conditions. At this self-sustaining speed, the motor may be disengaged or decoupled, and the vertical airfoils may continue driving rotation with sufficient speed and torque for one or more horizontal pump wings with airfoil shapes to move water through the system. This mode may be advantageous in still or slow-moving water where initial startup benefits from external power, while sustained operation may be maintained by the hydrodynamic forces generated by the rotating assembly.

In various self-powered water-pump configurations, the RLEP system may be positioned in a flowing water source such as a river, stream, or irrigation canal. Flowing water may drive the vertical airfoils, causing the rotating assembly to spin, similar to energy-harvesting operation in which the vertical airfoils extract kinetic energy from moving fluid. In pump embodiments, rotational energy may be used to drive a pumping action, for example by driving one or more horizontal wings with lift-based pump airfoils and/or by using the rotating assembly's induced flow in a housing designed to direct water toward an outlet. The system may operate without an external motor, powered by kinetic energy of the flowing water, and may be advantageous for irrigation, livestock watering, or remote water supply where electrical power is unavailable.

In some embodiments, a hybrid operation may be used in which a motor assists during startup and/or during low-flow conditions, and the system transitions to self-powered operation once sufficient water flow and/or rotational speed is available.

In water-pump embodiments, horizontal wings with airfoils may serve one or more functions depending on configuration. In some embodiments, horizontal wings may be configured with axial-load-compensation airfoils with a positive angle of attack to generate upward lift that reduces axial load on bearings, thereby reducing friction and improving efficiency in motor-driven and/or self-powered pumping. In pump embodiments, horizontal wings may also be configured with lift-based pumping airfoils that, when rotated, contribute to moving water upward and/or through a defined flow path. In such embodiments, downforce-generating wings may be omitted.

In embodiments using horizontal wings with lift-based pumping airfoils, rotation of the horizontal wings may produce a pressure differential and flow direction change that drives water circulation through a pump housing. For example, as horizontal wings with lift-based airfoils rotate, they may accelerate and redirect water to create a net upward and/or outlet-directed flow component, depending on housing geometry and inlet/outlet placement. The magnitude of pumping effect may depend on rotational speed, airfoil geometry, angle of attack, radius, and housing design.

A pump housing may include an inlet positioned to capture water and direct it through a defined flow path relative to the rotating assembly. The inlet may be positioned at a lower elevation and/or oriented to capture flowing water from a stream or canal. An outlet may be positioned at a higher elevation and/or coupled to a discharge pipe to direct water to a target location such as an irrigation field, storage tank, or livestock watering station. In some embodiments, housing geometry and operating speed may be selected to maintain stable pressure conditions and reduce adverse pressure transients.

The water-pump embodiment may demonstrate versatility of the RLEP system. A rotating assembly using vertical airfoils and horizontal wings may be used in energy harvesting (turbine mode), motor-driven pumping, and self-powered pumping. The modular nature of the system may allow horizontal wings to be configured for axial-load compensation and/or lift-based pumping depending on the arrangement of airfoils and based on application requirements. The ability to operate without external power in self-powered mode, and/or to reduce energy consumption in motor-driven mode through reduced bearing loading and efficient torque generation, may provide operational advantages over certain conventional pump designs. The following figures illustrate example embodiments of the RLEP system configured for specific applications.

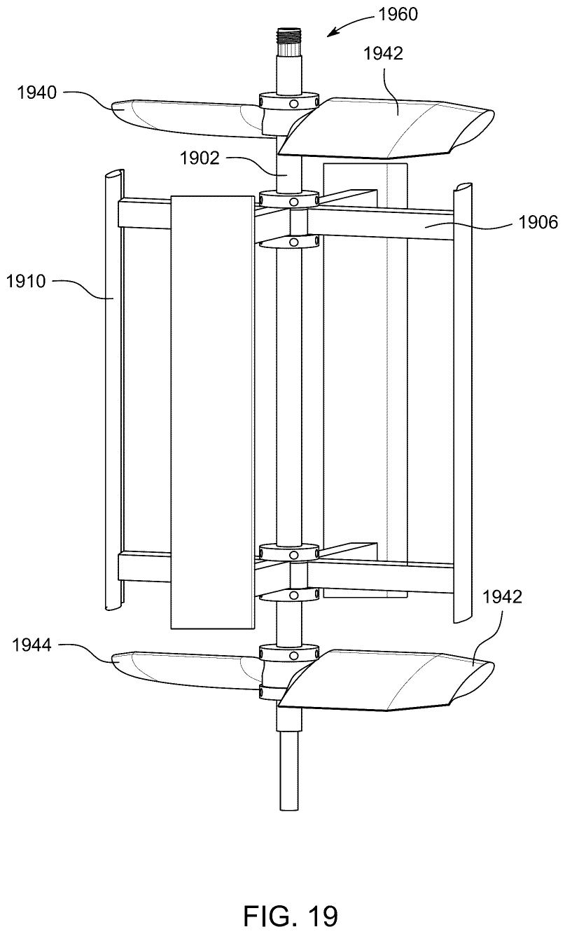

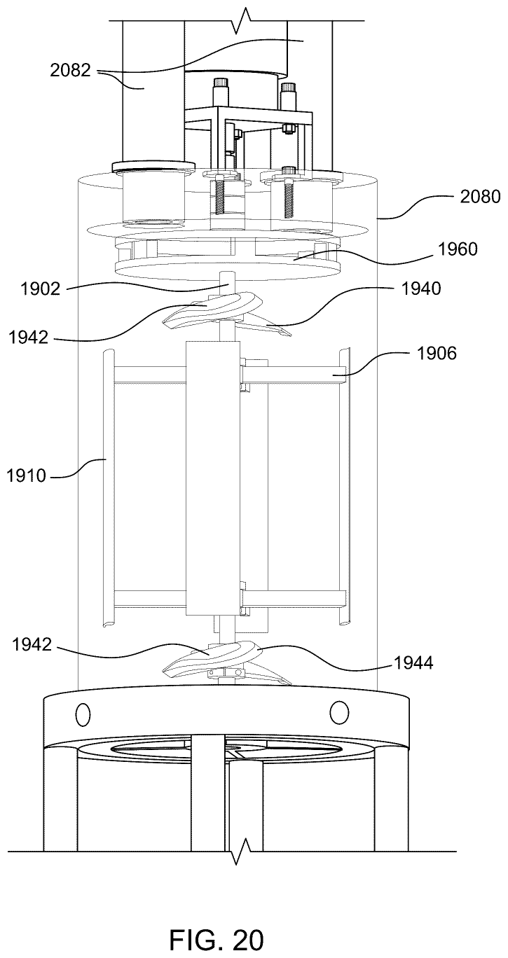

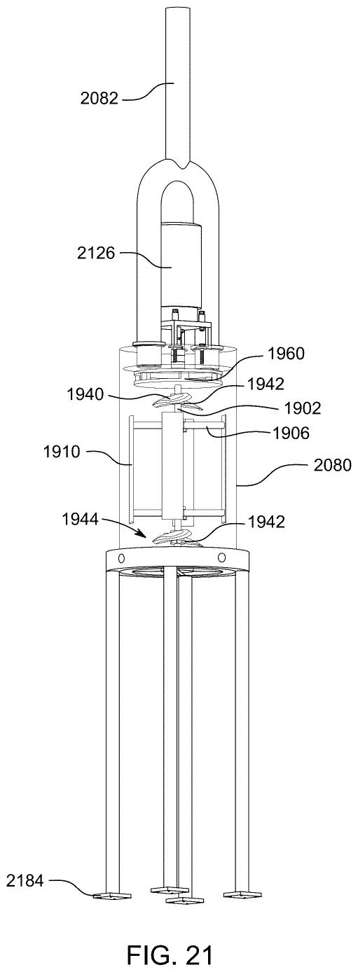

FIG. 19 is a perspective view of a rotating assembly for a water-pump system illustrating vertical airfoils and horizontal wings, FIG. 20 is a perspective view of a water-pump system illustrating the rotating assembly of FIG. 19 within a pump housing, and FIG. 21 is a perspective view of the water-pump system of FIG. 20 illustrating a support base and a wishbone-shaped outlet, in accordance with some embodiments.

FIG. 19 shows a rotating assembly comprising a central shaft 1902, radial arms 1906, vertical airfoils 1910, an upper set of horizontal wings 1940 with axial-load-compensation airfoils 1942, a lower set of horizontal wings 1944, and an Edge-Drive System 1960. The rotating assembly shown in FIG. 19 may be configured for water-pumping applications. The central shaft 1902 may extend through the assembly. The radial arms 1906 may extend outward from the central shaft 1902, and the vertical airfoils 1910 may be mounted at ends of the radial arms 1906. In the embodiment shown, two sets of radial arms may support the vertical airfoils 1910 (e.g., upper and lower supports) to improve structural stability for operation in a dense fluid environment such as water.

In the embodiment shown in FIG. 19, the upper set of horizontal wings 1940 may include axial-load-compensation airfoils 1942 configured with a positive angle of attack. The lower set of horizontal wings 1944 may also include axial-load-compensation airfoils 1942 configured with a positive angle of attack. In some embodiments, lift generated by one or more sets of horizontal wings with axial-load-compensation airfoils may substantially offset axial bearing load associated with the rotating assembly, thereby reducing friction and improving efficiency.

In this configuration, a primary pumping mechanism may be driven by rotation of the assembly, including hydrodynamic torque generated by the vertical airfoils 1910 and/or pumping contributions from horizontal wings with lift-based airfoils where included. A pump housing 2080 may be configured to direct induced flow toward an outlet 2082. In some embodiments, the rotating assembly may impart kinetic energy to the water and create a pressure rise that drives water through the housing and toward the outlet, analogous to an impeller-type pumping action, while maintaining the separation of torque generation and axial-load management functions across different airfoil sets.

This embodiment may be suitable for self-powered pumping applications in which the system is positioned in flowing water such as a stream or river. Flowing water may drive the vertical airfoils 1910, causing the rotating assembly to spin. Rotational energy may then be used to pump water to a higher elevation and/or to a different location. Reduced axial bearing loading provided by axial-load-compensation airfoils may improve efficiency and may enable operation at lower available driving flow energies, depending on site conditions and configuration.

In various embodiments, a system having horizontal wings with axial-load-compensation airfoils having positive angles of attack may be used in motor-driven mode, where a motor drives rotation and the rotating assembly produces pumping action. Reduced axial bearing loading may reduce power required from the motor compared to configurations with higher bearing load, improving energy efficiency. In some embodiments, a motor may bring the system to an operating speed, and the system may transition to self-powered operation when sufficient water flow is available, as described above.

In various embodiments, a water-pumping system may include one or more sets of horizontal wings with lift-generating airfoils configured for axial-load reduction and/or lift-based pumping contribution. For example, the lower set of horizontal wings 1944 may be configured with lift-generating airfoils 1942 with a positive angle of attack, similar to the upper set of horizontal wings 1940. In such embodiments, the upper set of horizontal wings 1940 and the lower set of horizontal wings 1944 may both operate to reduce axial bearing load and improve efficiency, and one or both sets may also contribute to lift-based pumping action depending on housing geometry and flow path design.

In some pump embodiments, one or more sets of horizontal lift-generating airfoils 1942 may contribute to the pumping mechanism by accelerating and redirecting water to create a net pressure rise and/or net upward/outlet-directed flow component within a pump housing. In such embodiments, rotation of the airfoils may establish a circulation pattern and pressure gradient that moves water from an inlet region to an outlet region.

The pump housing 2080 may be shaped to convert induced rotational flow and lift-induced pressure differentials into a desired discharge flow. For example, water may be drawn into the pump housing through an inlet, may be accelerated by the rotating assembly, and may be directed by internal housing geometry toward an outlet 2082. Vertical airfoils 1910 may contribute by generating tangential torque to sustain rotation, while horizontal wings with lift-generating airfoils may contribute by generating axial flow components and/or reducing bearing load, depending on configuration.

In some embodiments, system stability and operational robustness may be enhanced by structural supports, bearing selection, shrouds, and/or housing clearances selected to reduce vibration and maintain alignment. In water environments, cavitation risk may be managed by selecting operating speed, inlet geometry, pressure margins, and airfoil geometry appropriate to the application and by avoiding operating regimes that produce excessive localized low pressure.

Pump embodiments may be configured for motor-driven pumping and/or self-powered pumping depending on the application requirements. In motor-driven embodiments, an external motor may provide continuous drive torque to achieve target flow and discharge pressure. In self-powered embodiments, flowing water may provide the driving energy to rotate the assembly and sustain pumping. Design parameters such as radius, airfoil area, rotational speed, housing geometry, and discharge piping may be selected to meet target head and flow.

FIG. 20 shows the rotating assembly of FIG. 19 positioned within a pump housing 2080. The pump housing 2080 may enclose the rotating assembly and may direct water flow through the system. In various embodiments, an outlet 2082 may extend from the pump housing 2080. The pump housing 2080 may be shown in phantom to allow the rotating assembly to be visible inside, illustrating relative positioning of vertical airfoils 1910 and horizontal wings 1940, 1944 within the housing.

The pump housing 2080 may include an inlet positioned at a bottom or side region of the housing to allow water to enter and flow through the rotating assembly. The inlet may include a screen or filter to reduce debris ingress. Internal geometry of the pump housing 2080 may be configured to guide flow induced by the rotating assembly toward the outlet 2082, depending on whether pumping action is produced primarily by the rotating assembly's induced flow, by lift-based pressure differentials generated by horizontal wings with airfoils, or by a combination thereof.

FIG. 21 shows a complete water pump system including the pump housing 2080, the outlet 2082, a support base 2184, and a startup motor 2126. In various embodiments, the outlet 2082 may have a wishbone-shaped or Y-shaped structure to permit discharge in multiple directions and/or to provide structural support for discharge piping. The support base 2184 may provide a foundation for positioning the system in a water source such as a stream, canal, or well. The pump system may be installed vertically as shown or at an angle, and may be partially or fully submerged depending on the application.

The startup motor 2126 may be positioned at an upper region of the system and may be connected to the Edge-Drive System 1960 (or another coupling) to initiate rotation of the rotating assembly. In motor-driven pumping mode, the motor may operate continuously to drive the pump. In self-powered pumping mode, the motor may operate during startup to reach an operating condition and may then be disengaged or turned off as the rotating assembly is driven by the surrounding flow, depending on embodiment.

In one example embodiment, a water pump system having a rotating assembly radius of approximately 2 meters and operating at approximately 60 to 100 revolutions per minute may pump water at a rate of approximately 100 to 500 liters per minute to a height of approximately 5 to 15 meters, depending on airfoil geometry, housing design, inlet/outlet configuration, discharge piping, operating speed, and water source conditions. These values are provided as non-limiting examples and may vary based on implementation details.

The configuration shown in FIGS. 19-21 illustrates an example water-pump systems based on the RLEP platform. The example demonstrates integration of vertical airfoils, horizontal wings with airfoils, an Edge-Drive startup coupling, and support structures into a pump capable of operating in motor-driven and/or self-powered modes. The modular design may allow sizing and configuration of airfoils and housings to meet different pumping requirements.

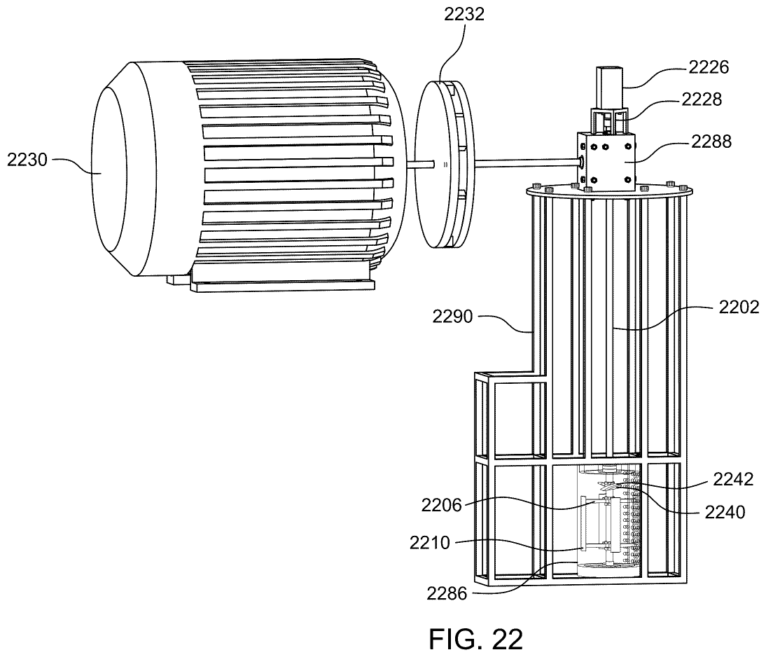

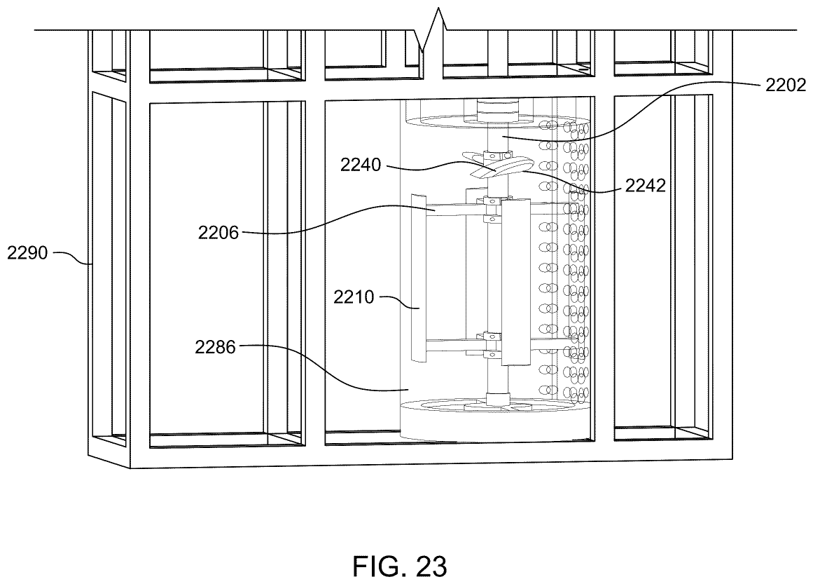

FIG. 22 is a perspective view of an underwater energy-harvesting system illustrating a submerged rotating assembly and a top-side power-transfer assembly, and FIG. 23 is a detailed perspective view of the system of FIG. 22 illustrating a rotating assembly within a protective shroud, in accordance with some embodiments. FIG. 22 shows an underwater energy-harvesting system comprising a rotating assembly positioned underwater, a central shaft 2202 extending upward from the rotating assembly, a power-transfer assembly 2288 positioned above a water surface, a startup motor 2226, a startup motor clutch 2228, a generator 2230, a generator clutch 2232, a protective shroud 2286, and a support frame 2290. The system may be configured to extract energy from underwater currents (e.g., ocean currents, tidal flows, or river currents) and convert that energy into electrical power.

The rotating assembly may be positioned underwater at a depth ranging from approximately 1 to 10 meters below a water surface. In some embodiments, a depth of approximately 2 to 5 meters may provide a practical balance between accessibility for installation and maintenance and exposure to consistent current flow, depending on site conditions. In various embodiments, the rotating assembly may be powered entirely or at least partially by natural currents in the surrounding water. Movement of the water may drive rotation of the assembly about a central axis, thereby enabling rotational power transfer for energy harvesting.

The rotating assembly may include vertical airfoils 2210 mounted on radial arms 2206 extending from a central shaft 2202. The rotating assembly may also include an upper set of horizontal wings 2240 configured with axial-load-compensation airfoils 2242 having a positive angle of attack. The axial-load-compensation airfoils 2242 may generate upward lift that reduces axial load on bearings supporting the central shaft 2202, thereby reducing friction and improving efficiency in underwater operation.

A protective shroud 2286 may surround the rotating assembly. The protective shroud 2286 may be a housing including a series of holes or openings. In some embodiments, hole diameters may be in a range of approximately 5 to 15 centimeters, sized to permit water flow through the shroud to interact with the vertical airfoils 2210 while reducing the likelihood of entry by larger marine life and reducing direct contact risk with rotating components. The protective shroud 2286 may also reduce the likelihood of damage from larger debris that could otherwise interfere with rotation. In various embodiments, openings may be provided on one side or in selected regions of the shroud to preferentially direct current flow toward one side of the vertical airfoils, thereby increasing a net driving torque about the central axis.

A support frame 2290 may provide structural support for the system. The support frame 2290 may be anchored to a seabed, riverbed, or other underwater surface to hold the rotating assembly in position relative to current flow. Anchoring methods may include pilings, concrete foundations, weighted bases, and/or other anchoring structures depending on substrate conditions and current forces. The support frame 2290 may be designed to withstand forces exerted by the water current and by operation of the rotating assembly.

The central shaft 2202 may extend upward from the rotating assembly toward the water surface. The central shaft 2202 may be sized to transmit torque from the submerged rotating assembly to a power transfer assembly 2288 positioned above the water surface. Submerged components may be constructed from corrosion-resistant materials such as stainless steel, titanium, and/or marine-grade aluminum, and/or may include protective coatings suitable for saltwater environments.

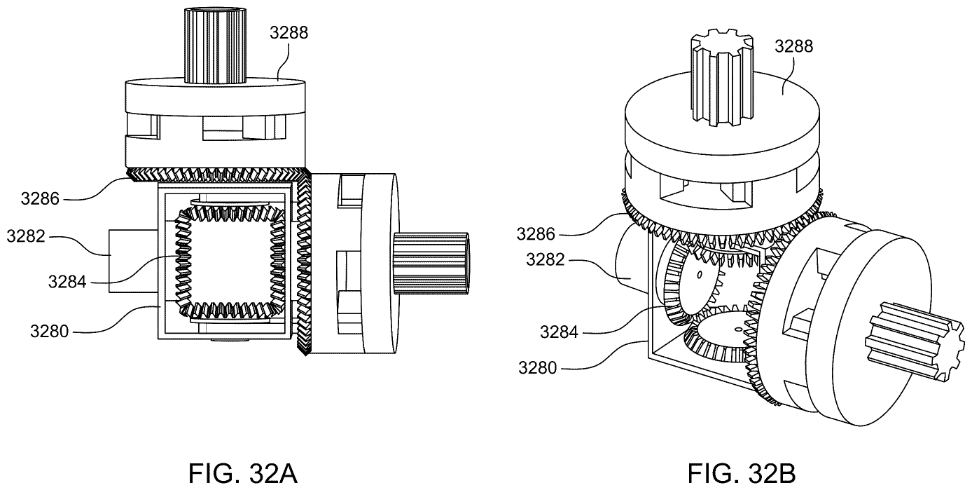

The power transfer assembly 2288 may be positioned above the water surface and coupled to the top of the central shaft 2202. The power transfer assembly 2288 may manage connections among the central shaft 2202, a startup motor 2226, and a generator 2230. In some embodiments, the power transfer assembly 2288 may include internal and/or external gear sets (e.g., as described later with reference to FIGS. 32A-B) enabling selective engagement of different components based on an operational mode.

The startup motor 2226 may be connected to the power transfer assembly 2288 through a startup motor clutch 2228. During startup, the startup motor 2226 may apply torque through the power transfer assembly 2288 to the central shaft 2202 to accelerate the submerged rotating assembly. Once the rotating assembly reaches a speed at which water current provides sufficient driving torque to sustain rotation, the startup motor clutch 2228 may disengage to decouple the startup motor 2226.

The generator 2230 may be connected to the power transfer assembly 2288 through a generator clutch 2232. Once the rotating assembly reaches an operating speed suitable for generation, the generator clutch 2232 may engage, allowing the generator 2230 to extract power from rotation of the central shaft 2202. The generator 2230 may convert mechanical rotational energy into electrical energy, which may be transmitted to shore or to other electrical systems via cables.

FIG. 23 provides a detailed view of the rotating assembly within the protective shroud 2286. This view may show the vertical airfoils 2210, the radial arms 2206, and the upper horizontal wings 2240 with axial-load-compensation airfoils 2242 more clearly. The protective shroud 2286 may be shown with holes or openings illustrating how water may flow through the shroud to interact with the rotating assembly while providing protective separation from debris and marine life.

The underwater energy harvesting system shown in FIGS. 22 and 23 may operate in a manner similar to energy-harvesting modes described above. Water current may flow through the protective shroud 2286 and interact with the vertical airfoils 2210. The vertical airfoils 2210 may generate tangential force components that produce torque, causing the rotating assembly to spin. The axial-load-compensation airfoils 2242 may reduce axial bearing load, thereby reducing friction and improving efficiency. Rotation may be transmitted through the central shaft 2202 to the power transfer assembly 2288 and generator 2230 to produce electrical power.

In some embodiments, the system may begin generating electrical power in relatively low current velocities, for example on the order of approximately 0.5 to 1 meter per second, depending on assembly radius, airfoil sizing, bearing configuration, generator selection, and site conditions. In one non-limiting example, a system having a rotating assembly radius of approximately 3 meters operating in a water current of approximately 2 meters per second may generate on the order of approximately 5 to 15 kilowatts of electrical power, depending on generator efficiency, gearing, and airfoil configuration.

The system may be advantageous for extracting energy from consistent underwater currents such as ocean currents or tidal flows, which may provide reliable energy availability in some locations. The protective shroud 2286 may address environmental considerations by reducing direct interaction risk with marine life while allowing current flow to drive the rotating assembly. Positioning the power transfer assembly 2288 and generator 2230 above the water surface may simplify maintenance access and may reduce exposure of these components to corrosive underwater conditions. FIGS. 22 and 23 illustrate how the RLEP platform may be adapted for underwater energy-harvesting applications across different fluid environments and operating conditions.

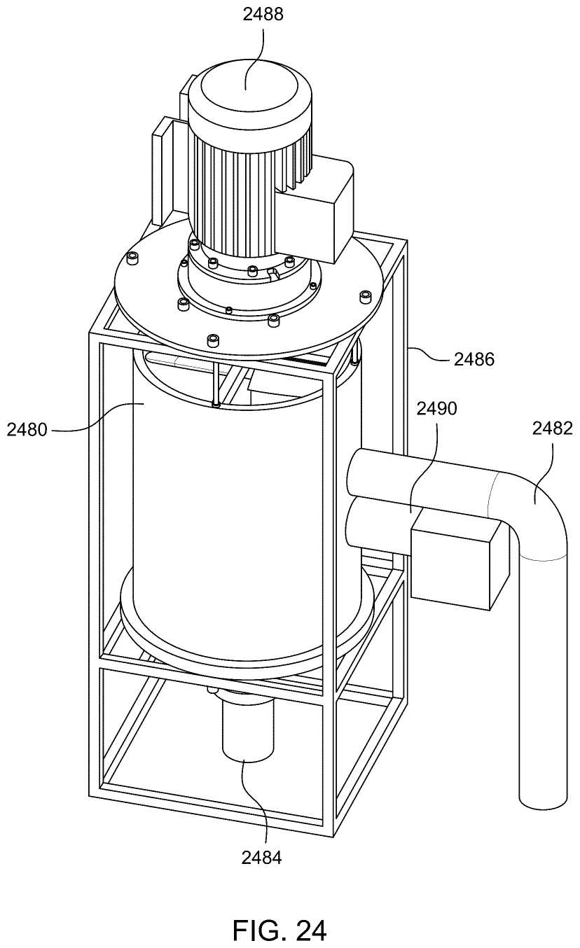

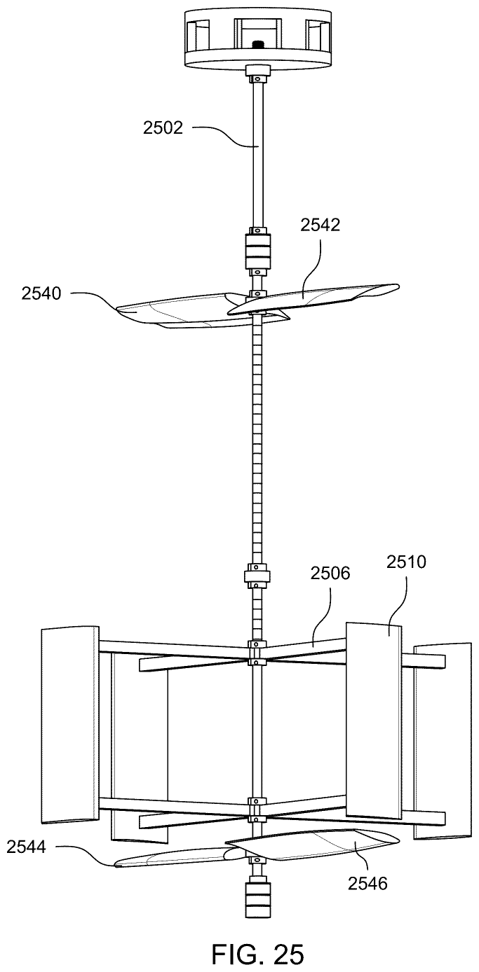

FIG. 24 is a perspective view of a stratified air movement system illustrating a housing with multiple inlets and outlets, in accordance with some embodiments, and FIG. 25 is a perspective view of a rotating assembly for the system of FIG. 24 illustrating upper and lower sets of horizontal wings separated by an isolation region, in accordance with some embodiments.

FIG. 24 shows a stratified air movement system comprising a housing 2480, a primary inlet 2482, a secondary inlet 2484, a support frame 2486, a motor 2488, and a primary outlet 2490. The system may be configured to move two separate, substantially non-mixing air streams using a single rotating assembly. This capability may allow operation as a dual-zone air handler, ventilation system, or specialized industrial air mover. In some embodiments, the system may support two separate duct networks within the same building or facility.

The housing 2480 may enclose the rotating assembly and direct airflow through the system. The housing 2480 may be open at a top region to allow an air stream to exit upward. The housing 2480 may include tubes and/or ducts providing inlet and outlet connections. The primary inlet 2482 may be positioned at a lower region of the housing 2480. The primary outlet 2490 may extend from a side region of the housing 2480 at a lower position. The secondary inlet 2484 may extend from a side region of the housing 2480 at a higher position, above the primary outlet 2490.

The motor 2488 may be positioned at an upper region of the system and may drive the rotating assembly through the edge-drive system 2460. The motor 2488 may provide power to rotate the assembly at speeds suitable for moving air through both primary and secondary flow paths. In some embodiments, varying rotational speed may adjust both airflow rates while maintaining separation between the two streams. The support frame 2486 may provide structural support for the housing 2480, motor 2488, and associated components.

FIG. 25 shows a rotating assembly for the stratified air movement system. The rotating assembly may comprise a central shaft 2502, radial arms 2506, vertical airfoils 2510, an upper set of horizontal wings 2540 with axial-load-compensation airfoils 2542, and a lower set of horizontal airfoils 2544 with downforce-generating airfoils 2546. The rotating assembly shown in FIG. 25 may be configured to create two airflow zones within the housing 2480.

The lower set of horizontal wings 2544 may include downforce-generating airfoils 2546 configured with a negative angle of attack. The vertical airfoils 2510 may be positioned above the lower set of horizontal wings 2544. The upper set of horizontal wings 2540 may include axial-load-compensation airfoils 2542 configured with a positive angle of attack. The upper set of horizontal wings 2540 may be positioned above the vertical airfoils 2510, providing a vertical separation distance between the upper horizontal airfoil set and the lower airflow-driving region.

This vertical separation distance may function as an isolation region (e.g., an isolation plenum) in which the two airflow systems operate with reduced mixing. In some embodiments, the isolation region may be formed primarily by spacing and flow-direction differences (aerodynamic separation). In other embodiments, an internal divider, baffle, or sealing structure may be used to further reduce mixing between the two airflow paths. In some embodiments, a vertical separation distance may be in a range of approximately 0.5 to 2 meters, depending on system size and a desired level of separation.

A primary airflow system may be driven by the lower horizontal wings 2544 with downforce-generating airfoils 2546 and, in some embodiments, assisted by induced flow from the vertical airfoils 2510. As the rotating assembly spins, the downforce-generating airfoils 2546 may produce a downward-directed flow component and create a higher-pressure region in a lower part of the housing 2480, which may direct air outward toward the primary outlet 2490. The downward flow and rotation may also create a lower-pressure region that draws air in through the primary inlet 2482. In this manner, a continuous primary airflow may be established: air enters through the primary inlet 2482, is accelerated and pressurized in the lower region of the housing, and exits through the primary outlet 2490. In some embodiments, the primary airflow path may be configured to provide higher static pressure capability for overcoming resistance such as ductwork, filters, and/or other flow restrictions.

A secondary airflow system may be driven by the axial-load-compensation airfoils 2542. As the rotating assembly spins, the axial-load-compensation airfoils 2542 may generate upward lift and an associated low-pressure region below the airfoils that draws air in through the secondary inlet 2484. Air drawn through the secondary inlet 2484 may be accelerated upward and may exit through an open top region of the housing 2480, thereby establishing a continuous secondary airflow: air enters through the secondary inlet 2484, is accelerated upward, and exits through the open top.

The vertical separation between the upper horizontal wings 2540 and the vertical airfoils 2510 may allow the primary and secondary airflow systems to operate with reduced interaction. The separation may be achieved aerodynamically via spacing and opposing flow directions and/or may be reinforced by a divider or sealing features in some embodiments. This arrangement may allow the system to move two air streams simultaneously without requiring multiple motors.

The separation may be understood in terms of pressure and flow dynamics. The lower airflow system may create a higher-pressure region that directs air toward the primary outlet 2490, while the upper airflow system may create a lower-pressure region that draws air upward toward the open top of the housing 2480. The isolation region may be configured such that turbulent mixing at boundaries of each flow zone is reduced and does not significantly couple the two streams under expected operating conditions. The secondary inlet 2484 may be positioned to deliver air into the isolation region and toward the upper airflow zone. The primary flow zone may be configured to direct air predominantly outward through the primary outlet rather than upward into the secondary zone.

In some embodiments, the two airflow paths may handle air at different temperatures with reduced mixing, which may be useful for applications in which hot and cold air streams are moved simultaneously, such as heat-recovery ventilation, industrial drying, or multi-zone climate-control systems.

In one non-limiting example, a system having a rotating assembly radius of approximately 1 meter operating at approximately 200 to 400 revolutions per minute may move approximately 500 to 2000 cubic meters per hour through the primary airflow path and approximately 300 to 1000 cubic meters per hour through the secondary airflow path. These values are provided as examples and may vary depending on housing geometry, duct resistance, airfoil configuration, and operating conditions. Airflow rates may be adjusted by varying rotational speed of the motor 2488.

The stratified air movement system shown in FIGS. 24 and 25 may be used as a dual-zone ventilation system in which fresh air is moved through one flow path and stale air is moved through another with reduced mixing. The system may be used in industrial processes requiring two separate air streams, including drying, cooling, filtration, and heat-recovery ventilation applications. The ability to move two air streams using a single motor and rotating assembly may provide energy and cost advantages over systems requiring separate fans or blowers, depending on application constraints. These embodiments illustrate adaptation of the RLEP platform for specialized air-movement applications and demonstrate advantages associated with force-vector management using different airfoil sets.

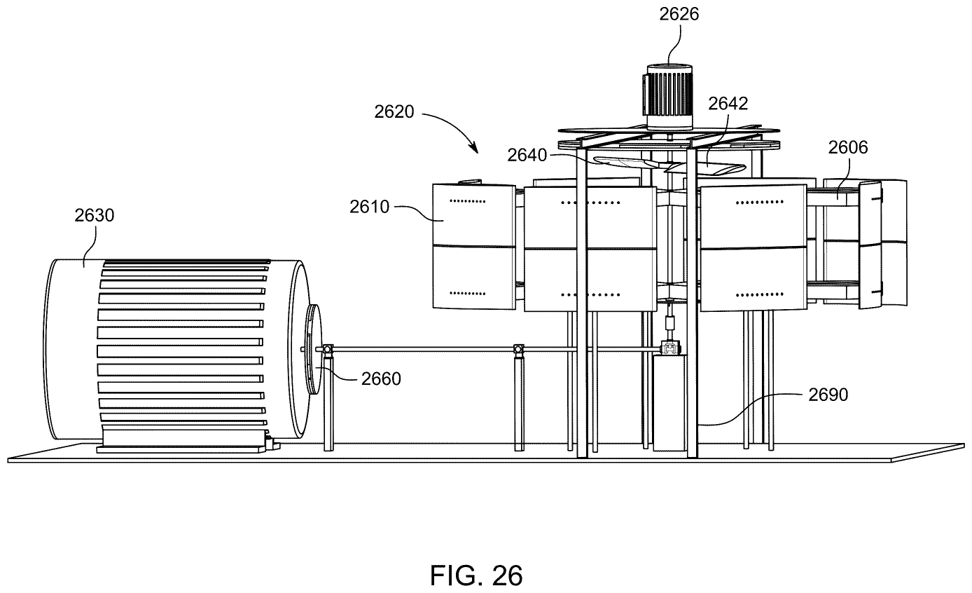

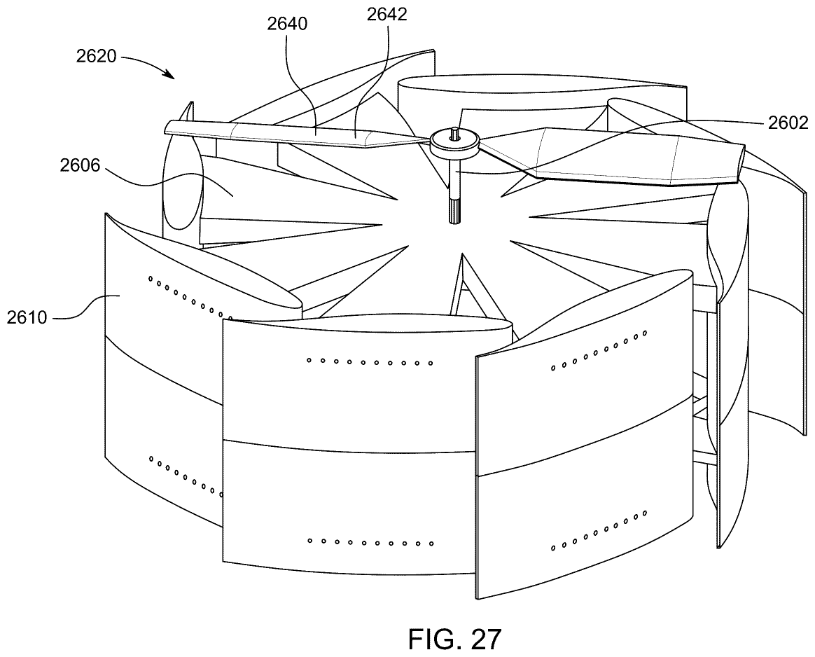

FIG. 26 is a perspective view of an open-air energy harvesting system, and FIG. 27 is a perspective view of a rotating assembly for the system of FIG. 26, in accordance with some embodiments. FIG. 26 shows an open-air energy harvesting system comprising a rotating assembly 2620, a central shaft 2602, radial arms 2606, vertical airfoils 2610, an upper set of horizontal wings 2640 with axial-load-compensation airfoils 2642, a startup motor 2626, a generator 2630, an edge-drive coupling 2660, a power transfer assembly 2688, and a support frame 2690. The system may be configured to extract energy from wind or other air currents and convert that energy into electrical power. In this embodiment, the rotating assembly may be directly exposed to wind without an enclosing housing.

The rotating assembly 2620 may be positioned at an upper region of the support frame 2690 to capture wind at higher velocities. The support frame 2690 may function as a tower and may have a height ranging from approximately 10 to 100 meters in some embodiments. Taller towers may provide access to stronger and more consistent winds at higher altitudes, depending on site conditions. The rotating assembly 2620 may include the central shaft 2602, radial arms 2606, vertical airfoils 2610, and the upper set of horizontal wings 2640 including axial-load-compensation airfoils 2642. The vertical airfoils 2610 may be mounted at ends of the radial arms 2606 extending outward from the central shaft 2602. The horizontal wings with axial-load-compensation airfoils 2642 may be positioned above the vertical airfoils 2610 and configured with a positive angle of attack to generate upward lift that reduces axial bearing load.

The support frame 2690 may provide a stable structure to elevate the rotating assembly 2620 and to support power-generation components. The support frame 2690 may be anchored to a foundation and may be designed to withstand wind loads and operational forces generated by the rotating assembly 2620.

In various embodiments, a startup motor may be aligned axially with, and positioned above, the rotating assembly. In other embodiments, a startup motor may be located near ground level and coupled to the rotating assembly through a power transfer assembly 2688. In various embodiments, the power transfer assembly 2688 may be positioned below the rotating assembly 2620 and coupled to the central shaft 2602. The power transfer assembly 2688 may manage connections among the central shaft 2602, the startup motor 2626, and the generator 2630, for example as described with reference to FIGS. 32A-B. Positioning the power transfer assembly 2688 and generator 2630 at a lower elevation than the rotating assembly may simplify maintenance and may reduce reliance on specialized lifting equipment for servicing these components.

The startup motor 2626 may be coupled to the power transfer assembly 2688 and may be used to bring the rotating assembly 2620 up to an operating speed during startup. An edge-drive system 2660 may provide a torque-transfer interface between the startup motor 2626 and the rotating assembly 2620 in some embodiments, enabling efficient torque transfer during startup. Once the rotating assembly 2620 reaches a threshold speed at which wind provides sufficient driving torque to sustain rotation, the startup motor 2626 may be disengaged or decoupled.

The generator 2630 may be coupled to the power transfer assembly 2688 and may extract power from rotation of the central shaft 2602 once the system is operating at sufficient speed. The generator 2630 may convert mechanical rotational energy into electrical energy delivered to an electrical grid, battery storage, and/or other electrical loads.

FIG. 27 shows the rotating assembly 2620 in isolation. The rotating assembly 2620 may include the central shaft 2602, radial arms 2606, vertical airfoils 2610, and an upper set of horizontal wings 2640 including axial-load-compensation airfoils 2642. This view illustrates how vertical airfoils 2610 may be positioned to interact with wind and generate tangential force components, and how axial-load-compensation airfoils 2642 may be positioned above to reduce axial bearing load.

The open-air energy harvesting system shown in FIGS. 26 and 27 may operate in an energy-harvesting mode. Wind may flow through and around the rotating assembly 2620 and interact with the vertical airfoils 2610. The vertical airfoils 2610 may generate tangential force components that produce torque, causing the rotating assembly 2620 to spin. The axial-load-compensation airfoils 2642 may generate an upward lift component that offsets at least a portion of the rotating assembly weight, reducing axial load on bearings and thereby reducing friction. Rotation may be transmitted through the central shaft 2602 to the power transfer assembly 2688 and generator 2630 to produce electrical power.

In some embodiments, the system may be configured to start and/or generate power at relatively low wind speeds, for example on the order of approximately 1 to 2 meters per second, depending on assembly radius, airfoil sizing, bearing configuration, generator selection, and site conditions. In some embodiments, a fixed-pitch configuration of the vertical airfoils 2610 may allow the system to self-regulate rotational speed based on wind velocity and connected load.

In one non-limiting example, a system having a rotating assembly radius of approximately 10 meters positioned on a tower of approximately 30 meters in height and operating in average wind conditions of approximately 6 to 8 meters per second may generate on the order of approximately 50 to 150 kilowatts of electrical power. Actual power output may depend on wind conditions, generator efficiency, drivetrain configuration, and rotating assembly geometry.

In some embodiments, the RLEP wind turbine may provide advantages relative to certain conventional horizontal-axis wind turbines. For example, some embodiments may reduce or eliminate a need for active yaw control because vertical airfoils may interact with wind from multiple directions, depending on arrangement. In some embodiments, the mechanical design may be simplified, and with fewer moving parts, relative to systems requiring blade pitch control and yaw control. The ability to operate at lower wind speeds in some configurations may allow deployment in locations where conventional turbines are less economical, depending on site conditions and regulatory constraints.

Multiple RLEP wind turbines may be installed in arrays to increase total generation. The modular design may allow systems to be scaled, for example from smaller installations having rotating assembly radii of approximately 1 to 3 meters to larger installations having rotating assembly radii of approximately 10 to 20 meters or more.

The open-air configuration shown in FIGS. 26 and 27 may be suitable for locations with consistent wind resources such as open plains, coastal areas, or elevated terrain. Absence of an enclosing housing may reduce material usage and weight relative to enclosed turbine embodiments. FIGS. 26 and 27 illustrate adaptation of the RLEP platform for open-air wind energy harvesting across different scales and wind conditions.

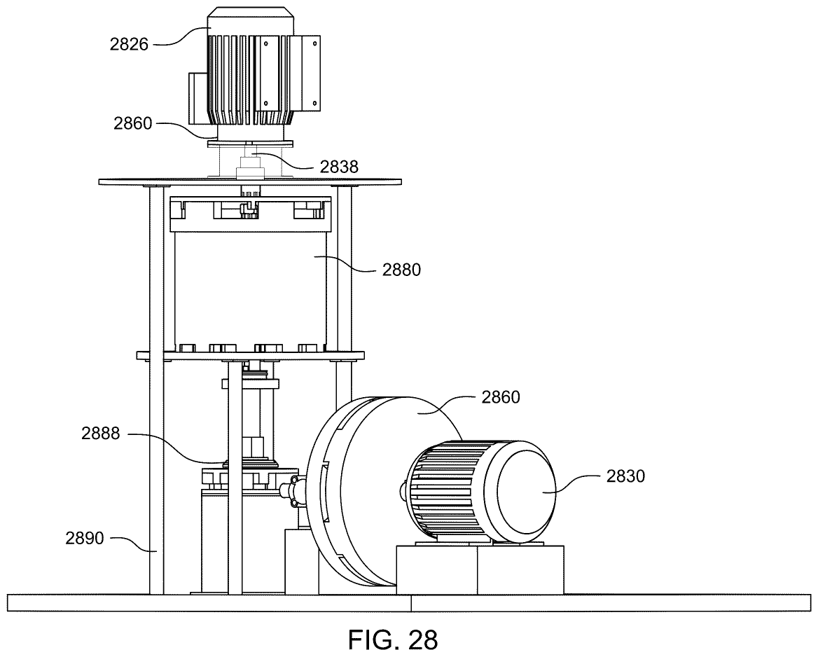

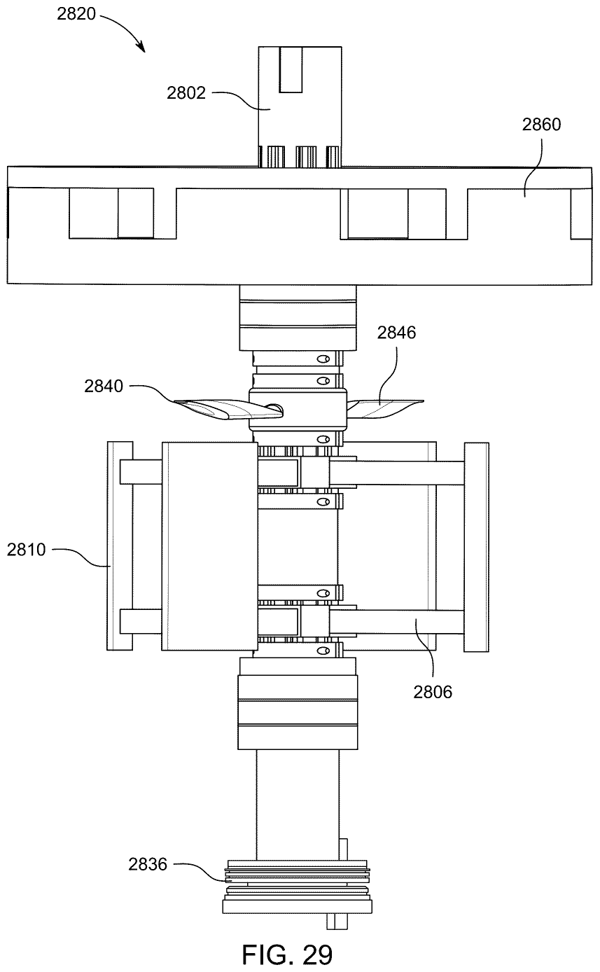

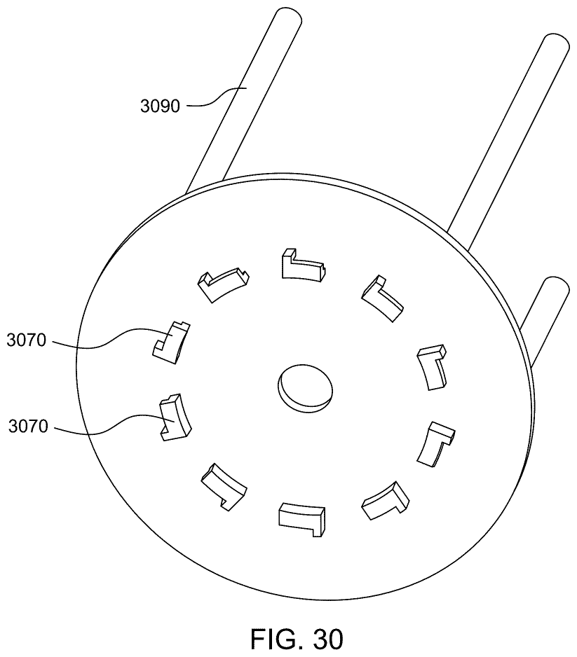

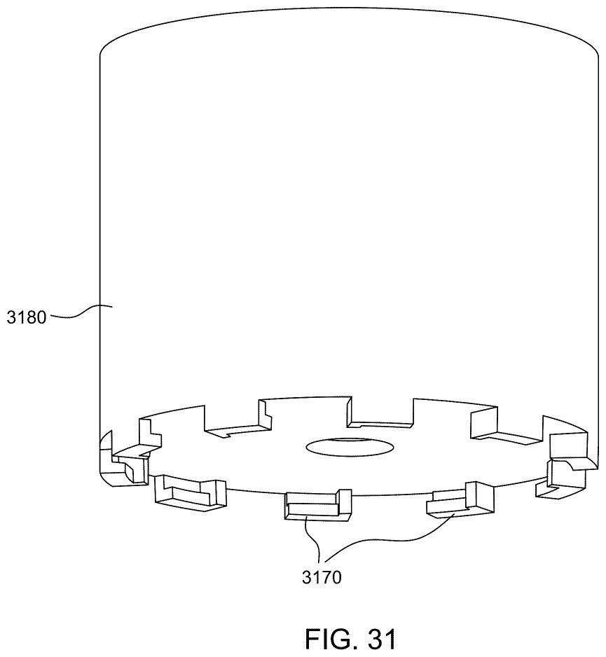

The RLEP system may also operate in alternate fluids such as oil or other hydraulic fluids to generate harvestable torque. In various embodiments, a startup motor may accelerate a rotating assembly to an operating speed within a sealed system filled with oil, such that pressure differentials and flow turning around the airfoils generate torque about a shaft to drive a generator and/or a mechanical output. FIG. 28 is a perspective view of a sealed oil barrel torque system illustrating a sealed housing and external power components, and FIG. 29 is a perspective view of a rotating assembly for the system of FIG. 28 illustrating downforce-generating airfoils, in accordance with some embodiments. FIG. 30 is a perspective view of a support base for the sealed oil barrel system illustrating directional locking segments for mounting a housing, and FIG. 31 is a perspective view of the sealed housing of FIG. 28 illustrating corresponding directional locking segments on its base, in accordance with some embodiments.

FIG. 28 shows a sealed oil barrel torque system comprising a sealed housing 2880, a startup motor 2826, a generator 2830, a power takeoff (PTO) shaft 2838, an edge-drive system 2860, a power transfer assembly 2888, and a support frame 2890. The system may be configured to generate industrial torque for mechanical drive and/or electrical output. A rotating assembly may be enclosed within the sealed housing 2880, which may contain oil or another hydraulic fluid.

The sealed housing 2880 may be a cylindrical or barrel-shaped container that encloses the rotating assembly and retains the hydraulic fluid. The sealed housing 2880 may be constructed from materials suitable for containing oil, including steel and/or reinforced composites, and may include seals to reduce leakage. The startup motor 2826 may be positioned at an upper region of the system and coupled to the edge-drive coupling 2860, which may provide a torque-transfer interface to the rotating assembly. The power transfer assembly 2888 may manage connections among the rotating assembly, the startup motor 2826, and the generator 2830, and may include gear sets (e.g., as described with reference to FIGS. 32A-B) to selectively engage components based on operating mode.

The generator 2830 may be coupled to the power transfer assembly 2888 and may extract electrical power from rotation. The PTO shaft 2838 may provide a mechanical output for driving external equipment (including, in some embodiments, an external generator, pump, compressor, or other machinery). The system may be configured to provide electrical power through the generator 2830, mechanical power through the PTO shaft 2838, or both.

The support frame 2890 may provide structural support for the sealed housing 2880 and associated power components. The support frame 2890 may hold the system in position and may allow the sealed housing 2880 to be mounted and dismounted using directional locking segments described below.

FIG. 29 shows a rotating assembly for the sealed oil barrel torque system. The rotating assembly may comprise a central shaft 2802, radial arms 2806, vertical airfoils 2810, one or more magnetic bearings 2836, an upper set of horizontal wings 2840 having downforce-generating airfoils 2846, and an edge-drive coupling 2860. The central shaft 2802 may extend through the rotating assembly. The one or more magnetic bearings 2836 may be positioned at a lower support region of the central shaft 2802 to provide reduced-friction support for the rotating assembly 2820 in some embodiments.

The radial arms 2806 may extend outward from the central shaft 2802, and the vertical airfoils 2810 may be mounted at ends of the radial arms 2806. The upper set of horizontal wings 2840 may include downforce-generating airfoils 2846 configured with a negative angle of attack. In some embodiments, downforce-generating airfoils 2846 may be used to influence internal flow distribution and pressure behavior within the sealed housing 2880 and/or to assist stability of operation. The edge-drive coupling 2860 may be positioned at an upper region of the rotating assembly and may provide a connection point for the startup motor.

The sealed oil barrel torque system may operate by converting fluid forces acting on rotating airfoils into torque about the central shaft. The startup motor 2826 may accelerate the rotating assembly 2820 to an operating speed. As rotational speed increases, the vertical airfoils 2810 may move through the oil and generate hydrodynamic forces associated with pressure differentials and flow turning around the airfoils. The vertical airfoils 2810 may create high-pressure zones on one side of the airfoils and low-pressure zones on the other side of the airfoils as they move through the oil. These forces may include tangential components that generate torque about the central shaft 2802.

Once the rotating assembly 2820 reaches a threshold speed, tangential force components generated by the vertical airfoils 2810 moving through the oil may become sufficient to sustain rotation with reduced or no continued motor input, depending on configuration and load. At this operating condition, the startup motor 2826 may be disengaged or turned off, and the vertical airfoils 2810 may continue to drive rotation with sufficient torque for electrical generation and/or mechanical drive. The higher density of oil relative to air may enable substantial force generation at moderate rotational speeds in some embodiments, supporting high-torque applications.

The downforce-generating airfoils 2846 may contribute by influencing internal pressure distribution and flow behavior within the sealed housing 2880. For example, a negative angle of attack may produce pressure and circulation effects that reduce undesirable surges and promote stable operation in certain implementations. Downforce-generating airfoil geometry, angle of attack, and placement may be selected based on fluid properties, operating speed, and desired pressure-management characteristics.

Torque generated by the rotating assembly 2820 may be transmitted through the central shaft 2802 to the power transfer assembly 2888. The power transfer assembly 2888 may transfer torque to the generator 2830 for electrical power generation and/or to the PTO shaft 2838 for mechanical output applications, depending on embodiment.

FIG. 30 shows a support base 3090 for the sealed oil barrel system. The support base 3090 may include directional locking segments 3070. The directional locking segments 3070 may be similar in structure and function to the directional locking segments described with reference to FIGS. 14 and 15. The directional locking segments 3070 on the support base 3090 may be configured to receive and mechanically lock with corresponding directional locking segments on a bottom region of the sealed housing 2880.

FIG. 31 shows the sealed housing 2880 in isolation with a view of a bottom surface. The sealed housing 2880 may include directional locking segments 3170 on its base configured to interlock with the directional locking segments 3070 on the support base 3090. When the sealed housing 2880 is positioned on the support base 3090 and rotated in an engagement direction, the directional locking segments may engage to secure the housing to the base. This twist-lock mounting arrangement may allow the sealed housing 2880 to be installed and removed more quickly for maintenance, servicing, or replacement.

The sealed oil barrel torque system shown in FIGS. 28-31 may be advantageous for applications requiring high torque in a compact sealed environment. The higher density of oil relative to air may enable vertical airfoils to generate substantial hydrodynamic forces in some embodiments, supporting industrial torque applications. The sealed configuration may protect the rotating assembly from environmental contaminants and may provide a controlled operating environment. Example applications include industrial power generation modules, hydraulic power units, and other systems where torque output and reliability in a sealed environment are desirable. FIGS. 28-31 illustrate example adaptation of the RLEP platform for sealed hydraulic torque generation.

FIG. 32A is a front view of a power transfer assembly, illustrating a box frame, shafts, and internal and external gear sets, and FIG. 32B is a perspective view of a power transfer assembly illustrating a box frame, shafts, and internal and external gear sets, in accordance with some embodiments. The power transfer assembly (also referred to as a power transfer gearbox or differential gearbox) may manage torque transfer and selective coupling among multiple rotating shafts. The power transfer assembly shown in FIGS. 32A-B may be adapted for use in air-based, water-based, and oil-based RLEP systems and other RLEP embodiments in which management of multiple shafts (e.g., a main shaft, startup motor input, generator input, and/or auxiliary outputs) is desired.

FIGS. 32A-B shows a power transfer assembly comprising a box frame 3280, shafts 3282, an internal gear set 3284, an external gear set 3286, and one or more edge drive coupling systems 3288. The box frame 3280 may be a housing that supports bearings and/or openings allowing the shafts 3282 to extend into and through the assembly.

The shafts 3282 may be oriented at angles relative to each other, including perpendicular orientations in some embodiments. In the embodiment shown in FIGS. 32A-B, two shafts 3282 are visible, though configurations with three or four shafts may be used. Each shaft 3282 may extend through the box frame 3280, with a portion inside the box frame and a portion outside the box frame.

The internal gear set 3284 may be positioned within the box frame 3280. In some embodiments, gears at ends of the shafts inside the box frame may include bevel gears (including, for example, miter-type bevel gears for certain ratios) configured to transfer rotational power between shafts oriented at an angle (e.g., approximately 90 degrees).

The external gear set 3286 may be positioned outside the box frame 3280. In some embodiments, external gears may also include bevel gears configured to provide additional torque paths, mode-dependent coupling, and/or mechanical engagement arrangements among shafts 3282. In some embodiments, each shaft 3282 may include at least one internal gear and at least one external gear. The disclosure is not limited to a specific gear angle or ratio, and gear geometry may be selected based on desired torque capacity, ratio, packaging, and operating mode.

The power transfer assembly may enable selective coupling among a main shaft of an RLEP system, a startup motor input, a generator input, and/or other mechanical loads. In some embodiments, bevel-gear engagement may transfer rotational power between perpendicular shafts, while clutches, couplers, and/or edge-drive coupling systems (e.g., couplings used as torque-transfer interfaces where applicable) may be used to engage or disengage specific shafts depending on an operating mode.

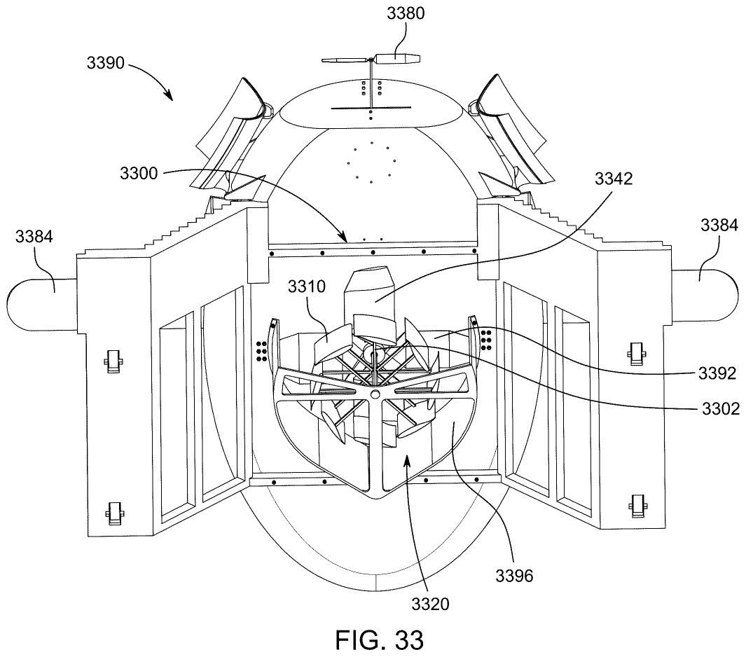

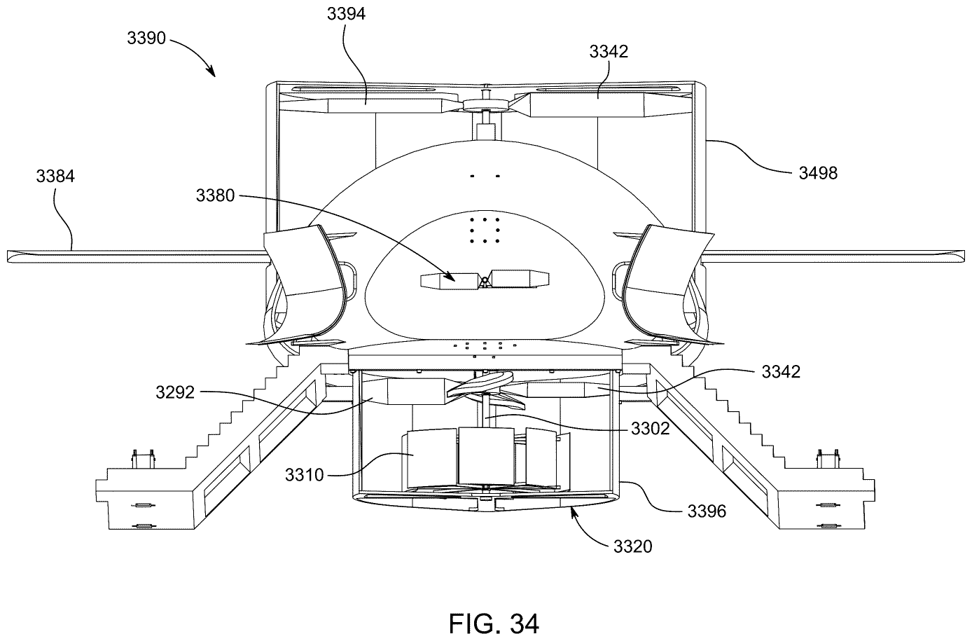

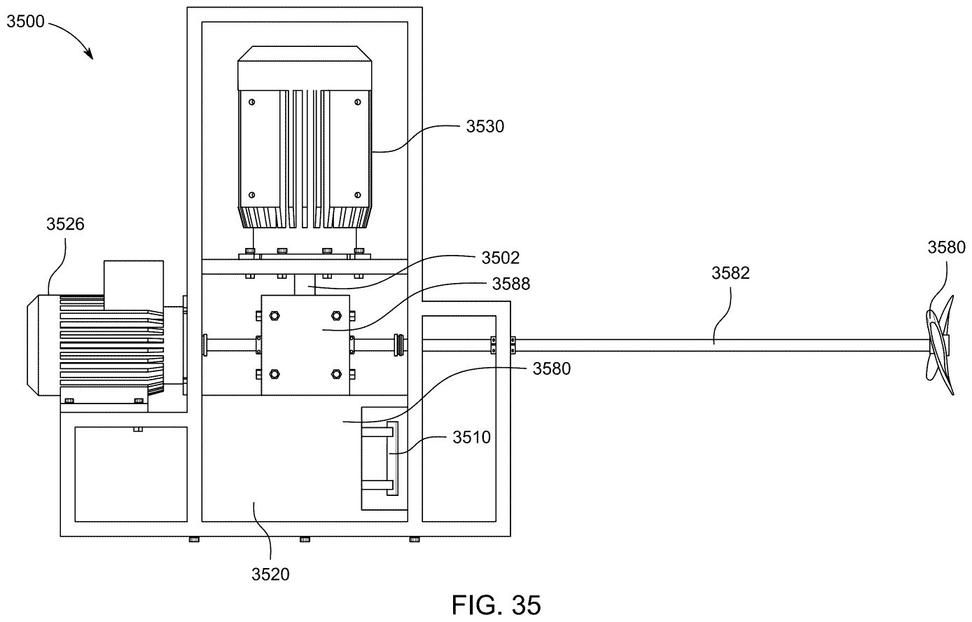

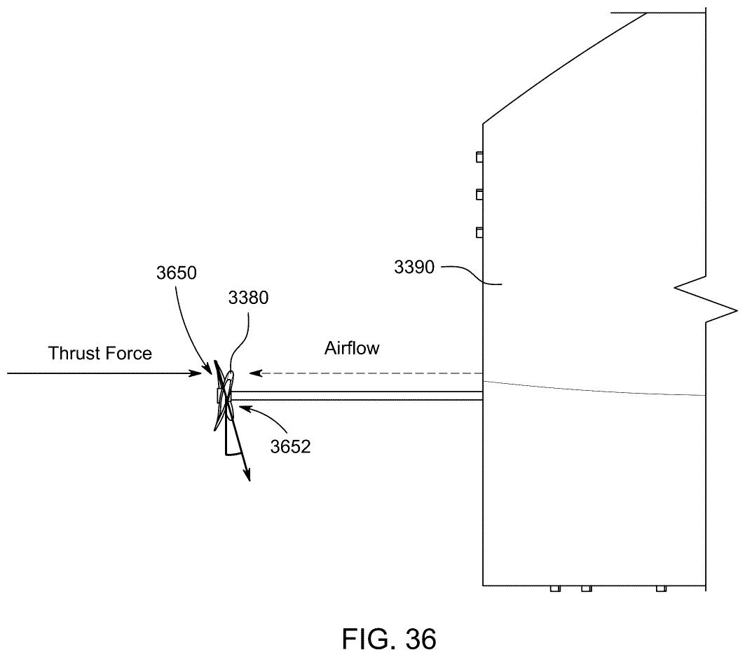

FIG. 33 is a bottom view of an aerial vehicle, illustrating a large rotating assembly with a protective shroud and a rear propeller, and FIG. 34 is a rear view of the aerial vehicle of FIG. 33, illustrating the rotating assembly, fixed horizontal wings, and upper horizontal wings, in accordance with some embodiments. FIG. 35 is a side view of an internal power system for the aerial vehicle of FIG. 33, illustrating a rotating assembly within a housing and a propeller drive system, and FIG. 36 is a schematic side view of a propeller system for the aerial vehicle of FIG. 33, illustrating an angle of attack and thrust vector, in accordance with some embodiments.

FIG. 33 shows a bottom view of an aerial vehicle, or skyship 3390, with a large rotating assembly 3320 positioned under the skyship 3390. The rotating assembly 3320 may include vertical airfoils 3310 and a set of horizontal wings 3392 configured with a positive angle of attack. The vertical airfoils 3310 and horizontal wings 3392 may be stacked one above the other on a main central shaft 3302.

The horizontal wings coupled with the vertical airfoils under the skyship can be underside lift wings 3392, and they can be configured with positive angle of attack as axial-load compensating wings 3342. These underside lift wings 3392 may provide the vertical force that keeps the skyship 3390 in the air. The entire rotating assembly 3320 may be partially surrounded by a lower shroud 3396. The lower shroud 3396 may protect the rotating assembly 3320 from frontal impacts, but may be open at the back and at the bottom to allow downward air movement. The lift force may come from the rotating assembly 3320, and the forward thrust may come from a propeller 3380 extending from the back of the skyship 3390. In various embodiments, fixed horizontal wings 3384 may extend from the left and right sides of the skyship 3390.

FIG. 34 shows a rear view of the skyship 3390. The rotating assembly 3320 may be visible from this view because the lower shroud 3396 protects the front but does not fully encircle the rotating assembly 3320 at the back. The vertical airfoils 3310 and the horizontal wings may be visible within the shroud. The propeller 3380 may be visible from the back. The fixed horizontal wings 3384 may extend from both the left and right sides of the skyship 3390.

At the top of the skyship 3390, there may be another set of horizontal wings. These may be the top-side lift wings 3494, which may be configured as axial-load compensating wings 3342 with a positive angle of attack. The top-side lift wings 3494 may generate additional upward lift to supplement the main lift provided by the underside lift wings 3392. This dual-lift configuration may provide greater lifting capacity and stability.

The top-side lift wings 3494 may be at least protected by an upper shroud 3498. The upper shroud 3498 may obscure the wings from the front and may protect them while the skyship 3390 moves forward, but the shroud may be open at the top, back, and/or sides to allow airflow and thrust.

In various embodiments, a single central shaft 3302 may extend from the rotating assembly 3320 at the bottom, through the skyship 3390, to the horizontal wings on the top of the skyship 3390, so that the rotating assembly 3320 can also power the horizontal wings 3494 above the skyship 3390. The bottom assembly and the horizontal wings 3494 above the skyship 3390 may all spin together. The underside lift wings 3392, the vertical airfoils 3310, and the top-side lift wings 3494 may all be part of a single rotating assembly 3320 that extends through the skyship 3390 from below to above. In various embodiments, the skyship may not have upper horizontal wings 3394, or the upper wings 3394 may be independently powered by a separate rotating assembly so that a central shaft does not extend through the skyship.

FIG. 35 shows a side view of an internal RLEP power system that may power the rear propulsion system. In various embodiments, a skyship can have a single RLEP, or can have multiple RLEPs performing different functions. In various embodiments, a skyship can have a primary RLEP that can keep the ship aloft through the axial-load compensating wings, and a secondary RLEP that can power the ship's internal components and/or power a forward-thrust producing propulsion system. An internal power system, such as shown in FIG. 35 may include a rotating assembly 3520 with vertical airfoils 3510 inside a housing 3580. In various embodiments, a secondary RLEP system can power a torque-driven airfoil thrust system to propel the skyship forward.

In various embodiments, a secondary RLEP can provide direct torque power to a propeller to drive the airship forward. In embodiments with a propeller, a propeller drive shaft 3582 may extend out through a rear wall of the skyship and may have the propeller 3380 on the end. There may be an RLEP with a generator 3530 on the other side and a startup motor 3526 on the top side. This internal power unit may provide direct torque and shaft rotation to power the propeller 3380 at the back of the skyship 3390.

The RLEP may also provide torque to the generator 3530 to extract power from this internal system to power various systems within the skyship 3390. A power transfer assembly 3588 may be positioned on top of the housing 3580 so that the startup motor, the generator, and the propeller can all be connected to the RLEP at different times.

The rotating assembly 3520 may include a central shaft 3502 and vertical airfoils 3510. The internal rotating assembly 3520 may be driven by the startup motor 3526, or may operate in a self-powered mode where the motor brings it to operational speed and then the vertical airfoils 3510 sustain rotation through aerodynamic forces, similar to the energy harvesting mode described above.

FIG. 36 shows a schematic side view of the back of the skyship 3390, with the propeller 3380 extending out from the back of the skyship 3390. The angle of attack of the propeller blades may be approximately 15 degrees, although other angles of attack are possible. A thrust force arrow and an airflow direction arrow may be shown.

As the propeller 3380 rotates, the propeller blades may create a pressure differential. A low-pressure zone 3650 may form on one surface of the blades, and a high-pressure zone 3652 may form on the other surface. This pressure differential may generate a thrust force TF that propels the skyship 3390 forward while the airflow AF moves backwards relative to the moving ship.

The skyship 3390 shown in FIGS. 33-36 demonstrates how the RLEP system may be adapted for aerial vehicle applications. The skyship 3390 may use separate decoupled lift and propulsion systems. The main rotating assembly 3320 may be dedicated to providing vertical lift, while the propeller 3380 may be dedicated to providing horizontal propulsion. This separation of functions may allow each system to be optimized for its specific purpose.

In the configuration shown, the skyship 3390 may use a primary RLEP 3300, including the main rotating assembly 3320, for vertical lift and a separate, secondary RLEP 3500, including the rotating assembly 3520 in the housing 3580 for horizontal propulsion and electrical power generation. The internal RLEP may drive the propeller 3380 through the propeller drive shaft 3582 and may simultaneously drive the generator 3530 to produce electrical power for the skyship's onboard systems. In alternative configurations, a skyship may use a single RLEP system that provides both vertical lift and drives a generator, with the electricity from the generator powering electric motors for horizontal thrusters. The configuration shown in FIGS. 33-36 may illustrate the versatility of the RLEP platform and its ability to provide efficient lift and propulsion for aerial vehicle applications.

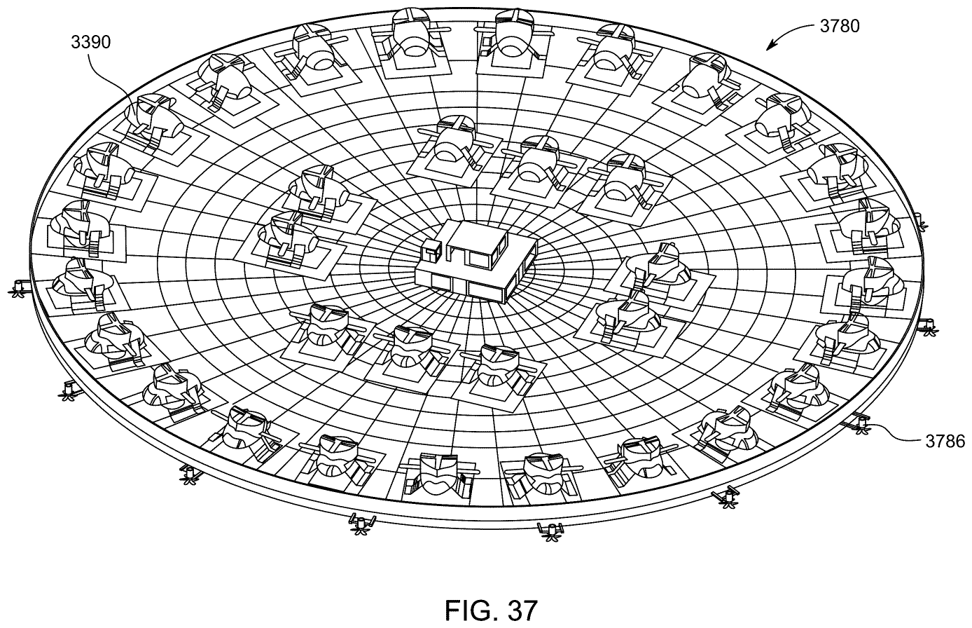

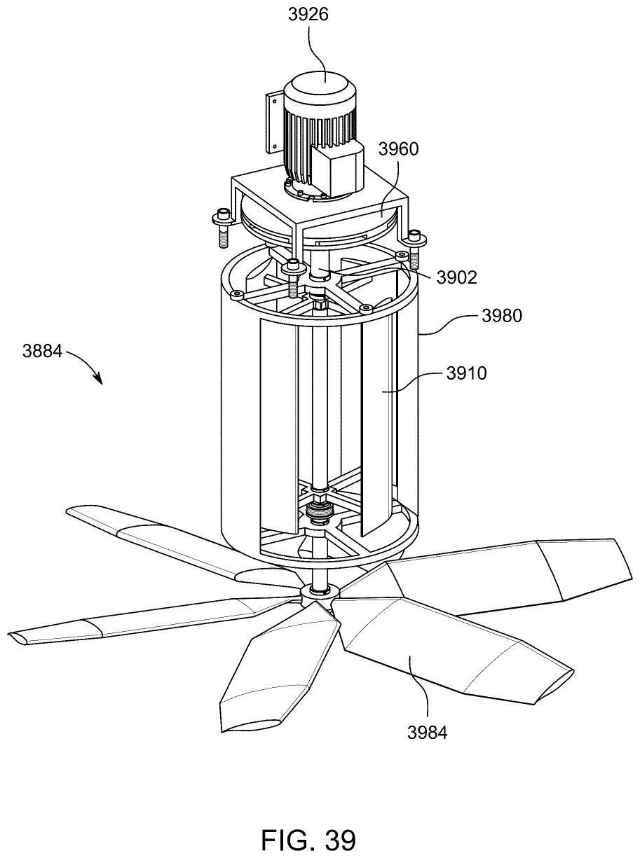

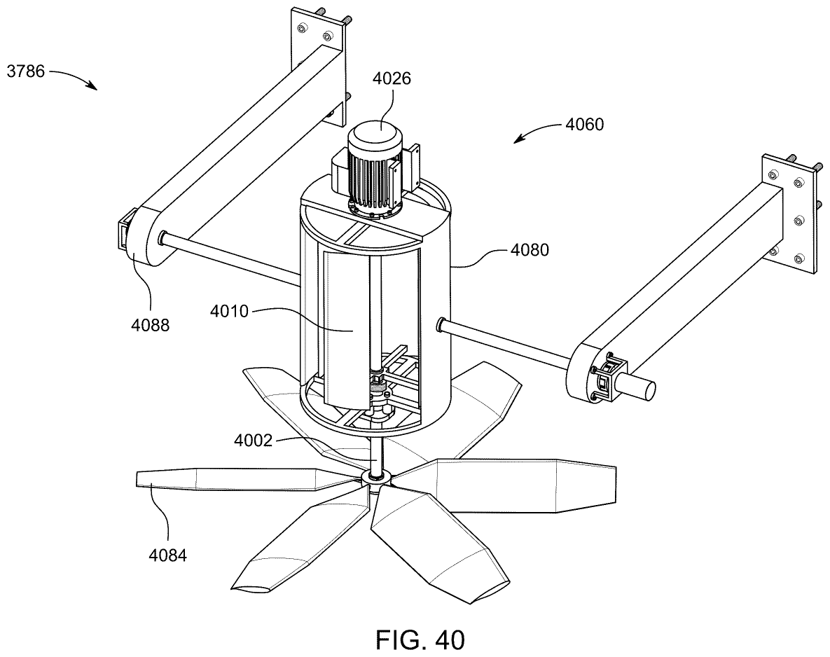

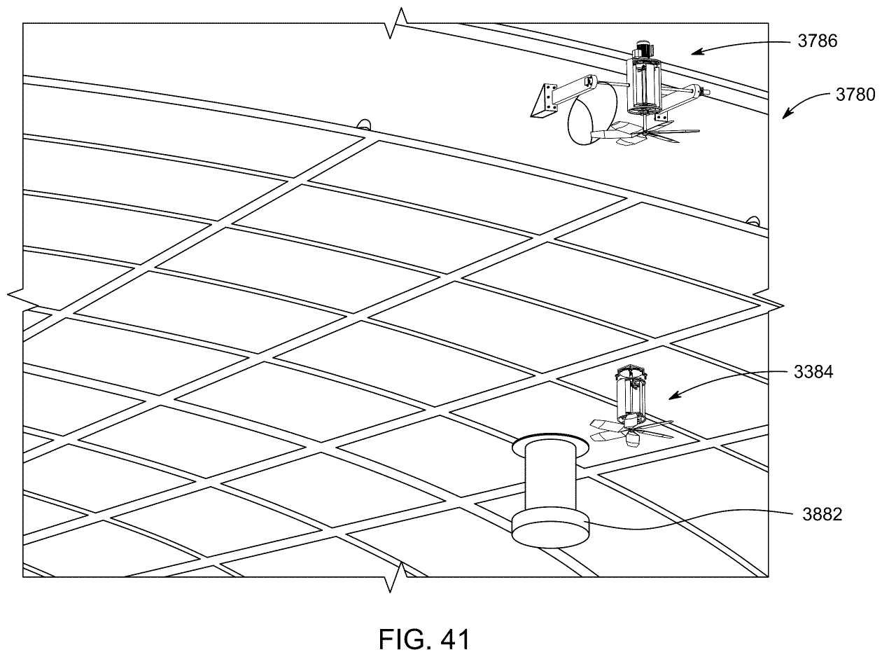

FIG. 37 is a top perspective view of a floating aerial platform, illustrating multiple docked aerial vehicles and peripheral lift systems, and 38 is a bottom perspective view of the floating aerial platform of FIG. 37, illustrating bottom-mounted lift systems and landing feet, in accordance with some embodiments. FIG. 39 is a side view of a bottom-mounted lift system for the platform of FIG. 37, illustrating a rotating assembly within a housing and downward-extending lift wings, FIG. 40 is a side view of a side-mounted lift system for the platform of FIG. 37, illustrating a pivoting support frame for directional control, and FIG. 41 is a detailed perspective view of the floating aerial platform of FIG. 37, illustrating a landing foot, a bottom-mounted lift system, and a side-mounted lift system, in accordance with some embodiments.

FIG. 37 shows a top perspective view of a floating aerial platform 3780. A floating aerial platform 3780 can be held aloft in the air by a number of RLEPs 3786 that may providing torque to horizontal wings, and those horizontal wings may rotate rapidly to generate thrust through the high and low pressure zones on the tops and bottoms of the rotating wings. The floating aerial platforms 3780 can be held aloft by the multiple RLEPs so that the floating aerial platforms can form a landing base for the skyships. Many skyships 3390 of different sizes may dock on the top of the aerial platform 3780.

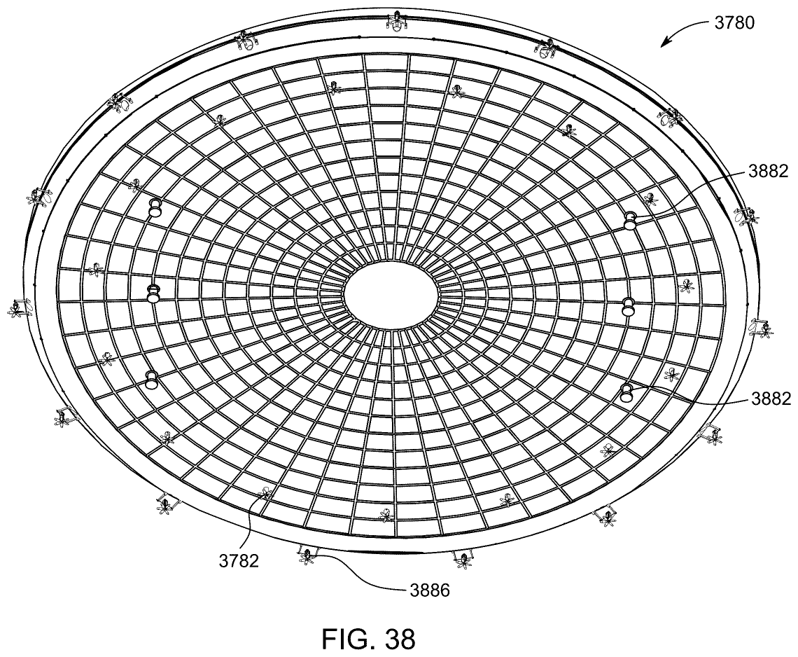

FIG. 38 shows a bottom perspective view of the aerial platform 3780. Around the outer periphery of the round aerial platform 3780, there may be many large side-mounted RLEP lift systems 3786. Each side-mounted RLEP lift system 3786 may have a set of horizontal wings at the bottom that provide lift for the floating platform 3780. Bottom mounted RLEP systems 3384 can be mounted across the underside of the floating aerial platform 3780, and similar to side mounted RLEPs, the bottom mounted RLEPs can have horizontal wing sets extending from the bottom of the RLEP. The bottom mounted and side mounted RLEPs can have vertical airfoils rotating inside of a housing, and the vertical airfoils can generate torque through aerodynamic pressure differentials and lift forces acting on the airfoils as the airfoils move through a fluid, and that torque can be transferred to the horizontal wing set to provide thrust that can keep the floating aerial platform aloft.

Many landing feet 3882 may be extending down from under the aerial platform 3780. The landing feet 3882 may allow the entire aerial platform 3780 to land on the ground, if necessary, without damage to the RLEP systems that are mounted across the bottom of the platform. The landing feet 3882 may extend down from the bottom of the platform 3780 a greater distance than the RLEP systems, ensuring that the RLEP systems do not contact the ground when the platform lands.

FIG. 39 is a side view of a bottom-mounted lift system 3884 with a partially cut-away housing 3980 exposing the vertical airfoils 3910 inside the housing 3980. The bottom-mounted lift system 3884 may include vertical airfoils 3910, the housing 3980, a startup motor 3926, a central shaft 3902, an edge-drive system 3960, and a set of lift-producing wings 3984 that extends down from the bottom of the housing 3980. The central shaft 3902 may pass down out of the housing 3980 where it connects to the lower horizontal lift wings 3984 that are the lowest point of the assembly. The set of wings depicted may have six blades that all have a positive angle of attack. The rotating assembly within the housing 3980 may power the horizontal wings 3984 below the housing 3980.

The horizontal wings 3984 may be positioned below the housing 3980, making them the lowest point of the entire aerial platform 3780. The positive angle of attack may mean the wings have a high-pressure zone under the bottom of the wings and a low-pressure zone on the top of the wings, which may generate forces in the upward direction. These wings 3984 may provide the force that keeps the platform 3780 aloft.

FIG. 40 is side view of a side-mounted lift system 4086. Various RLEP lift systems may have directional control. The side-mounted lift system 4086 may be mounted in a pivoting support frame 4088 that can pivot to change the angle of thrust produced by the horizontal wings. This can allow the aerial platform to stay centered in a preferred location despite changing wind patterns.

The side-mounted lift system 4086 may include a central shaft 4002, vertical airfoils 4010, a startup motor 4026, an edge-drive system, a housing 4080, and lower horizontal lift wings 4084 below the housing 4080. The pivoting support frame 4088 may allow the entire side-mounted lift system 4086 to be angled, which may change the direction of the thrust vector produced by the horizontal wings 4084. Various possible pivoting mechanisms are possible, and lift system may be able to pivot or change direction through two or more axes. This may allow the side-mounted lift systems 3786 to provide not only vertical lift but also horizontal thrust for maneuvering the aerial platform 3780.

FIG. 41 shows a close-up perspective view showing the side and bottom of the aerial platform 3780. A landing foot 3882, a bottom-mounted lift system 3884, and a side-mounted lift system 3786 may all be visible in this view, illustrating how the different components are integrated into the aerial platform 3780 structure.

The floating aerial platform 3780 shown in FIGS. 37-41 may be a large, stationary or slowly maneuverable aerial platform designed to serve as a mid-air docking station, refueling station, or transfer hub for aerial vehicles, including the skyships 3390. The platform 3780 may remain airborne using multiple large RLEP systems. The side-mounted lift systems 3786 may be positioned around the outer periphery of the platform 3780, and the bottom-mounted lift systems 3884 may be positioned across the bottom of the platform 3780.

The horizontal wings on these lift systems may be configured with positive angles of attack to generate massive upward thrust, allowing the platform 3780 to hover at altitude. The side-mounted lift systems 3786 may be mounted in pivoting support frames 4088 that allow directional control, enabling the platform 3780 to maneuver slowly or maintain position against wind. The landing feet 3882 may allow the platform 3780 to land on the ground when needed, such as for maintenance, loading, or during adverse weather conditions. The landing feet 3882 may extend below the RLEP systems to protect them from ground contact.

The configuration shown in FIGS. 37-41 may illustrate how multiple RLEP systems may be integrated into a large aerial platform to provide sufficient lift for a substantial structure that can serve as a floating airport or transfer hub. The platform may provide a stable surface for aerial vehicles to land, dock, transfer cargo or passengers, refuel, or undergo maintenance without needing to descend to the ground.

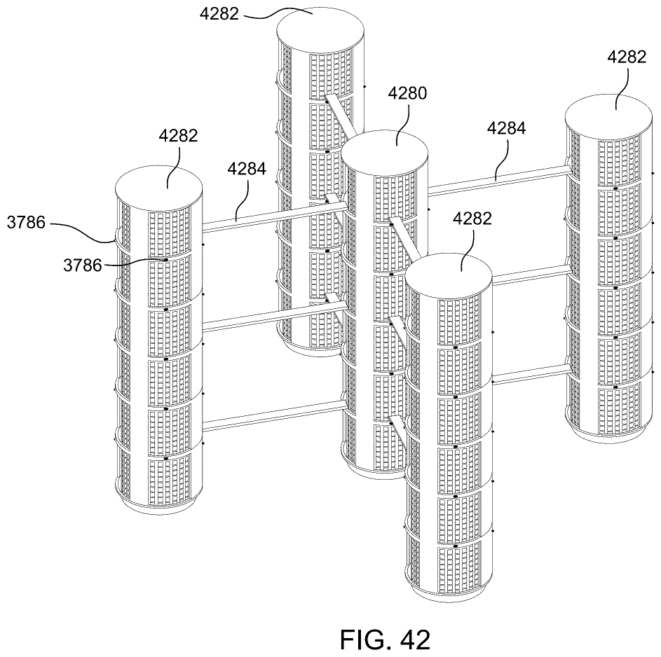

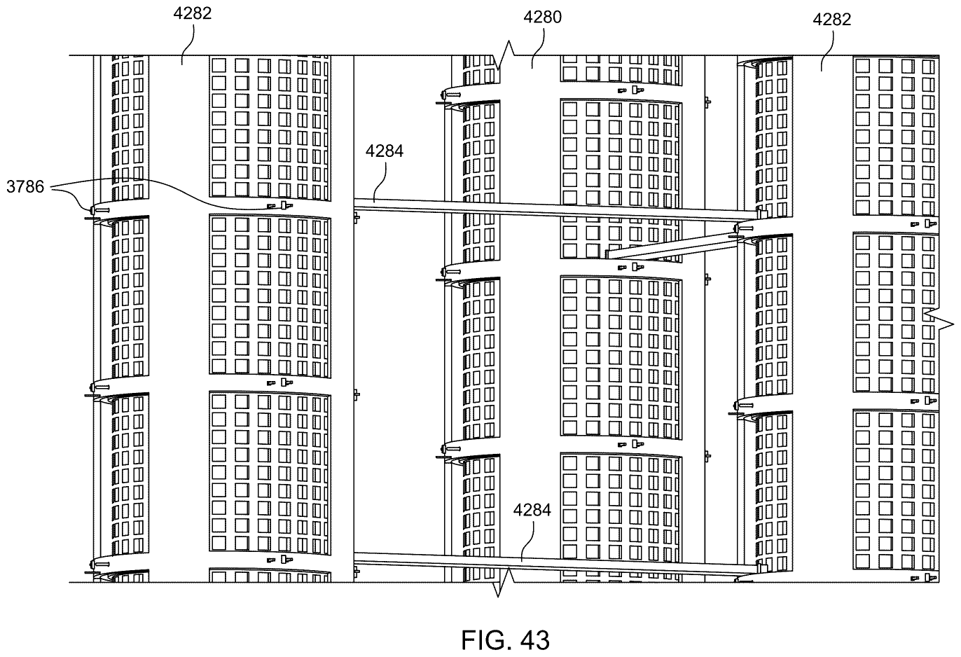

FIG. 42 is a perspective view of a multi-tower building structure, illustrating a central tower, surrounding towers, connecting bridges, and integrated side-mounted lift systems, and FIG. 43 is a detailed perspective view of the building structure of FIG. 42, illustrating the placement of side-mounted lift systems and connecting bridges, in accordance with some embodiments.

FIG. 42 shows five towers in a multi-tower building structure. There may be a central tower 4280 and various surrounding towers 4282. Each of the surrounding towers 4282 may be arranged around the central tower 4280 and may be connected by connecting bridges 4284. As shown, each outer tower may have three bridges connecting it to the central tower 4280. Side-mounted lift systems 3786 may be mounted in various positions around the periphery of the towers at intervals such as every ten floors.

FIG. 43 shows a closer view of the multi-tower building structure. The side-mounted lift systems 3786 may be shown mounted in various positions around the periphery of the towers. In various embodiments, side mounted lift systems may be positioned approximately every ten floors, and in various embodiments, the connecting bridges 4284 may connect the towers every twenty floors.

The multi-tower building structure shown in FIGS. 42 and 43 may be a vertical residential and commercial structure that integrates RLEP technology for lift as well as building climate control and energy efficiency.

Various towers may be multi-story buildings, which may be residential, commercial, or mixed-use. The building may use integrated RLEP systems to provide ventilation for the entire structure. In various embodiments, heating and/or cooling systems can be coupled to the integrated RLEP systems to provide heated and/or cooled air throughout the building, and the heated or cooled air can be powered throughout the building by the RLEP system. The side-mounted RLEP units 3786 may be positioned at regular intervals around the periphery of the towers. These units may draw in outside air and distribute it throughout the building.

The multi-tower design may include a central tower 4280 surrounded by four surrounding towers 4282, all of which may be connected by connecting bridges 4284. This design may maximize structural stability and may allow for shared infrastructure, including elevators, utilities, and ventilation. The connecting bridges 4284 may connect the towers every twenty floors, providing access between towers and structural support.

The side-mounted lift systems 3786 may be positioned around the periphery of the towers at regular intervals, appearing every ten floors. These RLEP-based air movement systems may draw in outside air and distribute it throughout the building. By using RLEP-based air movement and conditioning systems, the building may achieve superior energy efficiency compared to conventional ventilation systems. The RLEP systems may also generate electricity as a byproduct of their operation, further reducing the building's energy consumption.

The configuration shown in FIGS. 42 and 43 may illustrate how RLEP systems may be integrated into building architecture to provide efficient ventilation and energy generation. The multi-tower design with integrated RLEP systems may represent a new approach to sustainable building design, where the building's structure and its environmental control systems are designed together as an integrated whole.

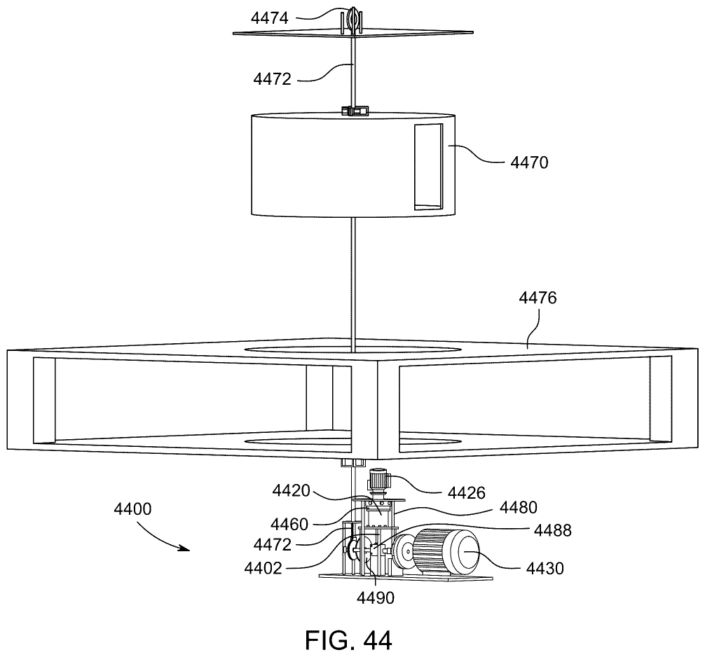

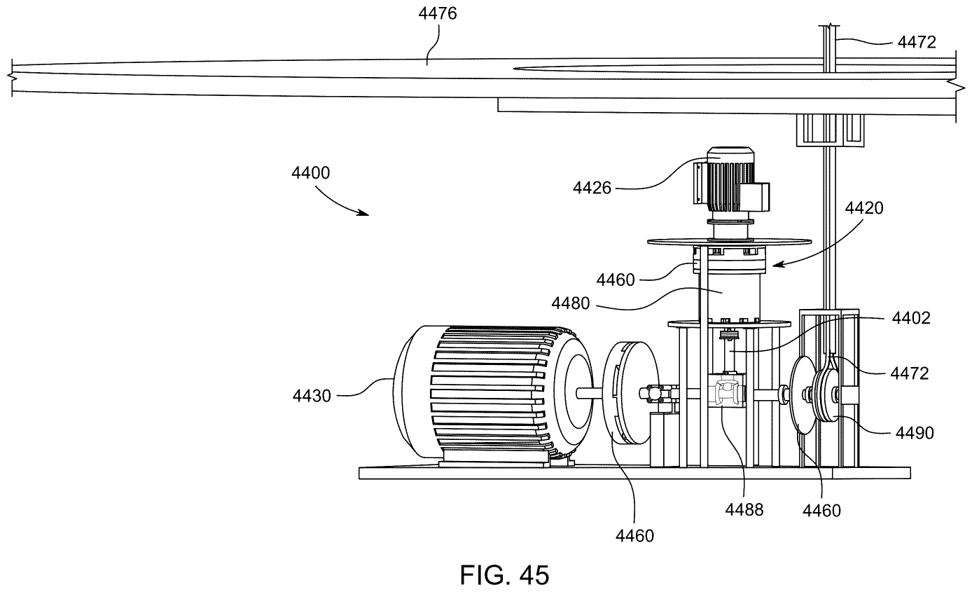

A multi tower building system may include an RLEP powered elevator system. In various embodiments the RLEP powered elevator system can include elevators powered by central pole torque transmission systems with edge-drive coupling and/or elevators powered by chain and pulley systems. FIG. 44 is a perspective view of an elevator system, illustrating a multi-floor structure with an elevator carriage, chain loop, and upper pulley, and FIG. 45 is a perspective view of a power system for the elevator of FIG. 44, illustrating a rotating assembly within a housing, a lower pulley, and power transfer components, in accordance with some embodiments.

FIG. 44 shows a complete multi-floor elevator system suitable for use in an RLEP powered multi-tower building system, as shown in FIG. 42. The system may include an elevator carriage 4470, a chain loop 4472, an upper pulley 4474, and a building structure 4476. The building structure 4476 may have holes in the floors to allow the elevator carriage 4470 and the supporting chain loop to pass through as it moves up and down. The elevator carriage 4470 may be connected to the chain loop 4472, and the chain loop 4472 may be a continuous loop that extends from the bottom of the system to the top. At the top of the system, the chain loop 4472 may pass over the upper pulley 4474, and the upper pulley 4474 may redirect the chain loop 4472 back downward.

At the bottom of the system, the chain loop 4472 may pass around a lower pulley 4490. The lower pulley 4490 may be driven by an RLEP 4400 with a rotating assembly 4420. As the lower pulley 4490 rotates, it may drive the chain loop 4472, causing the elevator carriage 4470 to move up or down depending on the direction of rotation. The system may also include an RLEP 4400 to provide the torque to drive the elevator.

FIG. 45 shows a detailed view of the power system at the bottom of the elevator system. The RLEP-based power system may include the rotating assembly 4420 inside a sealed housing 4480, the lower pulley 4490, the startup motor 4426, the generator 4430, the Edge-Drive System 4460, the Power Transfer Assembly 4488, and the bottom portion of the chain loop 4472. The rotating assembly 4420 may include a central shaft 4402 and vertical airfoils. The rotating assembly 4420 may be enclosed within the housing 4480. The housing 4480 may be sealed to contain the rotating assembly 4420 and to protect it from the environment.

The central shaft 4402 may extend from the rotating assembly 4420 upward through the top of the housing 4480. The central shaft 4402 may connect to the lower pulley 4490. The lower pulley 4490 may be mechanically connected to the central shaft 4402 so that rotation of the central shaft 4402 causes rotation of the lower pulley 4490.

The power transfer assembly 4488 may be positioned at or near the top of the housing 4480. The power transfer assembly 4488 may connect to the rotating assembly 4420 through the central shaft 4402. The power transfer assembly 4488 may manage the connections between multiple components, and may connect to the lower pulley, the startup motor 4426, and/or the generator 4430.

The startup motor 4426 may be connected to the power transfer assembly 4488. An Edge-Drive System 4460 may provide the connection between the startup motor 4426 and the rotating assembly 4420. The Edge-Drive System 4460 may allow the startup motor 4426 to bring the rotating assembly 4420 up to operational speed during startup.

The generator 4430 may be connected to the RLEP through the power transfer assembly 4488. The generator 4430 may extract electrical power from the rotation of the central shaft 4402. This may allow the elevator system to generate electricity while also providing mechanical drive for the elevator. In various embodiments, the RLEP may power the generator while the elevator idle, and the power transfer assembly may transfer power to the lower pulley when the elevator is called for. The chain loop 4472 may pass around the lower pulley 4490. As the lower pulley 4490 rotates, it may drive the chain loop 4472.

The elevator system shown in FIGS. 44 and 45 may be an RLEP-powered elevator system. The system may use a rotating assembly 4420 as the primary power source for moving the elevator carriage 4470. The rotating assembly 4420 may operate in a manner similar to other RLEP embodiments described above. The startup motor 4426 may be used to bring the rotating assembly 4420 up to operational speed. Once the rotating assembly 4420 is rotating at sufficient speed, it may generate torque through the central shaft 4402. The torque from the central shaft 4402 may be transmitted to the lower pulley 4490. The lower pulley 4490 may convert the rotational motion of the central shaft 4402 into linear motion of the chain loop 4472. As the chain loop 4472 moves, the elevator carriage 4470 attached to it may move up or down through the building structure 4476.

The Power Transfer Assembly 4488 may allow the system to perform multiple functions selectively or simultaneously. While the rotating assembly 4420 is driving the lower pulley 4490 to move the elevator, the Power Transfer Assembly 4488 may also transfer torque to the generator 4430. The generator 4430 may convert the mechanical rotational energy into electrical energy, which may be used to power building systems or may be fed back into the electrical grid.

The elevator system may be used inside towers, such as the multi-tower building structure shown in FIGS. 42-43, or in other locations. The use of an RLEP as the power source for the elevator may provide advantages over conventional elevator systems, including the ability to generate electricity while providing mechanical drive, and the potential for more efficient operation through the force vector management principles of the RLEP design. The configuration shown in FIGS. 44 and 45 may illustrate how the RLEP system may be adapted for elevator applications, demonstrating the versatility of the platform for providing mechanical drive in building systems.

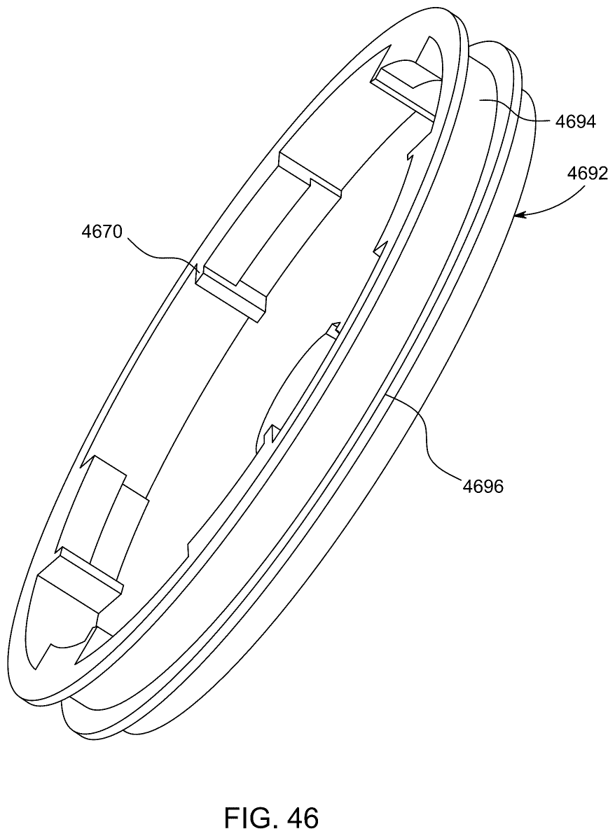

FIG. 46 is a perspective view of a pulley for the elevator of FIG. 44, illustrating directional locking segments for edge-lock connection to a drive shaft, in accordance with some embodiments. The pulley 4692 may include a disc 4694 and a rim 4696. The disc 4694 may be the central portion of the pulley, and the rim 4696 may extend around the outer edge of the disc 4694. The pulley 4692 may be shaped with a smaller diameter center area and extensions on both sides. This design may create a channel or groove around the middle of the pulley where a chain can be positioned, and the rims 4696 on either side may hold the chain in place and prevent it from slipping off the pulley during operation.

Inside the rim 4696, there may be directional locking segments 4670. The directional locking segments 4670 may be positioned on the inner surface of the rim 4696. The directional locking segments 4670 may be similar in structure and function to the directional locking segments described with reference to FIGS. 14 and 15 for the edge-drive startup system. The directional locking segments 4670 may allow the pulley 4692 to be connected to a drive shaft using an edge-lock connection, with the directional locking segments 4670 engaging with corresponding segments on a mating component attached to the drive shaft.

This edge-lock connection may allow the pulley 4692 to be engaged with the central shaft 4402 of the elevator system. When engaged, torque from the central shaft 4402 may be transferred through the directional locking segments 4670 to the rim 4696 and disc 4694 of the pulley 4692, causing the pulley to rotate. As the pulley 4692 rotates, it may drive the chain loop 4472, moving the elevator carriage 4470.

The use of directional locking segments 4670 for the connection between the drive shaft and the pulley may provide several advantages. The edge-lock connection may provide a secure, high-torque connection capable of handling the substantial loads required for elevator operation. The directional locking mechanism may ensure that torque is transferred efficiently in the drive direction. The connection may also allow for relatively easy assembly and disassembly for maintenance purposes.

The following paragraphs describe additional example implementations and configurations consistent with the systems and methods described above. In some embodiments, a rotational energy conversion system may include a plurality of lift-generating airfoils mounted around a central rotational axis and may be configured to produce rotational torque through fluid-induced lift, and a fluid medium may include at least one of air, water, or oil. In some embodiments, airfoils may be arranged vertically, horizontally, or in a hybrid orientation, and may be mounted at an angle of attack sufficient to generate lift-induced rotational force about a central axis. In some embodiments, generated torque may be transferred via a central shaft to at least one of a generator, a mechanical drive system, or a propulsion mechanism. In some embodiments, a locking mechanism may be configured to secure a central shaft using a self-tightening directional tooth-lock interface. In some embodiments, airfoils may be supercritical, subcritical, or otherwise shaped to increase lift relative to drag in a surrounding fluid medium. In some embodiments, a fluid medium may be enclosed within a sealed chamber and a system may operate at a rotational speed sufficient to generate desired power output regardless of component scaling. In some embodiments, a method of generating torque may include rotating a central shaft using aerodynamic or hydrodynamic lift generated by airfoils submerged in or exposed to a moving fluid medium, and lift may drive rotational motion without direct thrust. In some embodiments, a startup motor may be used to initiate motion, and a motor may optionally be disconnected once sufficient lift-based torque is established. In some embodiments, torque may be extracted from either a top or a bottom of a central shaft through a clutch, coupling, or power transfer assembly. In some embodiments, radial support arms between airfoils may serve structural and optional lift-reducing functions and may be solid or airfoil-shaped depending on application.

In some embodiments, an angle of attack may range between about 5 degrees and about 30 degrees and may be configured based on medium density and a target lift force. In some embodiments, airfoils may be constructed with tip trimming, partial curvature, or flat trailing edges and may enhance torque generation. In some embodiments, a system may operate at speeds between about 5 km/h and about 1000 km/h depending on medium and application size. In some embodiments, torque may be divided mechanically to power multiple devices including onboard propulsion systems and auxiliary systems. In some embodiments, a system may be installed in ships, aircraft, vehicles, or stationary platforms and may serve as a propulsion or energy generation unit. In some embodiments, a locking system may include interlocking components designed to tighten with rotational torque direction. In some embodiments, component sizes may remain fixed and power output may be governed by changes in rotational speed. In some embodiments, lift-generating vertical airfoils may be installed at equidistant radial positions around a shaft and may maintain aerodynamic balance. In some embodiments, system speed may be controlled post-startup via a variable frequency drive or another controller. In some embodiments, radial support arms may provide structural connection starting from about 50% of an airfoil chord width and may taper inward toward a shaft.

In some embodiments, a rotational lift energy platform may be integrated into a marine vessel and generated torque may be used for onboard power generation or direct propulsion. In some embodiments, a platform may be installed in an aircraft and may generate electric propulsion torque and/or mechanical propulsion torque. In some embodiments, a platform may be installed in a land-based power station and may generate electricity through lift-to-torque conversion. In some embodiments, a platform may be embedded in a ground vehicle and may serve as an electric torque source. In some embodiments, a platform may be installed in a train system and may produce torque for locomotive propulsion or regenerative energy. In some embodiments, a platform may be applied in aerospace applications and may generate electrical power in low-atmosphere or microgravity environments. In some embodiments, a platform may be configured for hybrid marine-electric operation using hydrodynamic wings underwater and aerodynamic wings while surfaced. In some embodiments, a platform may be used in submerged or surface marine installations for autonomous underwater or remote power systems. In some embodiments, multiple platforms may be operated in parallel and may be synchronized for scalable multi-megawatt power output. In some embodiments, modular configuration options may allow adaptation across mobile, stationary, airborne, and aquatic systems.

In some embodiments, a torque distribution system may include at least one rotational input ring mounted concentrically to a motor or shaft, and the ring may transfer torque to one or more output shafts without use of a gearbox. In some embodiments, torque may be transferred through radial engagement between a rotating input ring and one or more torque-receiving output rings. In some embodiments, an energy generation system may use aerodynamic or hydrodynamic lift from vertically or horizontally oriented airfoils rotating around a central shaft in a fluid medium. In some embodiments, torque may be transferred from a fluid-driven shaft directly to a vehicle drivetrain using an edge-drive system without energy conversion to electricity.

In some embodiments, an integrated propulsion system for a vehicle may include an onboard fluid-based RLEP unit generating rotational torque, an edge-drive transfer system connected to a central shaft, and a regenerative or clutch-based braking system integrated with an edge-drive output. In some embodiments, a torque router platform may include multiple edge-drive rings configured in series or parallel and may distribute torque across multiple output channels. In some embodiments, an amphibious or marine energy system may include a sealed RLEP oil barrel embedded in a marine vessel and an edge-drive system controlling torque to propulsion elements. In some embodiments, a modular retrofit kit may include an edge-drive torque transfer ring, a clutch-brake control assembly, and an interface system for adapting to existing shafts. In some embodiments, an industrial torque platform may use an RLEP-based generator coupled to an edge-drive ring array and may deliver rotational torque to equipment. In some embodiments, a robotic or articulation system may use miniaturized RLEP elements that may provide torque to mechanical limbs, and edge-drive elements may allow gearless control of rotation. In some embodiments, an autonomous vehicle drivetrain may use a central RLEP or electric motor and multiple edge-drive rings to individually control wheel or track torque. In some embodiments, a fluid medium optimization system may tune an RLEP system for air, oil, or water environments and may use an edge-drive system as a universal torque transfer interface.

In some embodiments, a mechanical lifting bridge or platform system may deliver torque generated from an RLEP through one or more edge-drive systems to lifting arms or rotary bridge structures. In some embodiments, a rotating gate or armature system may include a central RLEP torque source and an edge-drive output mechanism distributing torque to gates or robotic arms. In some embodiments, a commercial mechanical automation system may use edge-drive rings in place of belt or chain drives to transfer torque across conveyor systems or milling tools. In some embodiments, a modular torque assistance unit may include a compact RLEP-based torque generator and an edge-drive ring output module attachable to existing infrastructure.

In some embodiments, at least one horizontal wing may include an embedded downforce curvature configured to increase torque within enclosed fluid systems. In some embodiments, at least one horizontal wing and/or at least one radial support arm may be designed as a lift-reduction wing. In some embodiments, a startup mechanism for an RLEP system may deliver startup torque via an edge-drive rotational contact without a gearbox. In some embodiments, a multi-platform synchronization method may connect multiple RLEP units by timing shafts, controllers, or torque couplings to scale energy output. In some embodiments, a rotational axis may include more than one torque output shaft connected to different energy use cases. In some embodiments, a universal modular mounting frame for RLEP systems may be configured for rapid deployment and may include clutch, braking, and torque transfer infrastructure. In some embodiments, controlling lift-to-torque ratio dynamically may include adjustment of wing angle of attack in real time using actuators governed by load and speed sensors.

In some embodiments, a rotational lift energy platform may operate using any compressible or incompressible fluid medium capable of generating lift forces on airfoils. In some embodiments, airfoils may be arranged in multiple stacked layers along a central shaft to increase total lift-induced torque. In some embodiments, airfoils may be mounted on adjustable brackets permitting modification of radial distance from a central shaft. In some embodiments, a system may include a protective enclosure configured to guide fluid flow and reduce turbulence around rotating airfoils.

In some embodiments, an edge-drive ring may include outer-edge engagement teeth configured with a self-tightening angle relative to rotational direction. In some embodiments, an edge-drive ring may transfer torque to multiple output shafts simultaneously. In some embodiments, torque output may be controlled using clutch, brake, or electronic control systems. In some embodiments, an edge-drive system may replace traditional gearboxes in torque transfer applications.

In some embodiments, mechanical torque generated by an RLEP platform may drive an electrical generator. In some embodiments, generated torque may drive hydraulic, pneumatic, or mechanical pumping systems. In some embodiments, generated torque may be used directly for propulsion without intermediate electrical conversion. In some embodiments, generated torque may drive industrial machinery or manufacturing equipment.

In some embodiments, sensors may be configured to monitor rotational speed, torque output, and fluid pressure. In some embodiments, sensors may communicate with a control unit configured to adjust system performance. In some embodiments, system speed may be regulated using electronic controllers including variable frequency drives. In some embodiments, angle-of-attack adjustments may be performed automatically based on load conditions.

In some embodiments, braking mechanisms may be configured to slow or stop rotation of a central shaft. In some embodiments, a braking system may be integrated with an edge-drive torque transfer mechanism. In some embodiments, stabilization wings may be configured to counteract excessive lift forces. In some embodiments, stabilization wings may generate downforce.

In some embodiments, a platform may be constructed in modular sections permitting scalable installation sizes. In some embodiments, additional modules may be installed to increase torque output capacity. In some embodiments, multiple RLEP platforms may be synchronized using mechanical or electronic coordination systems. In some embodiments, synchronization may allow combined torque generation for large-scale energy production.

In some embodiments, a central shaft may be supported by magnetic, roller, or hydrodynamic bearings. In some embodiments, bearings may be positioned at multiple locations along a shaft to maintain alignment. In some embodiments, airfoils may be attached to structural brackets configured to distribute aerodynamic loads. In some embodiments, a system may include a rigid frame supporting a central shaft and an airfoil assembly.

In some embodiments, a system may operate interchangeably in air, water, or oil environments. In some embodiments, airfoil geometry may be optimized based on fluid density. In some embodiments, a system may be installed in enclosed barrels or open fluid environments. In some embodiments, a system may transition between fluid environments during operation.

In some embodiments, multiple edge-drive rings may be arranged concentrically to distribute torque across several outputs. In some embodiments, torque routing may be dynamically controlled through engagement or disengagement of output rings. In some embodiments, an edge-drive ring may include hardened engagement surfaces to withstand high torque loads. In some embodiments, an edge-drive mechanism may include replaceable engagement components.

In some embodiments, a platform may be used as a primary power source for aerial transport systems. In some embodiments, a platform may be used for pumping liquids from underground reservoirs. In some embodiments, a platform may be used for ventilation and air circulation in buildings. In some embodiments, a platform may be used for underwater propulsion systems.

In some embodiments, a hybrid energy system may include an RLEP platform and one or more edge-drive torque distribution units configured to power multiple devices simultaneously. In some embodiments, a multi-platform energy network may include multiple RLEP systems interconnected through mechanical or electrical synchronization systems. In some embodiments, energy produced by an RLEP platform may be stored in mechanical, electrical, or fluid-based storage systems. In some embodiments, a system may include automated shutdown or protection mechanisms triggered by abnormal operating conditions.

In some embodiments, rotational torque may be generated primarily from lift forces acting perpendicular to direction of fluid flow relative to rotating airfoils. In some embodiments, lift generated by airfoils may produce continuous rotational acceleration until mechanical resistance equals generated torque. In some embodiments, rotational torque generation may occur independently of external wind or current sources through internal circulation of a fluid medium. In some embodiments, airfoils may generate torque through differential pressure between upper and lower airfoil surfaces during rotation.

In some embodiments, multiple central shafts may be arranged in parallel within a shared structural frame. In some embodiments, torque from multiple shafts may be combined into a single output system. In some embodiments, a central shaft may include modular sections connected by mechanical couplings. In some embodiments, airfoils may be mounted on rotating brackets permitting dynamic repositioning along a shaft.

In some embodiments, fluid guidance channels may be configured to direct fluid flow across airfoils. In some embodiments, channels may improve lift generation efficiency. In some embodiments, fluid recirculation systems may be configured to maintain stable operating conditions. In some embodiments, recirculated fluid may maintain consistent density and pressure within an operating chamber.

In some embodiments, thermal management systems may be configured to dissipate heat generated by mechanical friction. In some embodiments, thermal management systems may include passive airflow cooling. In some embodiments, thermal management systems may include fluid cooling channels. In some embodiments, generated mechanical energy may be partially redirected to auxiliary subsystems within a platform.

In some embodiments, airfoils may be designed as replaceable modular components. In some embodiments, individual airfoils may be removed without disassembling a central shaft. In some embodiments, wear components of an edge-drive system may be replaceable without removing a ring from a shaft. In some embodiments, automated diagnostic systems may monitor structural integrity of rotating components.

In some embodiments, a system may include redundant torque transmission pathways. In some embodiments, redundant pathways may allow continued operation if a primary pathway fails. In some embodiments, automatic shutdown mechanisms may activate when rotational speeds exceed safe limits. In some embodiments, safety interlocks may prevent operation during structural faults.

In some embodiments, mechanical flywheel systems may be configured to store rotational energy. In some embodiments, stored rotational energy may be released during temporary load increases. In some embodiments, generated torque may be stored using mechanical spring, flywheel, or hydraulic storage systems. In some embodiments, energy storage modules may be integrated within platform structure.

In some embodiments, an RLEP system may operate alongside external renewable energy sources. In some embodiments, power generated from an RLEP system may be combined with solar or wind energy sources. In some embodiments, electrical energy generated by a system may be stored in batteries or capacitors. In some embodiments, a system may operate in combination with conventional propulsion systems.

In some embodiments, multiple RLEP platforms may communicate through networked control systems. In some embodiments, communication may coordinate torque output across platforms. In some embodiments, networked platforms may distribute load dynamically. In some embodiments, remote monitoring systems may supervise platform operation.

In some embodiments, a platform may be installed in large-scale infrastructure installations. In some embodiments, infrastructure may include bridges, towers, airports, or industrial complexes. In some embodiments, a platform may be used for distributed energy generation across multiple installations. In some embodiments, a platform may be configured for continuous operation over extended periods.

In some embodiments, a control system may use predictive algorithms to regulate rotational speed. In some embodiments, algorithms may optimize lift-to-torque efficiency. In some embodiments, algorithms may adjust airfoil angle based on load conditions. In some embodiments, system performance may be optimized through machine-learning-based control methods.

In some embodiments, a rotational lift energy platform may operate at any scale from micro-mechanical systems to large industrial systems. In some embodiments, a platform may maintain functionality regardless of scaling of component dimensions. In some embodiments, system performance may be governed primarily by rotational speed rather than physical scaling. In some embodiments, system architecture may remain functional regardless of variations in wing number, size, or orientation. In some embodiments, an RLEP system may be capable of operating continuously in multiple fluid mediums during a single operational cycle. In some embodiments, a system may be configured to prevent circumvention through variation of wing size, fluid density, rotational speed, or structural arrangement.

The embodiments described herein illustrate the versatility and broad applicability of the Rotational Lift Energy Platform. The embodiments described herein, including energy harvesting systems, water pumps, air movement systems, aerial vehicles, floating platforms, building climate control systems, sealed hydraulic torque generators, and elevator systems, may represent only a subset of the potential applications of the RLEP platform. The fundamental principles of force vector separation, low-friction operation through axial load management, efficient startup through peripheral engagement, and adaptable power transfer may be applied to numerous other applications not explicitly described herein. These may include, but are not limited to, marine propulsion systems, industrial mixing and processing equipment, renewable energy systems for remote locations, mobile power generation units, and other applications where efficient conversion between fluid flow and mechanical or electrical energy is required.

The scope of the disclosure may not be limited to the specific dimensions, materials, configurations, or operational parameters described in the embodiments above. The RLEP platform may be scaled to a wide range of sizes, from small portable units to large industrial or utility-scale installations. The systems may be constructed from various materials suitable for the intended operating environment. The number, size, and configuration of vertical airfoils, horizontal wings, and other components may be varied to optimize performance for specific applications. The principles disclosed herein may be applied across different fluid environments, including air, water, oil, and other fluids, and may be adapted to operate in various temperature ranges, pressure conditions, and operational contexts.

Although this invention has been disclosed in the context of certain preferred embodiments and examples, it should be understood by those skilled in the art that the present invention extends beyond the specifically disclosed embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, in various embodiments different arrangements of vertical and horizontal wings are possible, including arrangements with multiple sets of horizontal wings above or below the airfoils, and/or airfoils set and diagonal angles in addition to, or instead of, vertical and/or horizontal airfoils. Also, as used herein, various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances (e.g. 5%) of the system. Note also, as used herein the terms “process” and/or “processor” should be taken broadly to include a variety of electronic hardware and/or software based functions and components. Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Accordingly, this description is meant to be taken only by way of example, and not to otherwise limit the scope of this invention.

What is claimed is:

1. A rotational energy platform, comprising:
a rotating assembly comprising a central shaft, a plurality of vertical airfoils, and at least one set of horizontal wings;
wherein the plurality of vertical airfoils are mounted on one or more radial arms extending from the central shaft and are oriented to generate a tangential force that produces torque about the central shaft as the rotating assembly rotates through a fluid; and
wherein the at least one set of horizontal wings are mounted to the rotating assembly and are configured to generate an axial force along the central shaft.

2. The rotational energy platform of claim 1, wherein at least one of the at least one set of horizontal wings comprise axial-load compensating wings configured with a positive angle of attack to generate an upward lift force that counteracts a weight of the rotating assembly.

3. The rotational energy platform of claim 2, wherein the axial-load compensating wings are configured to offset at least 90 percent of the weight of the rotating assembly.

4. The rotational energy platform of claim 1, wherein the at least one set of horizontal wings comprise downforce-generating wings configured with a negative angle of attack to generate a downward force.

5. The rotational energy platform of claim 1, further comprising:
a startup system configured to engage the rotating assembly to initiate rotation, the startup system comprising two interlocking plates with directional locking segments that engage to transfer torque in a first direction and disengage when torque is applied in a second direction opposite to the first direction.

6. The rotational energy platform of claim 5, wherein the directional locking segments comprise:
a guide wall extending from a surface of a first plate;
an engagement ledge extending from the guide wall parallel to the surface of the first plate; and
a rotational stop positioned at an end of the directional locking segment.

7. The rotational energy platform of claim 1, further comprising:
a power transfer assembly configured to manage connections between the central shaft, a startup motor, and a generator.

8. The rotational energy platform of claim 1, wherein the rotating assembly is positioned within a housing, and wherein the housing comprises a plurality of openings configured to allow fluid flow through the housing while preventing contact with the rotating assembly.

9. The rotational energy platform of claim 1, wherein the at least one set of horizontal wings comprises:
an upper set of horizontal wings positioned above the one or more vertical airfoils; and
a lower set of horizontal wings positioned below the one or more vertical airfoils.

10. The rotational energy platform of claim 9, wherein a vertical gap between the upper set of horizontal wings and the lower set of horizontal wings defines an isolation plenum.

11. The rotational energy platform of claim 1, wherein the one or more vertical airfoils have an angle of attack in a range of approximately 5 to 15 degrees.

12. A method for converting fluid energy, comprising:
rotating an assembly through a fluid, the assembly comprising a central shaft, one or more vertical airfoils mounted on one or more radial arms extending from the central shaft, and one or more horizontal wings;
generating a tangential force with the one or more vertical airfoils to produce torque about the central shaft; and
generating an axial force with the one or more horizontal wings to manage an axial load on the central shaft.

13. The method of claim 12, wherein generating the axial force comprises generating an upward lift force that counteracts a weight of the assembly.

14. The method of claim 12, wherein generating the axial force comprises generating a downward force to stabilize the assembly.

15. The method of claim 12, further comprising:
applying torque to the central shaft of the assembly with a startup motor to initiate rotation;
disengaging the startup motor after the assembly reaches an operational speed; and
extracting power from the torque about the central shaft with a generator after the startup motor is disengaged.

16. The method of claim 12, wherein the fluid comprises water, and wherein the method further comprises pumping the water through a housing containing the assembly.

17. A system for aerial lift, comprising:
An arial vehicle body;
a rotating assembly comprising a central shaft extending vertically, a plurality of vertical airfoils mounted on radial arms extending from the central shaft, and at least one set of horizontal wings configured with a positive angle of attack;
wherein the at least one set of horizontal wings are configured to generate upward lift as the rotating assembly rotates; and
a propulsion system configured to provide horizontal thrust.

18. The system of claim 17, wherein the at least one set of horizontal wings comprises:
a first set of horizontal wings positioned below a body of an aerial vehicle; and
a second set of horizontal wings positioned above the body of the aerial vehicle;
wherein the central shaft extends through the body of the aerial vehicle to connect to the first set of horizontal wings and the second set of horizontal wings.
